(19) United States
(12) Patent Application Publication
(10) Pub. No.: US 2014/0038703 A1
(43) Pub. Date: Feb. 6, 2014

(54) CONTESTS AND SWEEPSTAKES

(71) Applicant: Sears Brands, L.L.C, Hoffman Estates, IL (US)

(72) Inventors: Edward S. Lampert, Bay Harbor, FL (US); Leena Munjal, Algonquin, IL (US); Scott H. Multer, Chicago, IL (US); Varun Reddy Agasti, Schaumburg, IL (US); Frederick W. Skoler, Barrington, IL (US); Sundaresan Chandrasekaran, Schaumburg, IL (US)

(21) Appl. No.: 13/956,978

(22) Filed: Aug. 1, 2013

Related U.S. Application Data
(60) Provisional application No. 61/678,547, filed on Aug. 1, 2012.

(51) Int. Cl. G07F 17/32

(52) U.S. Cl. CPC G07F 17/329
USPC 463/26

(57) ABSTRACT

A system and method that supports activities such as contests and sweepstakes within a social network environment.

### CROSS-REFERENCE TO RELATED APPLICATIONS

The present application makes reference to, claims benefit of, and claims priority to U.S. Provisional Patent Application No. 61/678,547, filed Aug. 1, 2012, which is hereby incorporated herein by reference, in its entirety.

### FIELD OF THE INVENTION

Certain embodiments of the invention relate to systems and methods for operating a social network. More specifically, certain embodiments of the present invention relate to systems and methods that support activities such as contests and sweepstakes within a social network environment.

### BACKGROUND OF THE INVENTION

Various forms of contests and sweepstakes have been in existence for many, many years. A contest may be defined herein as any competition the outcome of which is decided by one or more judges. A sweepstakes may be defined herein as any activity having a prize the winner of which is selected at random from the entrants. Present day forms of contests include, for example, sports, fashion, photography and film making, and writing. At the present time, entrants in contests and sweepstakes have little if any interaction with one another.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method that supports contests and sweepstakes within a social network environment, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system in which a representative embodiment of the present invention may be practiced.

FIG. 2 is a flowchart illustrating an exemplary process supporting events such as contests and sweepstakes using a social e-commerce platform, in accordance with a representative embodiment of the present invention.

FIG. 3 is an exemplary screen image showing the user interface for an application running on an e-commerce system such as, for example, the e-commerce system of FIG. 1, in accordance with a representative embodiment of the present invention.

FIG. 4 illustrates an exemplary screen image for user identification of personal interests, in accordance with a representative embodiment of the present invention.

FIG. 5 is an illustration of an exemplary screen image for user identification of their preferred product brands, in accordance with a representative embodiment of the present invention.

FIG. 6 is an illustration of an exemplary screen such as that shown in FIG. 5, in which a user has elected to enter a search term, and is presented with the result of the search, in accordance with a representative embodiment of the present invention.

FIG. 7 is an illustration of an exemplary screen such as that shown in FIG. 5, in which a user having entered a search term for which no possible matches are found, is presented a suggested list of brands, in accordance with a representative embodiment of the present invention.

FIG. 8 is an illustration of an exemplary screen image showing a thank you message box, in accordance with a representative embodiment of the present invention.

FIG. 9 is an illustration of an exemplary screen image showing an “Edit Preferences” box displaying the current interests of a user, to enable editing of user preferences, in accordance with a representative embodiment of the present invention.

FIG. 10 is an illustration of an exemplary screen image showing an “Edit Preferences” box displaying the current brands preferences of a user, to enable editing of previously selected product brands preferred by the user, in accordance with a representative embodiment of the present invention.

FIG. 11 is an illustration of an exemplary screen image showing a listing of recommended sweepstakes that have been selected for a user based on the personal interests and preferred brands of the user, in accordance with a representative embodiment of the present invention.

FIG. 12 shows an exemplary screen image showing a listing of recommended sweepstakes that have been selected for a user based on the preferred interests and brands of the user that may correspond, for example, to the screen image of FIG. 11, including a dropdown list displaying the current interests of the user, in accordance with a representative embodiment of the present invention.

FIG. 13 shows an exemplary screen image showing a listing of recommended sweepstakes that have been selected for a user based on the preferred interests and brands of the user that may correspond to the screen image of FIG. 11, including a dropdown list displaying the current preferred brands of a user, in accordance with a representative embodiment of the present invention.

FIG. 14 shows an exemplary screen image showing a listing of recommended sweepstakes that have been selected for a user based on the filters in effect, in which filters have by default have been set to include all available sweepstakes, in accordance with a representative embodiment of the present invention.

FIG. 15 shows an exemplary screen image showing a listing of all available sweepstakes, including a dropdown list displaying all of the currently available choices of user interests, in accordance with a representative embodiment of the present invention.

FIG. 16 shows an exemplary screen image showing a listing of all available sweepstakes, including a dropdown list displaying all of the currently available choices of user preferences of brands, in accordance with a representative embodiment of the present invention.

FIG. 17 shows an exemplary screen image showing an exemplary screen image containing a message to a user that has not indicated by their preferences any user interests, in accordance with a representative embodiment of the present invention.

FIG. 18 shows an exemplary screen image showing an exemplary screen image containing a message to a user that there are no sweepstakes to display based on their personal interests of the user profile, or the filter settings, in accordance with a representative embodiment of the present invention.

FIG. 19 shows an exemplary screen image showing a listing of all available sweepstakes, including a dropdown list displaying all of the currently available options in sorting the displayed list of sweepstakes, in accordance with a representative embodiment of the present invention.

FIG. 20 illustrates an exemplary screen image showing detailed information for a sweepstake selected by the user from the compact or contracted listing of sweepstakes illustrated in FIG. 19, in accordance with a representative embodiment of the present invention.

FIG. 21 illustrates an exemplary screen image showing a modal box that may be displayed in response to a user that has chosen to participate in qualifying for a sweepstake, such as that described above with respect to the “GET STARTED NOW” button of FIG. 20, in accordance with a representative embodiment of the present invention.

FIG. 22 shows an exemplary screen image showing a selection of products suggested for inclusion in a catalog, where the products have been automatically selected by a system such as the e-commerce system of FIG. 1 based on, for example, the interests of the user, in accordance with a representative embodiment of the present invention.

FIG. 23 is an illustration of an exemplary screen image showing a product page having a selectable/clickable button to permit the user to indicate the desire to add the currently displayed product to a catalog, in accordance with a representative embodiment of the present invention.

FIG. 24 illustrates an exemplary screen image showing details for a sweepstake in which the user is a participant attempting to qualify for entry, in accordance with a representative embodiment of the present invention.

FIG. 25 is an illustration of an exemplary screen image that includes a box containing information to aid the user in performing a task required to qualify for entry in a sweepstake, in accordance with a representative embodiment of the present invention.

FIG. 26 shows an exemplary screen image that includes a box containing the “official rules” governing the sweepstake(s), which may be displayed upon selection/clicking upon one or more graphics such as the “Official Rules” links described above with respect to, for example, FIG. 11 and FIG. 20, in accordance with a representative embodiment of the present invention.

FIG. 27 shows an exemplary screen image that includes a text box displaying frequently asked questions (FAQs), which may be displayed upon selection/clicking upon one or more graphics such as the “Official Rules” links described above with respect to, for example, FIG. 11, in accordance with a representative embodiment of the present invention.

FIG. 28 is an illustration of an exemplary screen image that includes a dialog box to enable a user to share with others, via email and social media, information about participation of the user in a contest or sweepstake, in accordance with a representative embodiment of the present invention.

FIG. 29 illustrates an exemplary screen image having a dialog box that may correspond to the dialog box of FIG. 27, in which the user has enabled sharing of information about participation of the user in a contest or sweepstake via all of the email and social media communication options, in accordance with a representative embodiment of the present invention.

FIG. 30 shows an exemplary screen image for an authorization dialog box to permit the use of the twitter® real-time electronic communication system by a system such as, for example, the system of FIG. 1, in accordance with a representative embodiment of the present invention.

FIG. 31 shows an exemplary screen image for an authorization dialog box to permit the use of the Facebook® social communication network by a system such as, for example, the system of FIG. 1, in accordance with a representative embodiment of the present invention.

FIG. 32 shows an exemplary screen image showing a listing of sweepstakes for a user, in accordance with a representative embodiment of the present invention.

FIG. 33 is an illustration of an exemplary screen image showing another listing of sweepstakes for a user, in accordance with a representative embodiment of the present invention.

FIG. 34 is an illustration of an exemplary screen image showing another listing of sweepstakes for a user, in accordance with a representative embodiment of the present invention.

FIG. 35 is an illustration of an exemplary screen image showing another listing of sweepstakes for a user, in accordance with a representative embodiment of the present invention.

FIG. 36 is an illustration of an exemplary screen image showing yet another listing of sweepstakes for a user that is similar in ways to the illustration of FIG. 33, in accordance with a representative embodiment of the present invention.

FIG. 37 is an illustration of an exemplary screen image showing another listing of sweepstakes for a user, in accordance with a representative embodiment of the present invention.

FIG. 38 is an illustration of an exemplary screen image showing another listing of sweepstakes for a user, in accordance with a representative embodiment of the present invention.

FIG. 39 is an illustration of an exemplary screen image showing another listing of sweepstakes for a user, in accordance with a representative embodiment of the present invention.

FIG. 40 is an illustration of an exemplary screen image showing another listing of sweepstakes for a user, in accordance with a representative embodiment of the present invention.

FIG. 41 is an illustration of an exemplary screen image showing another listing of sweepstakes for a user, in accordance with a representative embodiment of the present invention.

FIG. 42 is an illustration of an exemplary screen image showing another listing of sweepstakes for a user, in accordance with a representative embodiment of the present invention.

FIG. 43 is an illustration of an exemplary screen image showing a dialog box that may be displayed when a user has qualified for and been entered in a sweepstake, in accordance with a representative embodiment of the present invention.

FIG. 44 shows an illustration of an exemplary screen image of a dialog box that may be displayed when a user has qualified for and been entered in multiple sweepstakes, in accordance with a representative embodiment of the present invention.

FIG. 45 shows an illustration of an exemplary screen image of a dialog box that may be displayed when a user has qualified for, been entered in, and won a sweepstakes, in accordance with a representative embodiment of the present invention.

FIG. 46 is an illustration of an exemplary screen image showing a newsfeed stream of a member of the loyalty program of a business operator or sponsor of a system such as the system of FIG. 1, in accordance with a representative embodiment of the present invention.

FIG. 47 is an illustration of an exemplary email that may be sent to members of a loyalty program of a business operator or sponsor of a system such as the e-commerce system to promote or incite interest in participating in activities such as contests and sweepstakes, in accordance with a representative embodiment of the present invention.

FIG. 48 is an illustration of an exemplary email that may be sent to a member of a loyalty program of a business operator or sponsor of a system such as the e-commerce system to inform them their win in an activity such as a contest or sweepstake, in accordance with a representative embodiment of the present invention.

FIG. 49 is an illustration of an exemplary screen image of a pop-up box that appears when a user chooses the “Comments” link that appears on screen images such as those illustrated in FIGS. 20-42, in accordance with a representative embodiment of the present invention.

FIG. 50 is an illustration of an exemplary screen image of a pop-up box such as that shown in FIG. 49, in which the user has chosen to add a comment, in accordance with a representative embodiment of the present invention.

FIG. 51 is an illustration of an exemplary screen image of a pop-up box that appears when a user chooses the “Friends” link that appears on screen images such as those illustrated in FIGS. 20-42, in accordance with a representative embodiment of the present invention.

FIG. 52 is an illustration of an exemplary screen image showing a ratings tool to permit the user to indicate their satisfaction with the contests and sweepstakes application, in accordance with a representative embodiment of the present invention.

FIG. 53 is an illustration of an exemplary screen image showing a pop-up box that permits the user to indicate by selection or text entry, details of their experience using the contest and sweepstakes application, in accordance with a representative embodiment of the present invention.

FIG. 54 is an illustration of an exemplary screen image showing a follow-on pop-up box that permits the user to indicate by text entry, details of their experience using the contest and sweepstakes application when a particular number of stars have been selected by the user in response to a pop-up box such as that of FIG. 52, in accordance with a representative embodiment of the present invention.

FIG. 55 is an illustration of an exemplary screen image showing a follow-on pop-up box that permits the user to indicate by text entry, details of their experience using the contest and sweepstakes application when a particular number of stars have been selected by the user in response to a pop-up box such as that of FIG. 52, in accordance with a representative embodiment of the present invention.

FIG. 56 is an illustration of an exemplary screen image showing a pop-up box used to notify the user of a system failure, in accordance with a representative embodiment of the present invention.

FIG. 57 is a flowchart illustrating an exemplary process for a sweepstake having a task for qualification that involves the creation of a catalog of products on a system such as the e-commerce system of FIG. 1, in accordance with a representative embodiment of the present invention.

FIG. 58 is a flowchart illustrating an exemplary process for a sweepstake qualifying task that involves the uploading of a photograph to a system such as the e-commerce system of FIG. 1, in accordance with a representative embodiment of the present invention.

FIG. 59 is a flowchart illustrating an exemplary process of accepting an application by a member of a loyalty program to become a participant in a contest or sweepstakes, in accordance with a representative embodiment of the present invention.

FIG. 60 is a flowchart illustrating an exemplary process for operating a system that track the completion of tasks by participants in qualifying for a contest or sweepstake in a social e-commerce network, in accordance with a representative embodiment of the present invention.

FIG. 61A is an illustration of an exemplary user device having an electronic display that includes a region having a graphical representation of a “scratch-off” coating that partially or fully obscures notice to the user of reward information, in accordance with a representative embodiment of the present invention.

FIG. 61B is an illustration of an exemplary user device having an electronic display, that may correspond to the user device, in which the region having a graphical representation of a “scratch-off” coating has been “scratched-off” to reveal the details of a reward to the user of the device, in accordance with a representative embodiment of the present invention.

### DETAILED DESCRIPTION OF THE INVENTION

Aspects of the present invention are related to systems and methods for operation of a contest and sweepstakes system. More specifically, certain embodiments of the present invention relate to systems and methods that support activities such as contests and sweepstakes within a social network environment.

A representative embodiment of the present invention may be seen in a method of operating an e-commerce platform that promotes the engagement of customers of a sponsoring business by combining aspects of membership, contests, sweepstakes, gaming, social networking, and achievement-based incentive upgrades to drive sales activity. The customers of the sponsoring business may be or become members of a loyalty program that promotes participation in various activities and events. Participation in the loyalty program may be rewarded in a number of ways including, for example, a “point” system, “badges” signifying each of a number of possible levels of achievement, prizes (e.g., product giveaways) for a contest or sweepstake that are awarded from a pool of prizes that may be based on the level of achievement of those permitted entrance, special offers that are targeted to the member based on information that has been gathered from members behaviors, and the ability to donate awarded value such in forms such as points, currency, or goods or services to charitable causes of interest to the participating member.

In a representative embodiment of the present invention, membership in the loyalty program may be divided into a number of groups including, for example, those that are new members, those that belong to certain segments of the membership based on characteristics, and “VIP” members, and may include different benefits or bonuses for such membership groups. In a representative embodiment of the present invention, different segments of the membership may be offered participation in different contests and sweepstakes based upon measures such as, for example, level of achievement. That is, some contests and/or sweepstakes may be open to all members of the social network, while certain other contests and/or sweepstakes may be targeted at or open only to “new” members. Certain member segments (e.g., characterized by interest, their stage in life, affiliations, those that are customers of partner businesses of the sponsoring business) may be offered yet other contests and/or sweepstakes, and members meeting the qualifications for a “VIP” status (e.g., purchase history, credit score, residence location) may be eligible for participation in a different array of contests and/or sweepstakes, with a different array of awards or prizes, than the other three example levels of achievement or qualification described above. For example, various contests or sweepstakes may be targeted at or customized for individuals that are contemplating, in the process of, or recently completed a move from one home or residence to another; those that are engaged to be married; those expecting a baby; and/or those that have recently purchased a new home.

In a representative embodiment of the present invention, the e-commerce platform may track achievement of various tasks, and the results of such achievement may be posted for other members to view such as, for example, on a “leader board” for a particular contest sweepstakes, or indicating the leader(s) within a particular level of achievement (e.g., new member or “VIP”). To further incent participants at a particular level of achievement to work towards qualifying for the next higher level, the benefits of that higher level may be disclosed or “previewed,” and what is required of the participant to move to that next level may be clearly identified. In addition, at designated times the e-commerce platform may open the next higher level to members at a particular level of achievement, for example, for a limited amount of time, to enable members to better understand the benefits of achieving the next higher level of achievement.

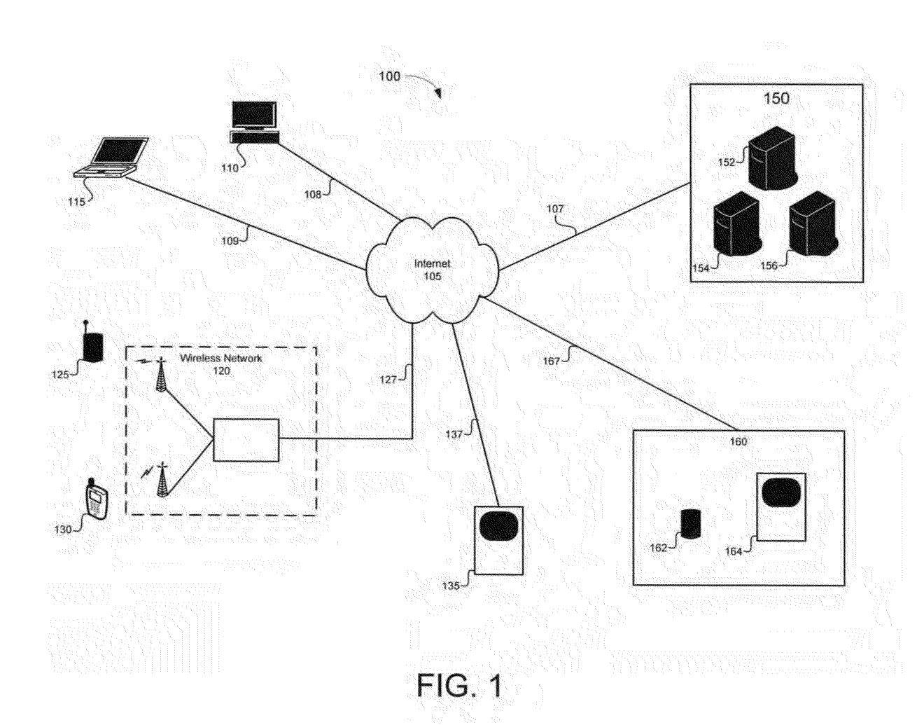

In a representative embodiment of the present invention, the tasks may vary in complexity by the level of achievement of the participants, and the members may be offered incentives to participate, which may increase with the complexity of the tasks that they are asked to perform. It should be noted that the terms “task” and “social task” may be used herein interchangeably to refer to an activity to be completed by an individual as part of qualifying for entry in a contest or sweepstake, where the activity results in communication or interaction with other individuals or groups that may be, for example, acquaintances, friends, or relatives, and may be members of a loyalty program of a business operator or sponsor of an e-commerce system such as the system 150 of FIG. 1. The tasks may involve activities that have a social component such as, for example, tasks that result in interaction of a participant with other members of the social network in ways that aid others, or promote awareness and sales of the products and/or services of a business operating or sponsoring the e-commerce platform. Non-limiting examples of tasks that a participant may be asked to perform include a participant visiting one ort more product pages and indicating that they “Like,” “Want,” or “Have” a particular product; a participant submitting a comment or review on a particular product and/or service; and a participant recommending a particular product and/or service to others. Additional non-limiting examples of tasks include a participant creating a catalog of products and/or services, in which the catalog of items that they have selected is to be made accessible to other members; a participant submitting their personal rating (e.g., one to five “stars”) for a particular product and/or service; and a participant choosing to “Follow” a particular brand, store, topic, or “tag.” The duration of asks may vary from simple tasks that may be completed in a minute or two, to tasks that may span several days.

A representative embodiment of the present invention may involve aspects of various types of games including, for example, games that engage a single member, strategy-based games, games that involve multiple members and/or multiple tasks, games that involve two or more sales channels of the sponsoring business(es) such as, for example, performing certain tasks in a “brick-and-mortar” store and completing other tasks via the Internet. As a non-limiting example of a game involving multiple players, a “scavenger hunt” game may require members to find and “Like” each entry of a list describing items available on the Internet website of the sponsor of the e-commerce platform. In performing this example task, the participants may display their skill at using web site search tools, and in the process of searching for the listed items, may come upon particular items of interest to themselves, friends, or family, increasing participant enjoyment and sales on the sponsor web site. Such a game may also span across the electronic and the brick-and-mortar locations of multiple business partners. An e-commerce platform in accordance with a representative embodiment of the present invention may, during such games, collect information such as, for example, the nature of the game, the particulars of the participants, the various actions and behaviors of the participants, the outcome of each action, and the outcome of the game, to name only a few possibilities.

A representative embodiment of the present invention aids the business entities operating or sponsoring the social e-commerce platform to capture information about customer behavior in order to permit improved customization of customer experience in future use of the e-commerce platforms of the sponsoring business(es), and those of their business partners, across the various points of contact with customers.

A representative embodiment of the present invention promotes member engagement with the e-commerce platform and the sponsoring business(es), by providing incentives to create content such as, for example, pictures, catalogs, product and/or service reviews, to assist members in getting information and/or opinions of others related to their purchase decisions, to offer aid to other customer members in their shopping activities, and to interact with and engage their own personal social networks. In addition, a representative embodiment of the present invention promotes involvement of the personal social networks of the participating members, in sponsored contests and sweepstakes made available through the e-commerce platform. Such an e-commerce platform may be referred to herein as a social commerce/e-commerce platform.

An e-commerce platform in accordance with a representative embodiment of the present invention is, in part, a learning platform that may, for example, learn based upon the interactions of members with each other, their personal social networks, and the platform itself. Some learning may result from question and answer sessions with a new member including, for example, things such as a basic profile of member interests, brand preferences, and stores that are identified as being nearby their residence. Using the learned information, such a social commerce platform will provide the members with the most relevant and customized information content and offers or promotions, to enhance their experience with the e-commerce platform. This may include, for example, targeting customers with customized interactions, and the choosing of prizes. As the level of member engagement increases, and member interaction is on a more regular basis, the incentives offered to the member and the complexity of the promotions may increase. An e-commerce platform in accordance with a representative embodiment of the present invention may then provide more opportunities to the member to engage in the activities of a broader array of e-commerce businesses, including one or more business partners, some of whom may sponsor the e-commerce platform described herein, and allow cross-platform experiences. In addition, the e-commerce platform of the present invention may automatically provide the recipient of awards and prizes with the necessary documentation related to any tax liabilities.

As utilized herein, the terms “exemplary” or “example” means serving as a non-limiting example, instance, or illustration. As utilized herein, the term “e.g.” introduces a list of one or more non-limiting examples, instances, or illustrations.

FIG. 1 is a block diagram of an exemplary system 100 in which a representative embodiment of the present invention may be practiced. As illustrated in FIG. 1, the system 100 includes an e-commerce system 150 comprising one or more web servers 154, one or more database servers 156, and one or more application servers 152. The elements of the e-commerce system 150 may be interconnected, and may singly or as a group be connected to Internet 105 via communication link 107, which may employ any suitable combination of wired or wireless data communication links. FIG. 1 also includes personal computers (PCs) 110, 115, which are connected to the Internet 105 by communications links 108, 109, respectively, which may be any suitable combination of wired or wireless data communication links. PCs 110, 115 may be any of, for example, a desktop computer, a laptop computer, a notebook computer, a netbook computer, a tablet computer, or any other electronic device having capabilities suitable for accessing the Internet 105 from, for example, a home, a small business, or any private or public area having suitable support for communications links 108, 109.

In addition, FIG. 1 illustrates a user communication device 125 that may comprise, for example, a tablet computer, smart phone, or other handheld electronic device capable of communicating to the e-commerce system 150 via a wireless network 120, a communication link 127, and the Internet 105. The communication device 125 of FIG. 1 may include suitable software applications, hardware, and logic to permit the communication device to display received web pages and other forms of digital information on a display of the communication device 125, and suitable user interface elements to permit a user to interact with the e-commerce system 150 using tactual, speech, and other forms of input. The wireless network 120 may support communication of digital information using any suitable wireless access technology including, for example, any combination of short-range, long range, Wi-Fi, cellular, personal communication system (PCS), Bluetooth, Near Field communication (NFC), to name only a few possible air interface technologies.

FIG. 1 also includes a portable telephone 130 that may be capable of communicating over one or more of a cellular, PCS, Wi-Fi, or other wireless communication network, and may have more limited yet sufficient functionality to interact with the e-commerce system 150 than that available from the PCs 110, 115 and the communication device 125, for example.

In addition, FIG. 1 illustrates a kiosk device 135, which may permit users in retail and public venues to access the e-commerce system 150. The kiosk device 135 may be designed for indoor or outdoor use, and may be linked to the e-commerce system 150 via a communication link 137 and Internet 105, as shown, or may communicate directly with the e-commerce system 150 using any other suitable wired or wireless means. The kiosk 135 may have functionality that is equivalent, greater than, or less than the personal computers 110, 115, the communications device 125, and the cellular telephone 130.

The illustration of FIG. 1 also shows a retail establishment 160 that may, for example, be a “brick-and-mortar” business associated with the operator or sponsor of the e-commerce system 150. The retail establishment 160 may include a kiosk 164 that may support access to the e-commerce system 150 from the retail establishment 160, for those users that are located within the retail establishment 160. The illustration of FIG. 1 also includes a communication device 162 that may belong to, or be loaned to a customer of the retail establishment 160, permitting the customer to, for example, electronically access information about products and/or services available at the retail establishment 160, at other business locations of the operator of the retail establishment 160, or at other businesses operated by, for example, the operator, or businesses that partner with the operator of the e-commerce system 150. Communication devices within the retail business 160 such as, for example, the communication device 162 and the kiosk 164 may communicate with the e-commerce system 150 via the Internet 105 and the communication link 167, which may be, for example, any suitable combination of wired and/or wireless communication technologies.

In accordance with a representative embodiment of the present invention, the elements of a system such as the e-commerce system 150 of FIG. 1 may include the functionality in a software application that enables user membership in a loyalty program of a business operator or sponsor of the e-commerce system 150, and the engagement of users in the events and the activities of one or more contests and sweepstakes. The e-commerce system 150 may include a software platform which tracks social interactions of users, and may track the activities of each member of the loyalty program. The tracking capabilities may include a flexible interaction tracking framework that supports multiple social interactions of the members. In addition, the software application may support interfacing a variety of user communication devices including, for example, tablet, desktop, notebook, notepad, and network computers, cellular telephone and smart phones, public and private kiosks, and other suitable electronic user communication devices available at the present time or in the future.

The e-commerce system 150 may also include suitable software, hardware, and/or suitable logic of an application that provides functionality supporting contests and sweepstakes. The functionality of such an application may, for example, include functionality which tracks the entry of members in qualifying for and gaining entry to contests and sweepstakes. Such an application may also validate social interactions of the members against specific rules of any contest or sweepstake, and rules provided by other sources such as, for example, a prizing engine, described below. An application used in this manner may also be arranged to notify users of the status of, or changes in the status of their qualification for, entry in, and the identification of the winners of the contests and sweepstakes managed by the application.

The e-commerce system 150 may also include software, hardware, and/or suitable logic for what may be referred to herein as a “prizing engine.” In a representative embodiment of the present invention, such a prizing engine may manage the content of contests and sweepstakes run on the e-commerce system 150, and may manage the activities involved in the setup of contests and sweepstakes. The prizing engine may communicate to the contests and sweepstakes application described above, the rules and variables to be tracked.

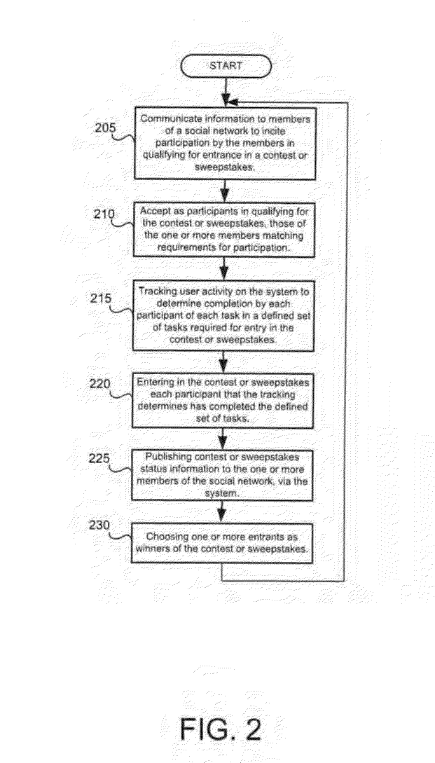

FIG. 2 is a flowchart illustrating an exemplary process supporting events such as contests and sweepstakes using a social e-commerce platform, in accordance with a representative embodiment of the present invention. The actions of the method of FIG. 2 may be performed using elements of the system 100 of FIG. 1 including, for example, the e-commerce system 150. The e-commerce system 150 may be arranged to support the purchasing activities of customers of a business operator or sponsor, including the support of customer membership in a loyalty program of the business operator or sponsor, and may also provide functionality supporting activities such as, for example, contests and sweepstakes involving the customer members and the personal social networks of the customer members.

The method of FIG. 2 begins at block 205, where the e-commerce system 150 may communicate information to members of a loyalty program via a social network associated with the operator or sponsor of the system 150. The communication may, for example, be displayed on a web page by posting to the personal account of a member of a social network, and may be created so as to incite participation by the members in qualifying for entrance in a contest or sweepstakes run by the operator or sponsor of the e-commerce system 150. Next, at block 210, the system may accept as participants in qualifying for the contest or sweepstakes, those of the members matching requirements for participation. The requirements may include, for example, that the member has established a particular level of a plurality of levels of achievement in the loyalty program, or that the member is a new member that just joined the loyalty program.

Following acceptance for participation in qualifying for entry in the contest or sweepstakes, the method of FIG. 2 may, at block 215 commence tracking activity of the member on the system, to determine completion, by the participating member, of each task in a defined set of tasks, the completion of which is required for entry in the contest or sweepstakes. In a representative embodiment of the present invention, the tasks in the defined set of tasks may, for example, involve creation of content for the use and viewing of other members of the loyalty program or members of a social network operated using the system 150, or communication of the participant with other members of the loyalty program or members of a social network operated using the system 150. As the participants complete each of the tasks in the defined set of tasks which they were given, the system of FIG. 2 may notify various members of the accomplishment of the task by the participant including, for example, by posting messages to one or more pages of members of the participant's personal social network. In this way, the system 150 may instill a sense of competition and urgency in other members to complete the tasks given them.

At some later time, such as at the expiration of a qualifying period, the method of FIG. 2, at block 220, may cease to accept new participants, and may qualify as entrants in the contest or sweepstake each participant that the tracking has determined has completed each of the required tasks in the defined set of tasks. At the next block 225, the method of FIG. 2 may then publish contest or sweepstakes status information to the members of the social network, via a system such as the system 150 of FIG. 1. In a representative embodiment of the present invention, some information about the qualification of a member for entry in the contest or sweepstakes may, for example, be published as information available to all members of the loyalty program, only to members of a personal social network of the participant, or may be published only to those members participating in the completion of the tasks required for entry in the contests or sweepstakes. In the method of FIG. 2, one or more entrants in the contest or sweepstakes may then be chosen as winners. In some representative embodiments of the present invention, the winner(s) of a sweepstake may be chosen randomly from all of those that qualified for entry in the sweepstake. In other representative embodiments of the present invention, a winner of a contest may be selected based upon, for example, the decision(s) of one or more judges that evaluate a submission of each of the entrants. Prizes awarded to the winner(s) may be selected from a pool of prizes the size or nature of which is determined based on particular characteristics of the entrants, which may also have been used in a decision accepting the member as a participant in the contests or sweepstakes.

For example, in a representative embodiment of the present invention, prizes to be awarded may consist of, for example, “point” awards that are part of a loyalty program of the business operator or sponsor of the system of FIG. 1, or premium prizes that may include “in-kind” items that may be unique, have limited availability, are hard to find, or that would be perceived by participants as exclusive. Examples of such “in-kind” prizes may include, for example, items of merchandise that are considered to represent the latest in technology; tickets to exclusive music, sports, celebrity, tourist, or cultural events; new releases of items of the most popular or “hottest” brands; and limited editions or collectors items. Prizes to be awarded may also be in the form of discounts or “deals” on various items. In accordance with a representative embodiment of the present invention, prizes to be awarded may be manually selected by an operator, or automatically selected by an e-commerce system based on the customer segment into which the participant fits (e.g., “fashionistas,” “gadget-lovers,” and “music enthusiasts”), which may be determined using information provided by the customer during an enrollment or qualification activity, or derived from participant purchase and social behavior tracked by an e-commerce system such as the e-commerce system 150 of FIG. 1.

The prizes to be awarded may be based upon various stages of life of participants such as, for example, the celebration of a birthday, when preparing for or graduating from high school or college, becoming engaged or married, expecting the birth of a child, and preparing for, purchasing, or moving into a new home or residence, and may be selected from various products, services, and events that may be of interest to individuals in each of the identified stages of life. Prizes to be awarded may also be selected based upon various customer segments such as, for example, the “beauty maven” that may be particular interested in her appearance, a “pet lover” whose interests may revolve around one or more pets, the “fitness fanatic” that may work to stay in top physical condition, and the automotive enthusiast that spends much of their free their time working to repair or accessorize various cars.

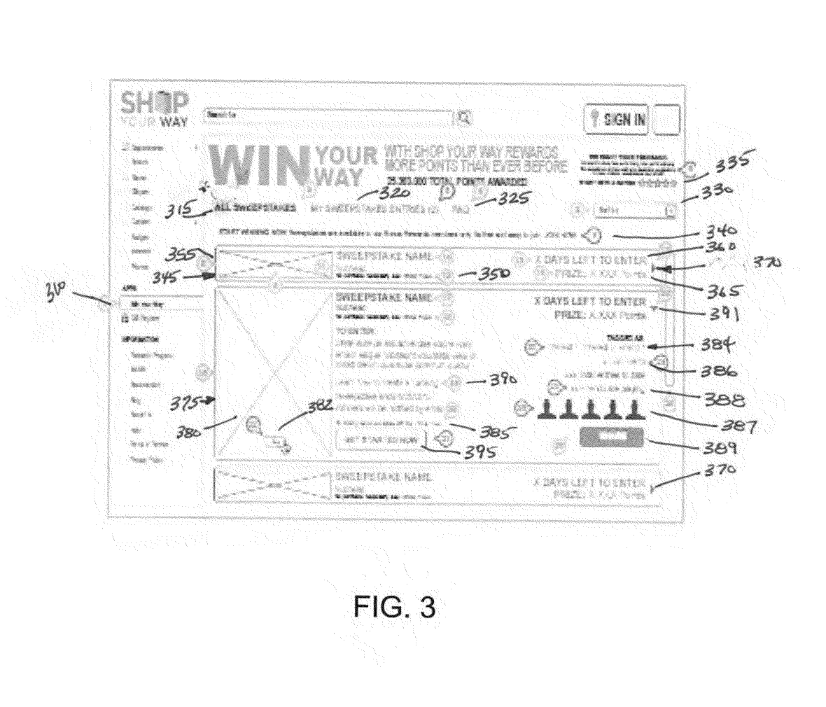

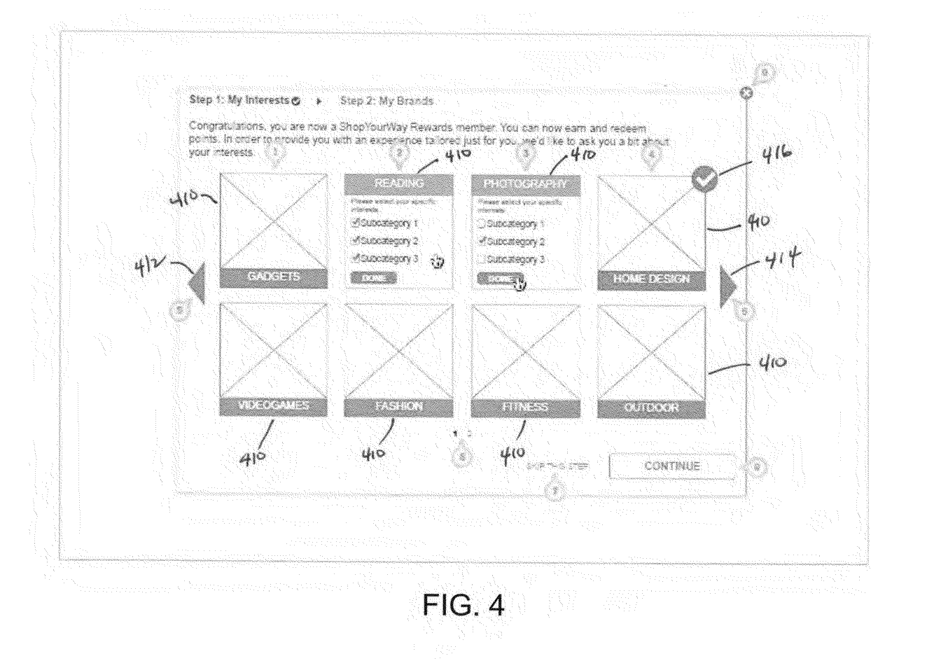

FIG. 3 is an exemplary screen image showing the user interface for an application running on an e-commerce system such as, for example, the e-commerce system 150 of FIG. 1, in accordance with a representative embodiment of the present invention. The user interface may be presented in suitable forms via a variety of personal and public communication devices such as, for example, a laptop, desktop, notebook, or netbook computer, a smart phone or cellular telephone, a handheld personal computer, and public or private terminals such as, for example, a kiosk, and/or other suitable electronic devices typically found in homes, small offices, and businesses. Such communication devices may communicate with a system such as the e-commerce system 150 via a suitable combination of wired and wireless communications links, as described above with respect to FIG. 1. The various user interface elements illustrated in the screen image of FIG. 3 are described in greater detail below with respect to FIGS. 4-56. The screen image of FIG. 3 includes element such as, for example, an active main menu tab 310, which when selected shows various information related to contests and sweepstakes in a portion of the screen. Selecting one of several tabs, such as a “All Sweepstakes” tab 315 may result in display of a list of the latest available sweepstakes matching the personal interest or preferred or feature brand of the user. The screen of FIG. 3 may also include a “My Sweepstakes” tab 320 to allow a user to view only the sweepstakes entries of the user. A “Frequently Asked Questions (FAQ)” tab 325 may be provided that when selected/clicked causes the display of the latest listing of questions most asked by users. The screen of FIG. 3 also includes a “Sorting” dropdown menu 330 with a listing of various options for sorting the list of contests or sweepstakes, and a “ranking” tool 335 to permit the user to express their level of satisfaction with the user experience of the contests and sweepstakes application.

The screen image of FIG. 3 also includes an invitation message 340 to encourage or incite users to become bonus members in the loyalty program of the business operator or sponsor of the e-commerce system 150. In each listing of contests and sweepstakes, each entry or row in the listing may be presented in a brief, compact, or “collapsed” state (e.g., at 345) having limited detail information about the event. The compact or collapsed form may include a link 350 to access the “Official Rules” of that contest or sweepstake. Selecting a row in the listing may cause additional details to be displayed using a larger screen area, which may include a clipped or thumbnail image 355 related to the contest or sweepstake. The detailed information may also include the amount of time remaining to participate in the contest or sweepstake as the number days left until the end of the event. If the remaining time is less than a day, the time left may be displayed as hours, while if the time remaining is less than an hour, the time remaining may be displayed as minutes.

A row of information representing a contest or sweepstakes may include an indication of the amount or size 365 (e.g., in “points” of the loyalty program, currency, or another form of award) of the sweepstake prize. An arrow icon 370 may be present at the right end of the row of contests or sweepstakes information presented in compact or collapsed form. The arrow icon 370 may point to the right, to indicate that the current state of the sweepstake display is compact or collapsed, and selecting/clicking the arrow may cause the expansion of the collapsed form into a larger form 375 with additional contest or sweepstake detail. The larger form 375 of the row of contest or sweepstake information may include a larger image 380 related to the contest or sweepstake, and a link to the Official Rules 385.

In one representative embodiment of the present invention, a link 390 may be provided to permit the user to display information about how to complete one exemplary social task such as, in the exemplary larger form 375, of creating a catalog of products, which is described in greater detail below. A “GET STARTED NOW” button 395 may be provided to permit the user to immediately begin preparation to participate in a contest or sweepstake.

In a representative embodiment of the present invention, a “Like” button 382 may be displayed to permit the user to indicate that the user wishes to indicate to others that they have interest in the selected contest or sweepstake. The “Like” button 382 may be displayed when the user scrolls or hovers over the image portion 380 of the information for the selected contest or sweepstake. A number of tags 384 may also be shown that may be used to initiate setting of filtering of displayed contests and sweepstakes to match the interests and product brands indicated by the tags 384. The user may read or leave comments by selecting/clicking the “Comments” button or link 386 shown in FIG. 3, and may review a list showing the members currently in their personal social network that are participating in the selected contest or sweepstake, by selecting a “Friends” button or link 388.

A group of multiple thumbnail images 387 of some of the members of the user's personal social network is also included in the screen example of FIG. 3. If the list of participating members of the user's personal social network contains fewer members than the spaces for thumbnail images, the grouping 387 of thumbnail images may be filled-out using the most recently added members of the social network of the business operator or sponsor of the e-commerce system 150. The thumbnail images of the participants shown in the group of thumbnail images 387 may be selected and arranged according to the order of completion of tasks required by the selected contest or sweepstakes. The name of each participant displayed as a thumbnail image may be displayed as a pop-up “tool-tip” (not shown) upon the user scrolling or hovering the cursor over a thumbnail image of the group of thumbnail images 387. The user may choose to share information about their own participation in the selected contest or sweepstake by selecting/clicking on a “Share” button 389. An arrow pointing downward 391 may be included at the right end of the detailed view of the larger form 375 for a contest or sweepstake, to permit the user to return the sweepstake information in screen image to the compact or collapsed form 345.

FIG. 4 illustrates an exemplary screen image for user identification of personal interests, in accordance with a representative embodiment of the present invention. The personal interests identified by the user may, for example, be made part of a personal profile for the user, and may later be used in the selection or filtering of information presented to the user. The screen of FIG. 4 includes a number of “Interest” boxes 410 representing possible areas of interest to the user (e.g., “Gadgets,” “Reading,” “Photography,” “Home Design,” “Videogames,” “Fashion,” “Fitness,” etc). The interest boxes 410 of FIG. 4 are part of a “carousel” that permits the user to have access to a greater number of interest boxes than may fit on the screen of their communication device at one time, by using scroll buttons 412, 414.

In the screen of FIG. 4, subcategories for each area of interest may, by default, be hidden when the screen is first displayed. When the user selects/clicks an interest box 410, the related subcategories may be shown, and they be accompanied by check marks by default, to show those that are in effect, according to a set of default subcategories, or subcategories previously selected by the user and stored in a user profile by the system. The user may modify the check marks of the default selection(s) that may be provided. Once the user has reviewed the selected subcategories and set them as desired, he/she may select/click a “Done” button to apply/confirm the selected interest subcategories. If the user has checked at least one interest subcategory and the changes are applied, the box representing a particular interest may return to a default view having a check mark icon 416, to indicate user selection of at least one subcategory in that area of interest. The user may edit selected subcategories for a particular interest area by selecting/clicking on any of the displayed interest boxes 410.

The screen image of FIG. 4 also includes left and right arrows 412, 414 that are selectable/clickable to control the motion of the carousel on which the interest boxes 410 are positioned. An alternative navigation option using “paginator links” (not shown) may also be used. In such an embodiment, an indication of current page may not be selectable/clickable. The user may continue through the process of joining the loyalty program without entering his/her interests. In that case, a “Thank you” modal window (e.g., for confirmation) may be displayed having a message that allows the user to add his/her interests. The user may then submit the information entered by the user and continue to the “Thank you” modal window. Closing the window may trigger display of a message that requests confirmation before closing the process of joining, or continuing the process. If the user cancels the process of joining, the modal window may be closed without submitting any of the entered information.

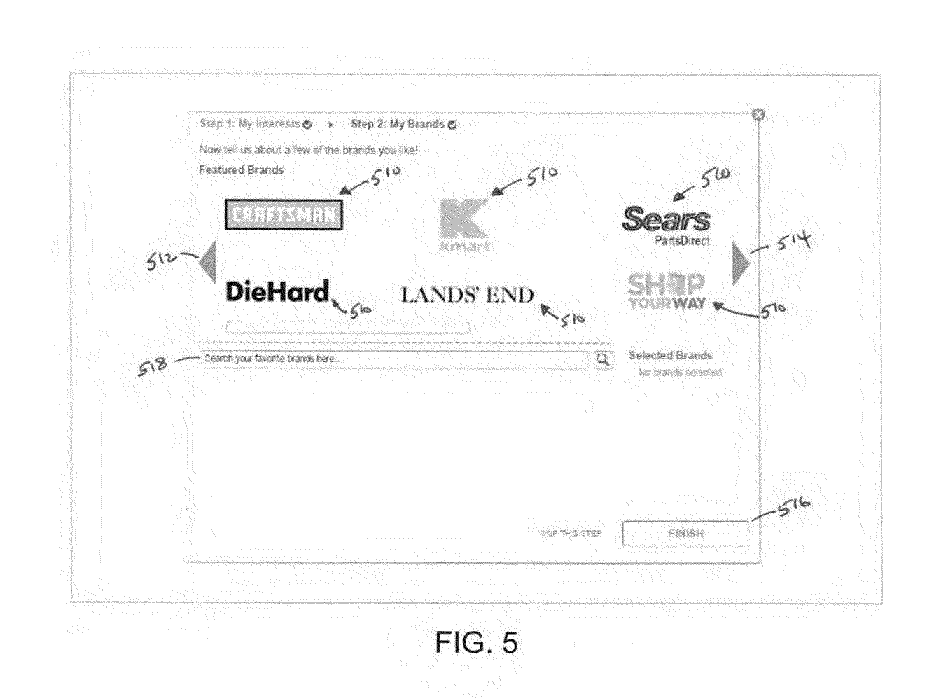

FIG. 5 is an illustration of an exemplary screen image for user identification of their preferred product brands, in accordance with a representative embodiment of the present invention. The product brands identified by the user may, for example, be made part of a personal profile for the user, and may later be used in the selection or filtering of information presented to the user. The screen of FIG. 5 includes a number of logos 510 representing various product brands that may be preferred by the user. The logos representing product brands may be part of a “carousel” that permits the user to have access to a greater number of product brands than may fit on the screen at one time. Once the user has reviewed the available product brands and select those that they prefer, he/she may select/click a “Finish” button 516 to apply/confirm the preferred product brands. A text box 518 is also provided to permit the user to search for product brands by name. The screen of FIG. 5 also includes left and right arrows 512, 514 that are selectable/clickable to control the motion of the carousel on which the product logos 510 are shown. An alternative navigation option using “paginator links” (not shown) may also be used. In such an embodiment, an indication of current page may not be selectable/clickable.

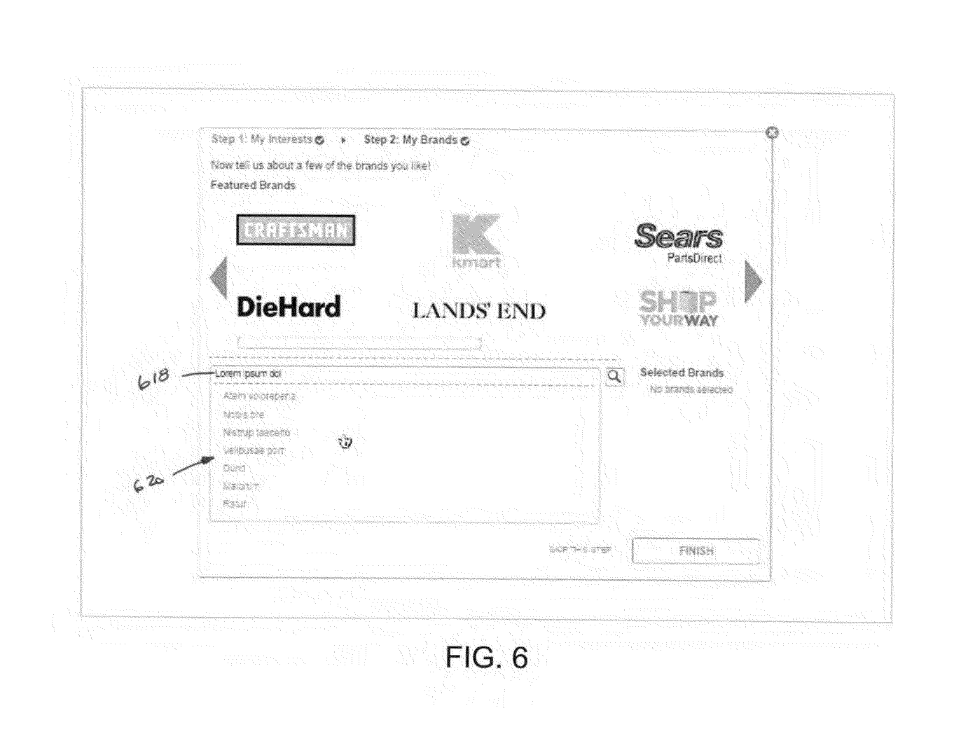

FIG. 6 is an illustration of an exemplary screen such as that shown in FIG. 5, in which a user has elected to enter a search term 618, and is presented with the result of the search 620, in accordance with a representative embodiment of the present invention. The results of the search for a user specified product brand name may, as shown in FIG. 6, be displayed in a drop-down box, to permit the user to select their preferred product brand from a plurality of choices.

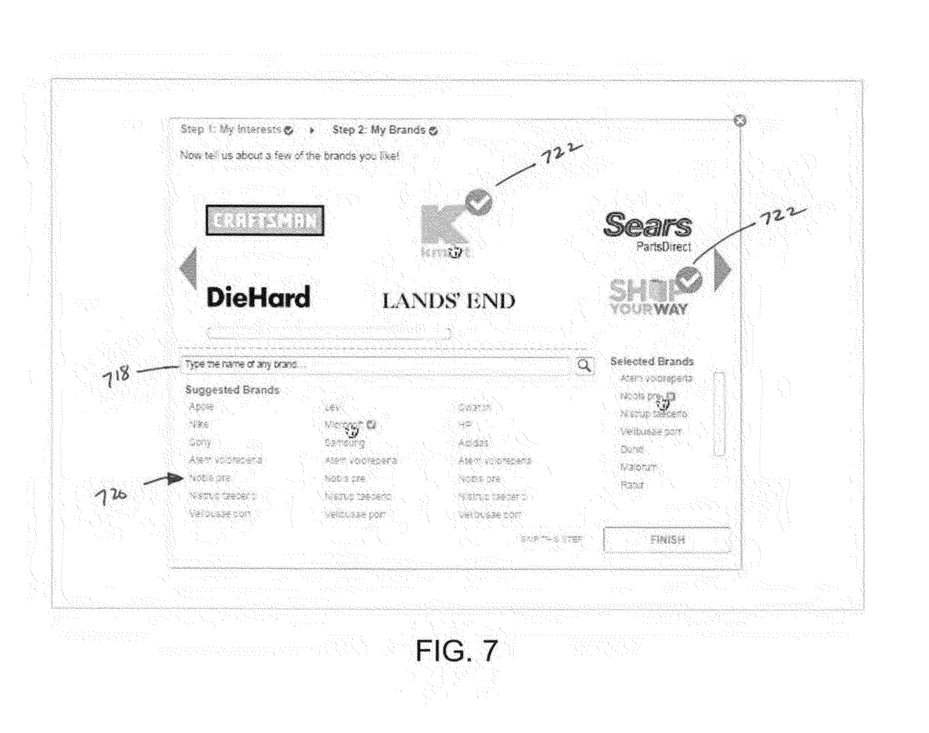

FIG. 7 is an illustration of an exemplary screen such as that shown in FIG. 5, in which a user having entered a search term 718 for which no possible matches are found, is presented a suggested list of brands 720, in accordance with a representative embodiment of the present invention. Check marks 722 indicate those product brands that, for example, have been selected by the user or set as defaults by the operator or sponsor of a representative embodiment of the present invention, and which may be stored in a profile for the user by the system.

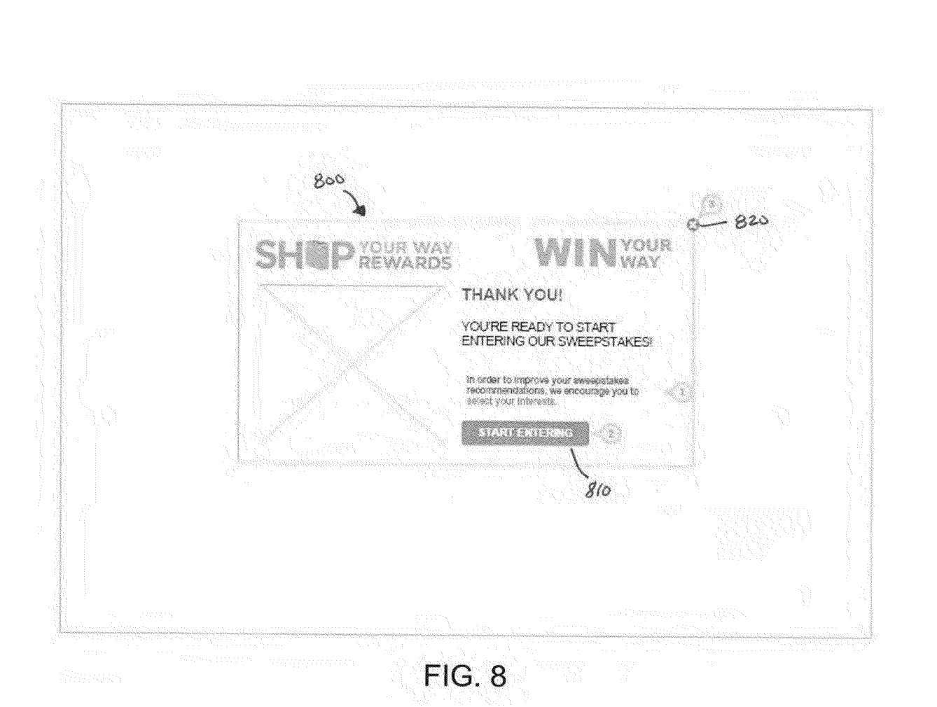

FIG. 8 is an illustration of an exemplary screen image showing a thank you message box 800, in accordance with a representative embodiment of the present invention. The message box 800 of FIG. 8 may be a modal box, and may be displayed once the user has provided information about their area(s) of interest and their preferred brand(s). If the user failed to select an interest area, or skipped the interest selection screen entirely, a message may be displayed with a link to permit the user to return to the selection of personal interests. The screen image illustrated in FIG. 8 may include a “START ENTERING” button 810 that may close the message box 800 and transition the user to a screen view that presents a list of sweepstakes that are recommended for the user based on their personal interests. A “Close” button 820 may be provided to close the message box 800 and transition the user to a screen view listing sweepstakes recommended for the user based on their selected interests.

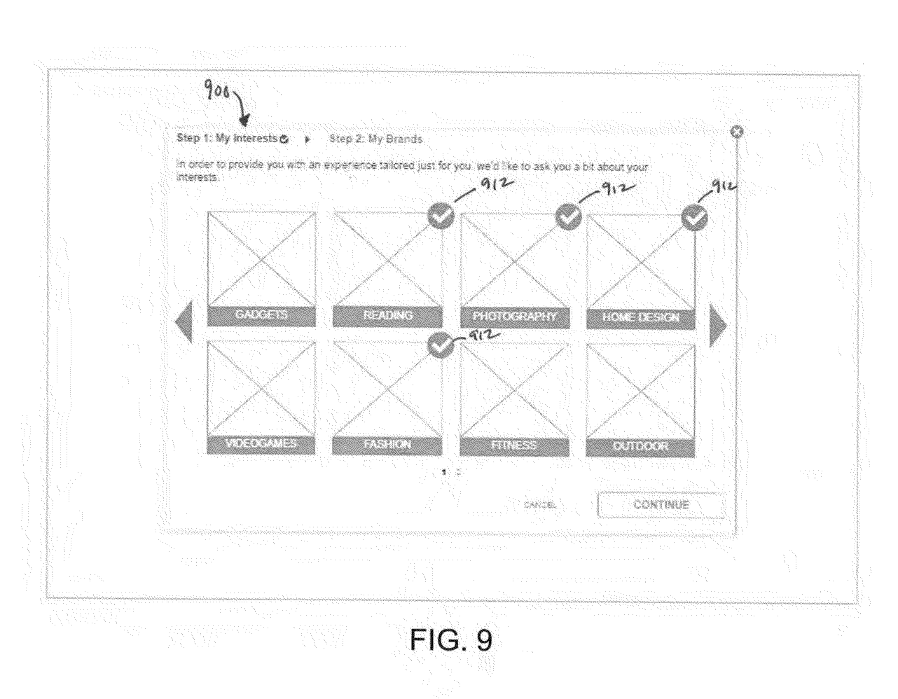

FIG. 9 is an illustration of an exemplary screen image showing an “Edit Interest Preferences” box 900 displaying the current interests of a user, to enable editing of user interest preferences, in accordance with a representative embodiment of the present invention. The “Edit Interest Preferences” box 900 may be a modal box that may be preconfigured or preloaded from a stored user profile, to show the current user interests as indicated by check marks 912, and may permit the user to edit their previously selected areas of interest.

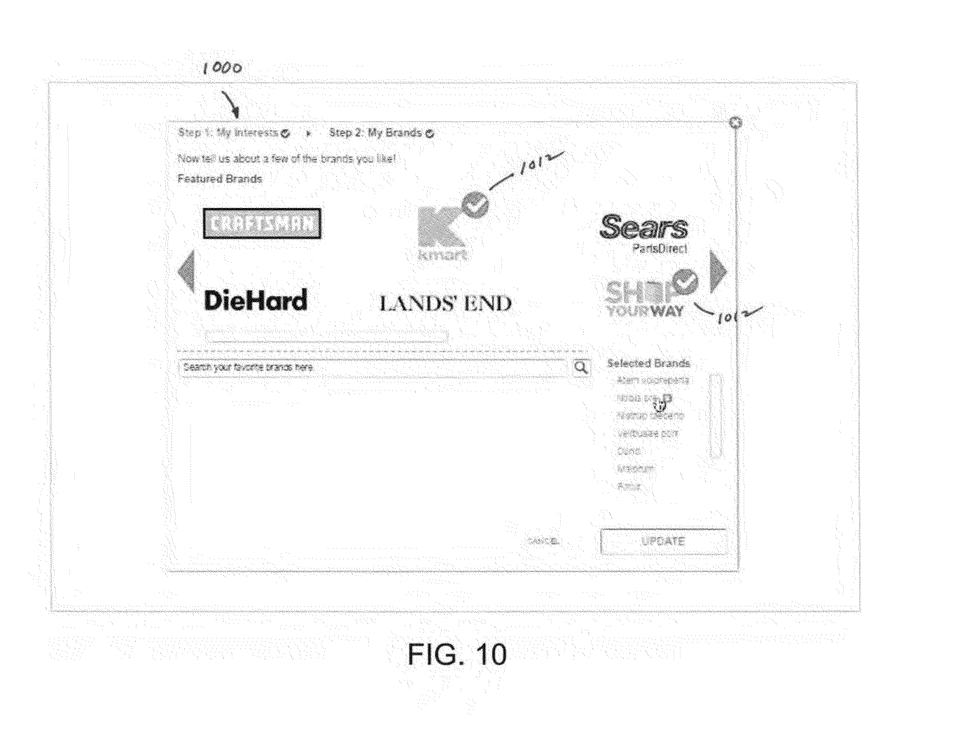

FIG. 10 is an illustration of an exemplary screen image showing an “Edit Brand Preferences” box 1000 displaying the current brands preferences of a user, to enable editing of previously selected product brands preferred by the user, in accordance with a representative embodiment of the present invention. The “Edit Brand Preferences” box 1000 may be a modal box that may be preconfigured or preloaded from a stored user profile, to display the current user preferred brands as indicated by check marks 1012, and may permit the user to edit/change the brands that the user prefers.

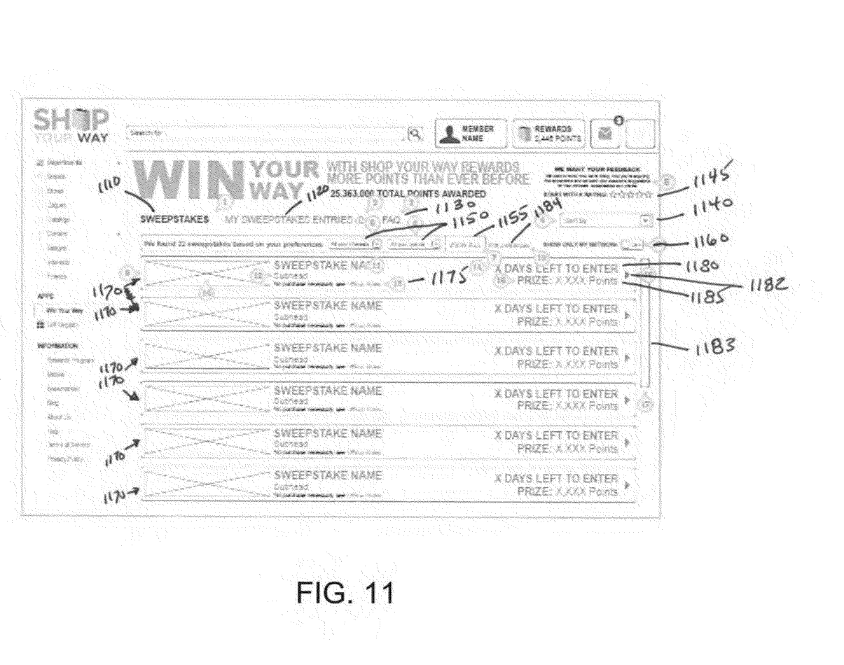

FIG. 11 is an illustration of an exemplary screen image showing a listing of recommended sweepstakes that have been selected for a user based on the personal interests and preferred brands of the user, in accordance with a representative embodiment of the present invention. The sweepstakes identified in a screen such as that shown in FIG. 11 may be default recommendations, which may be based on personal interests and product brands preferences of the user that may, for example, be collected from the user and stored in a user profile by the system of the present invention. The screen image of FIG. 11 includes an active tab 1110 that shows the latest sweepstakes based on the users interests and brands, and a “My Sweepstakes” tab 1120 to permit the user to view his/her current sweepstakes entries. A “FAQ” tab 1130 may result in display of a list of frequently asked questions related to the displayed screen content, which may be shown in a modal box. The screen image includes a sorting dropdown menu 1140 with related options, and rating components 1145 that display related flow. A set of filters 1150 is included that by default may show all sweepstakes based on the user's interests and preferred brands. Clicking on a “VIEW ALL” link 1155 may show all available sweepstakes. The screen image also includes a “SHOW ONLY MY NETWORK” toggle 1160 that may hide/unhide those sweepstakes in which the friends of the user are not participating. As illustrated, each sweepstake shown in FIG. 11 is represented in a collapsed state that includes a selected group of sweepstake details. The user may click anywhere on a particular sweepstakes row 1170 to display expanded details for that sweepstake. In one representative embodiment of the present invention, only one sweepstake may be shown at a time in expanded form, and the listing of sweepstakes may exhibit “accordion” behavior. Each row 1170 of the listing may include a clipped or thumbnail image related to the sweepstake of that row. The screen image includes an “Official Rules” link 1175 for each row that when clicked may display the official rules for the sweepstake of that row in a modal box. Each sweepstakes row of listing of the screen image of FIG. 11 also includes an indication of the time remaining to participate 1180, as the number of days left to the end of the sweepstake. If the amount of time is less than a day, the time may be displayed as hours. If the amount of time is less than an hour, the amount of time may be displayed as minutes. The screen image also includes an indication of the amount (e.g., points) to be awarded 1185 as the sweepstake prize for the sweepstakes of each row. An arrow icon 1182 at the right end of a row for a sweepstake (i.e., in which the arrow is pointing to the right) may be used to expand or emphasize the current state of the sweepstake display from a “collapsed” state to a larger format that provides additional information, as described above. All of the rows shown in FIG. 11 are presented in a collapsed state. A scroll bar 1183 may be included to permit the user to vertically navigate through the entire list of sweepstakes entries. A link 1184 may also be provided to allow the user to open a modal box (not shown) to edit his/her interests/preferences from within the screen shown in FIG. 11.

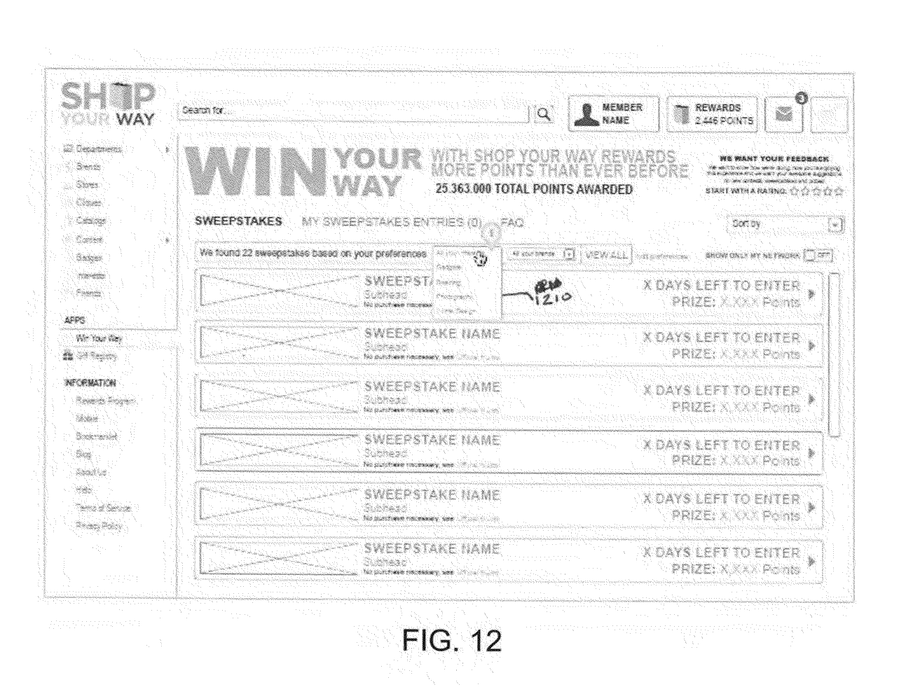

FIG. 12 shows an exemplary screen image showing a listing of recommended sweepstakes that have been selected for a user based on the preferred interests and brands of the user that may correspond, for example, to the screen image of FIG. 11, including a dropdown list 1210 displaying the current interests of the user, in accordance with a representative embodiment of the present invention. The dropdown list 1210 may display all of the user interests, as indicated by the his/her interests of the profile stored for the user by the system.

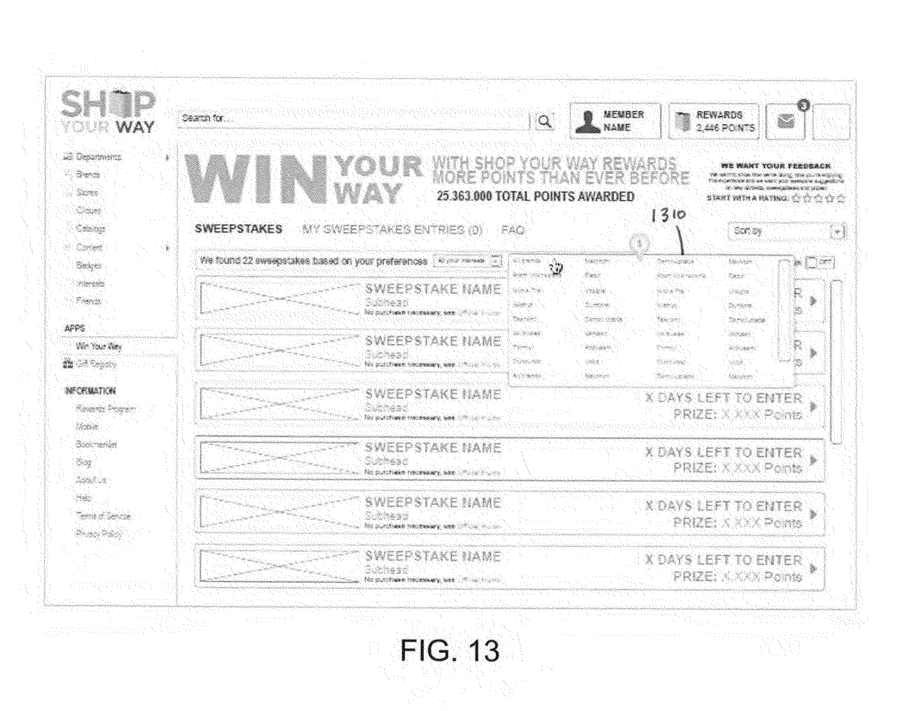

FIG. 13 shows an exemplary screen image showing a listing of recommended sweepstakes that have been selected for a user based on the preferred interests and brands of the user that may correspond to the screen image of FIG. 11, including a dropdown list 1310 displaying the current preferred brands of a user, in accordance with a representative embodiment of the present invention. The dropdown list 1310 may display all of the brands preferred by the user, as indicated by the his/her brand preferences of the profile stored by the system.

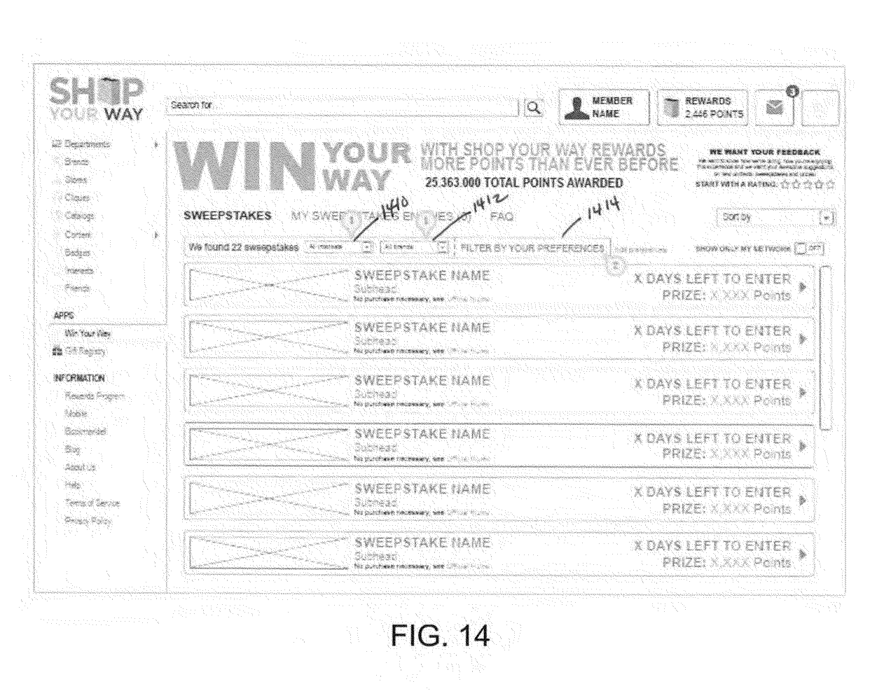

FIG. 14 shows an exemplary screen image showing a listing of recommended sweepstakes that have been selected for a user based on the filters in effect 1410, 1412, in which filters have by default have been set to include all available sweepstakes, in accordance with a representative embodiment of the present invention. In a representative embodiment of the present invention, the default state of filter settings 1410, 1412 may be to include in the listing all available sweepstakes, as shown in FIG. 14. A selectable/clickable screen object 1414 may cause the listing of sweepstakes to show only suggested sweepstakes based on the preferences of the user, which may be maintained by the system in a profile for the user.

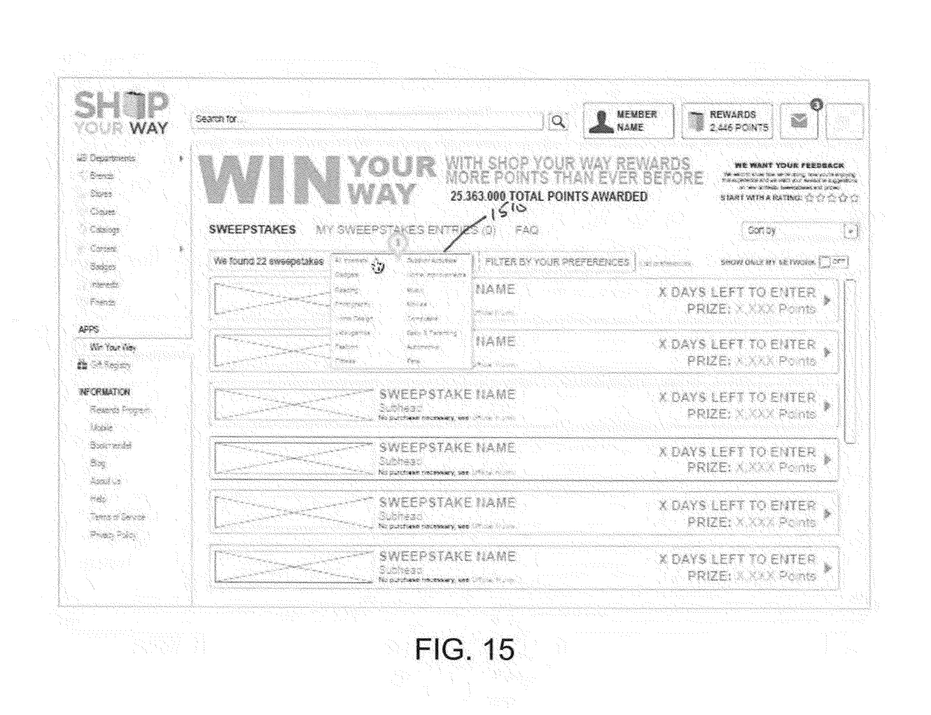

FIG. 15 shows an exemplary screen image showing a listing of all available sweepstakes, including a dropdown list 1510 displaying all of the currently available choices of user interests, in accordance with a representative embodiment of the present invention. In a representative embodiment of the present invention, the dropdown list 1510 may display to the user a listing all available interests that may be indicated in his/her preferences, and that may be selected to narrow the listing of sweepstakes to those of particular interest to the user. If more that a certain number of interests is available, the drop down list 1510 may be scrollable.

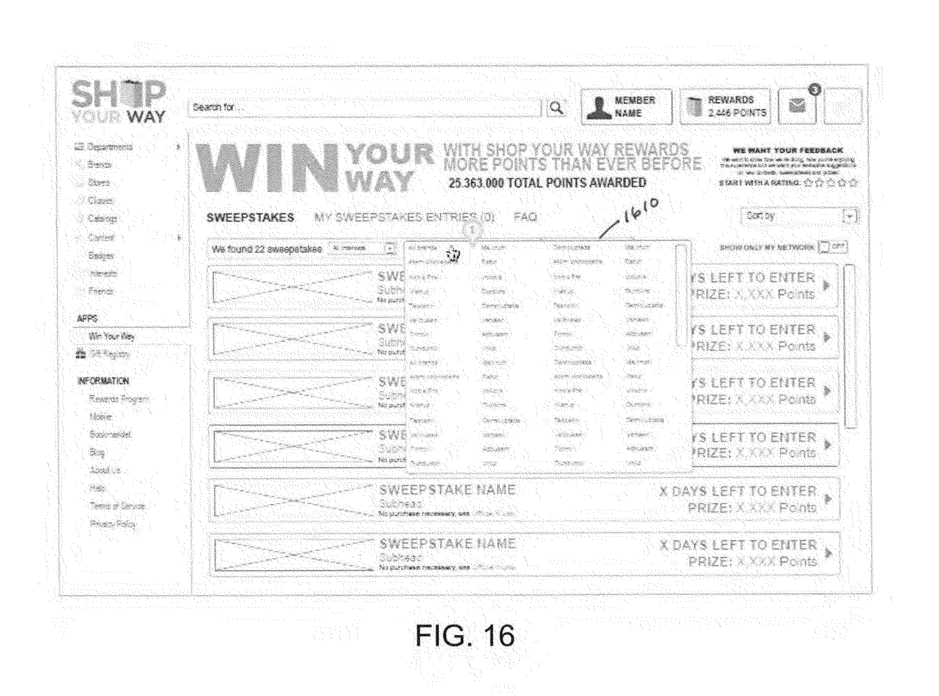

FIG. 16 shows an exemplary screen image showing a listing of all available sweepstakes, including a dropdown list 1610 displaying all of the currently available choices of user preferences of brands, in accordance with a representative embodiment of the present invention. In a representative embodiment of the present invention, the dropdown list 1610 may display to the user a listing all available product brands that the user may indicate as preferred brands in his/her preferences, and that may be selected to narrow the listing of sweepstakes to those of particular interest to the user. If more that a certain number of choices of brands is available, the drop down list 1610 may be scrollable.

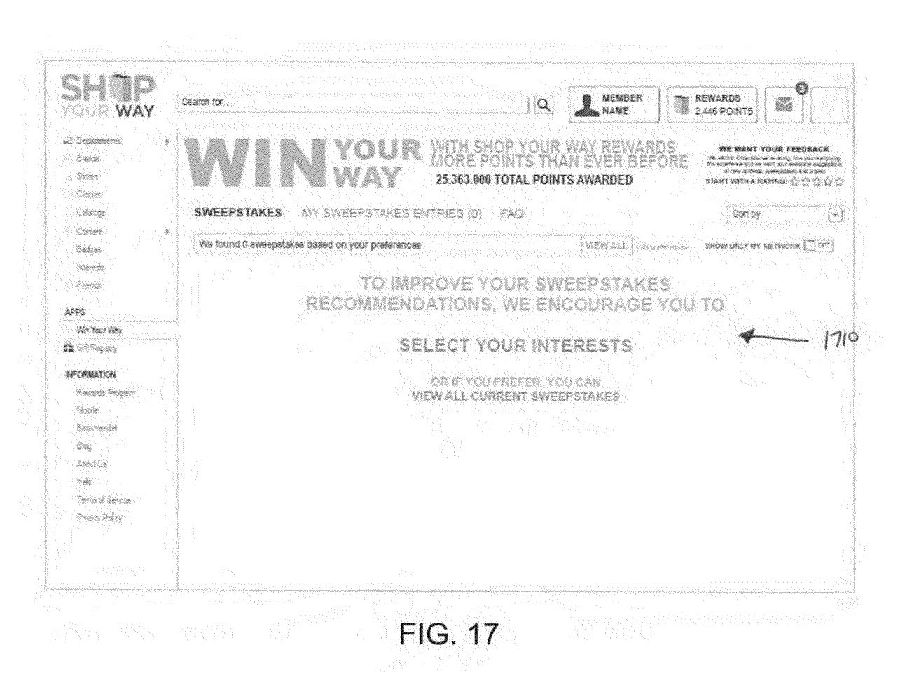

FIG. 17 shows an exemplary screen image showing an exemplary screen image containing a message 1710 to a user that has not indicated by their preferences any user interests, in accordance with a representative embodiment of the present invention. In a representative embodiment of the present invention, the user may then indicate one or more interests using the elements of the screen image of FIG. 17, or may choose to view a listing including all currently available sweepstakes.

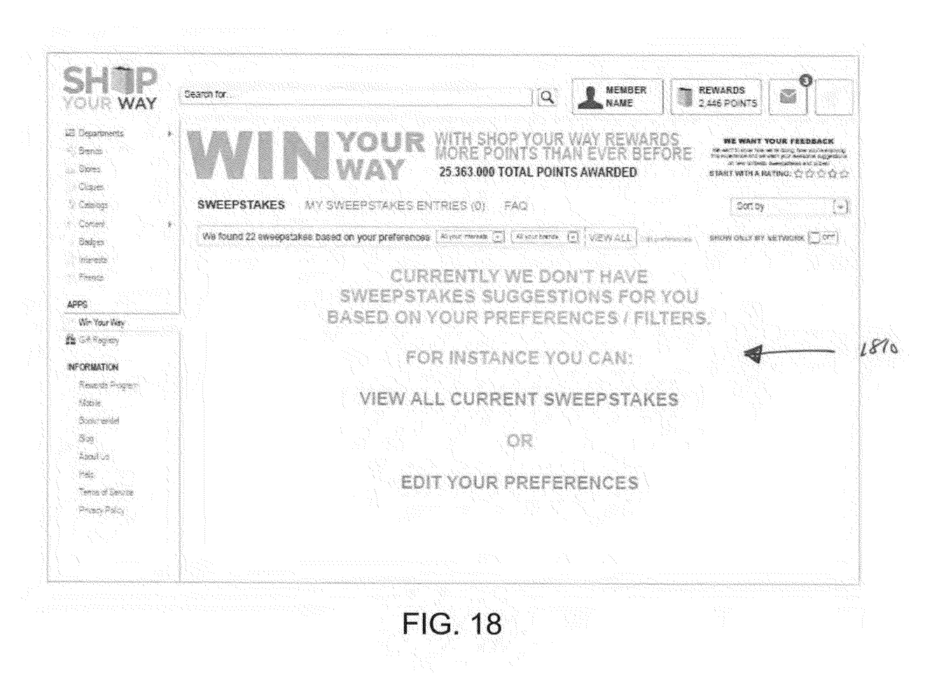

FIG. 18 shows an exemplary screen image showing an exemplary screen image containing a message 1810 to a user that there are no sweepstakes to display based on their personal interests of the user profile, or the filter settings, in accordance with a representative embodiment of the present invention. In a representative embodiment of the present invention, the user may then indicate an interest using the user selectable elements of the screen image shown in FIG. 18, may choose to edit their user preference settings of their user profile, or may choose to view a listing including all currently available sweepstakes.

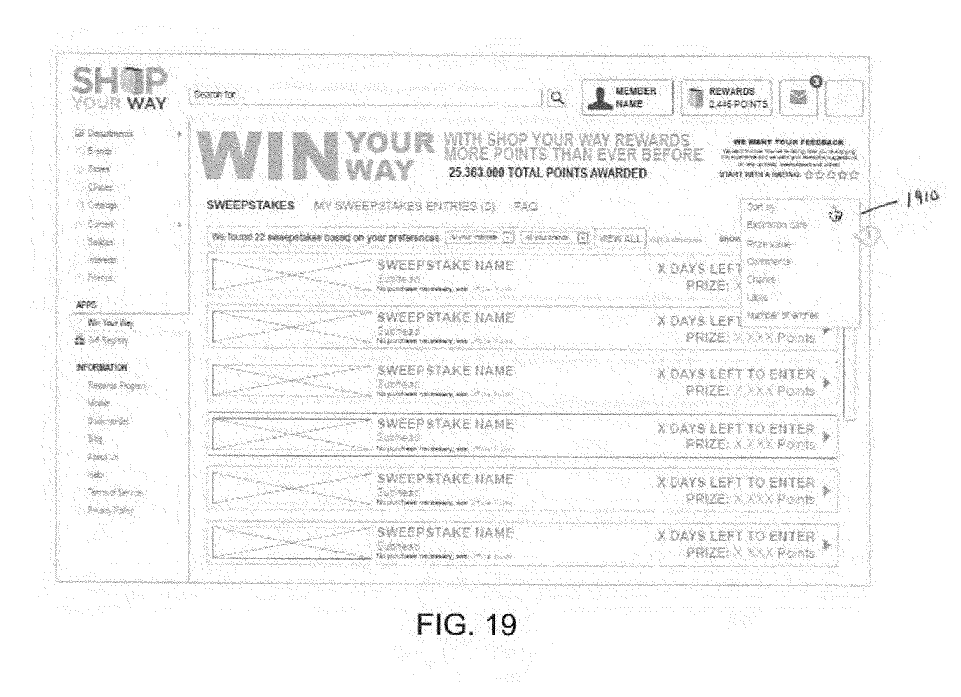

FIG. 19 shows an exemplary screen image showing a listing of all available sweepstakes, including a dropdown list 1910 displaying all of the currently available options in sorting the displayed list of sweepstakes, in accordance with a representative embodiment of the present invention. Upon selection of a sorting option by the user, the sweepstakes list may be rearranged according to the value selected by the user in the dropdown list 1910.

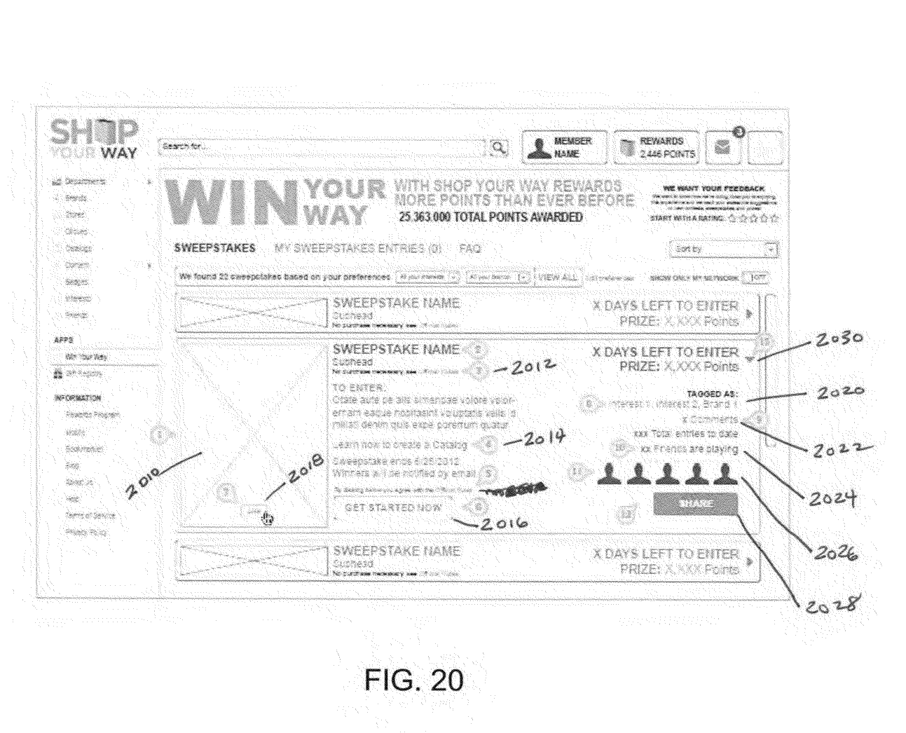

FIG. 20 illustrates an exemplary screen image showing detailed information for a sweepstake selected by the user from the compact or contracted listing of sweepstakes illustrated in FIG. 19, in accordance with a representative embodiment of the present invention. The details shown in FIG. 20 may, for example, be a default set of details. As shown in FIG. 20, the detailed information may include a full image 2010 related to the sweepstake, rather than the clipped or thumbnail image that may be displayed for the “compact” format of rows of the listing showing non-selected sweepstakes. The screen image may include an “Official Rules” link 2012 that, when selected by the user, displays the official rules for the selected sweepstake in a modal box (not shown). In a representative embodiment of the present invention such as that illustrated in FIG. 20, entry to the selected sweepstake may require the user to, for example, create a “catalog” of product items selected by the user. For this reason, the screen image of FIG. 20 includes a link 2014 that, when selected by the user, causes the display of a modal box with information about how to create the required catalog, and an additional “Official Rules” link that may display the official rules of the selected sweepstake in a modal box. The screen image of FIG. 20 also includes a “GET STARTED NOW” button 2016, that the user may select to indicate their interest in participating in qualifying for the selected sweepstake.

The screen image shown in FIG. 20 also includes a “Like” button 2018, that may be displayed when the user scrolls or hover over the image 2010. The selection of the “Like” button 2018 may be tracked through the prizing engine described above, or by another entity in a system such as the system 100 of FIG. 1. Tags 2020 may be included in a screen image such as that shown in FIG. 20, and may be part of a designation or identification of related interest(s)/brand(s). User selection/clicking of the tags 2020 may apply one or more filters that cause display of only those contests/sweepstakes that pertain to the interest or brand tag(s) of this sweepstake entry that has been selected by the user.

The screen image of FIG. 20 also includes a “Comments” link 2022 that when selected/clicked on by the user displays a “Comments” window (not shown). The screen image of FIG. 20 also includes a “Friends” link 2024 that when selected/clicked may cause the display of a list of friends (e.g., members of their personal social network) of the user that are participating in the sweepstake. In a representative embodiment of the present invention, an indication of the number of friends/members of the personal social network of the user may be shown, and a number of profile/thumbnail pictures of friends 2026 (e.g., in the example, five) that are participating in the sweepstake may be shown. The displayed profiles/thumbnails may be selectable/clickable to causing sharing of information about the user and/or selected sweepstake(s) with that selected friend. If no friends of the user are participating in the selected sweepstake(s), information identifying the latest member(s) of the loyalty program to participate in the displayed sweepstake(s) may be shown. A “Share” button 2028 may also be provided, to permit notifying friends and others that the user is participating in a contest or sweepstake. A described herein, such notification may, for example, be via a social network provided by the system 100 of FIG. 1, an email, a message sent via a real-time electronic network such as twitter®, a posting to a page of a social networking system such as Facebook®, or by another suitable communication means. The screen image of FIG. 20 also includes an arrow icon 2030 pointing downward, to indicate that the screen image is currently displaying detailed sweepstake information for the selected sweepstake. The user may cause the detail view of the sweepstake to “collapse” by selecting/clicking the arrow icon 2030, which then may rotate to point towards the right.

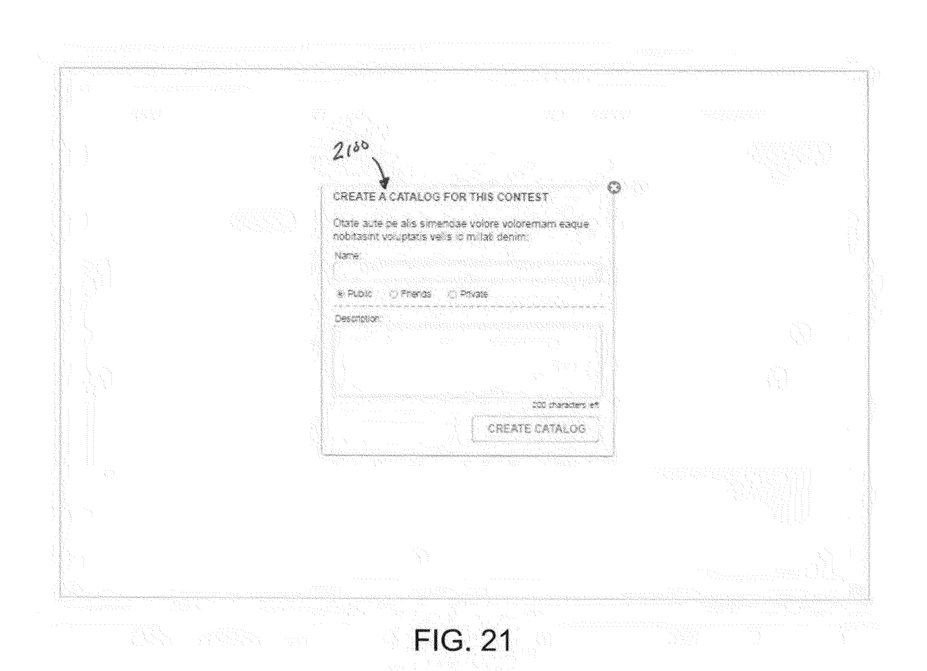

FIG. 21 illustrates an exemplary screen image showing a modal box 2100 that may be displayed in response to a user that has chosen to participate in qualifying for a sweepstake, such as that described above with respect to the “GET STARTED NOW” button 2016 of FIG. 20, in accordance with a representative embodiment of the present invention. As shown in the example of FIG. 21, the user may enter their name, and may choose the accessibility to the catalog by other members as “Public,” “Friends,” or “Private.” The user may also enter a description of the catalog to be created.

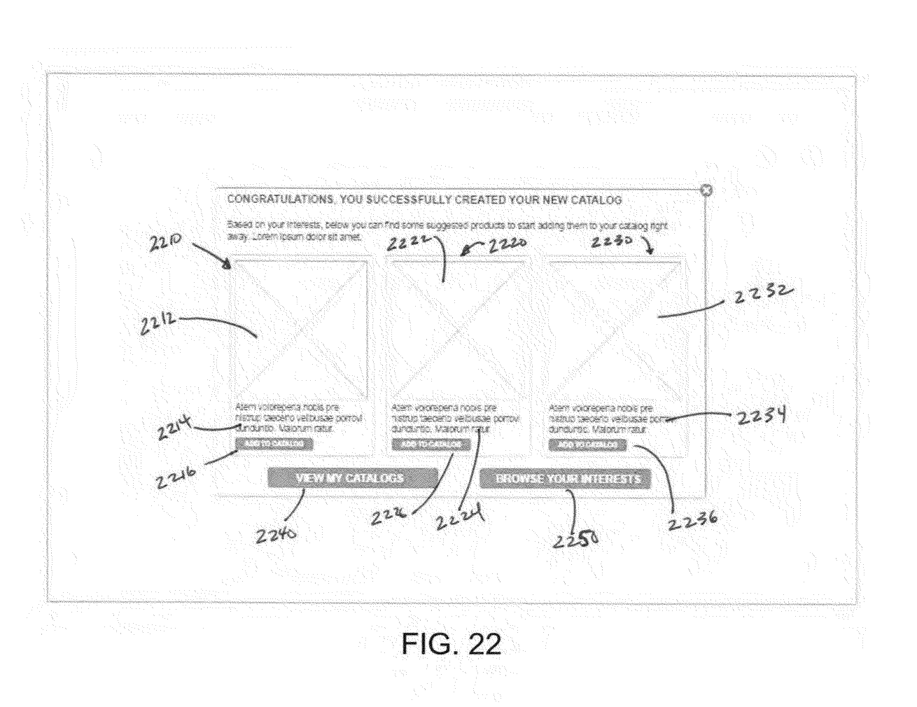

FIG. 22 shows an exemplary screen image showing a selection of products 2210, 2220, 2230 suggested for inclusion in a catalog, where the products 2210, 2220, 2230 have been automatically selected by a system such as the e-commerce system 150 of FIG. 1 based on, for example, the interests of the user, in accordance with a representative embodiment of the present invention. As shown in FIG. 22, the screen image may include an suitably sized image 2212, 2222, 2232 of each product and a corresponding brief description 2214, 2224, 2234 , along with a corresponding button 2216, 2226, 2236 that when selected/clicked adds the product to a catalog currently being created by the user. The screen image also includes a “VIEW MY CATALOGS” button 2240 and a “BROWSE YOUR INTERESTS” button 2250 , to permit the user to review the catalogs of the user, and the interests indicated in the profile of the user.

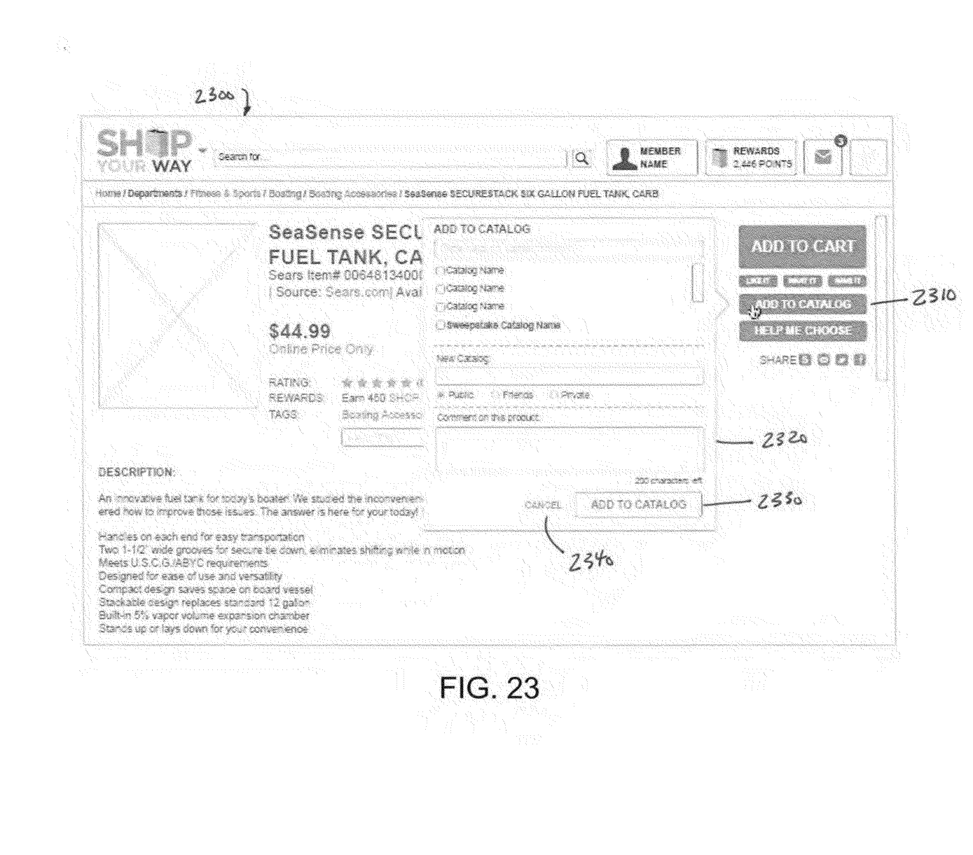

FIG. 23 is an illustration of an exemplary screen image showing a product page 2300 having a selectable/clickable button 2310 to permit the user to indicate the desire to add the currently displayed product to a catalog, in accordance with a representative embodiment of the present invention. As illustrated in FIG. 23, selecting/clicking on the “ADD TO CATALOG” button 2310 may result in the display of a modal box 2320 that permits the user to search for a particular catalog to which the item is to be added. The user may enter the name of the catalog to enable a search of available catalogs, or may choose to create a new catalog in a manner similar to that described above with respect to FIG. 22. The user may then add the displayed product to the catalog found by searching or created by the user, by selecting/clicking the “ADD TO CATALOG” button 2330, or cancel adding the product by selecting/clicking on the “CANCEL” button 2340.

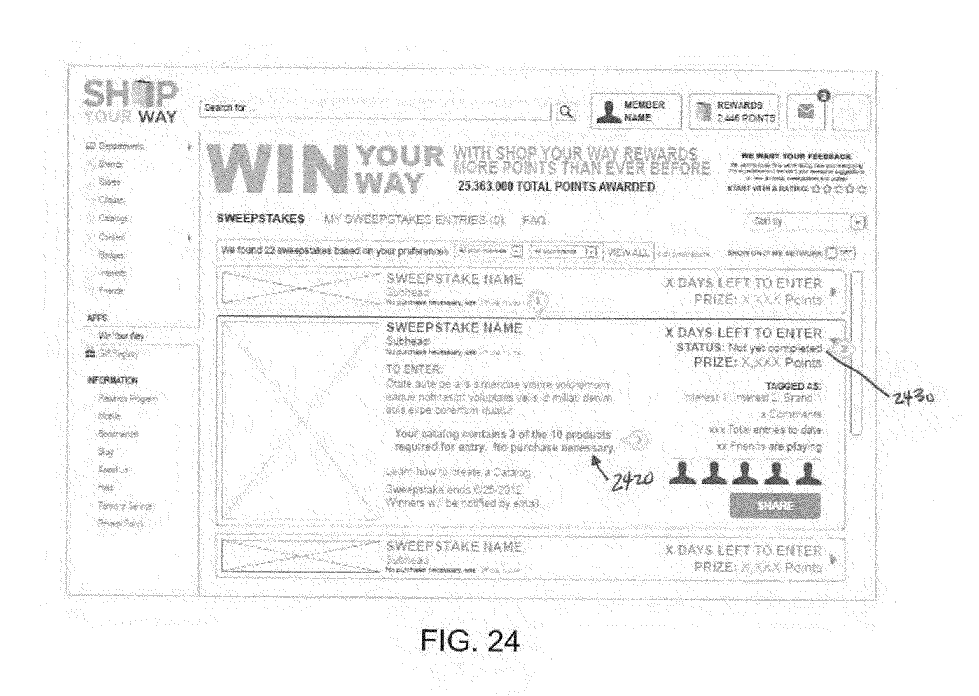

FIG. 24 illustrates an exemplary screen image showing details for a sweepstake in which the user is a participant attempting to qualify for entry, in accordance with a representative embodiment of the present invention. The illustration of FIG. 24 shows detail information 2410 for a selected sweepstake that is similar in many ways to that described above with respect to FIG. 20. However, the detail information of FIG. 24 includes progress information that indicates how far along the user is in completing the task needed to qualify for entry in the selected sweepstake, in this example, the creation of a catalog of products. The detail information also includes completion status information 2430 that indicates whether or not the user has completed the requirement(s) for entry in the selected sweepstake.

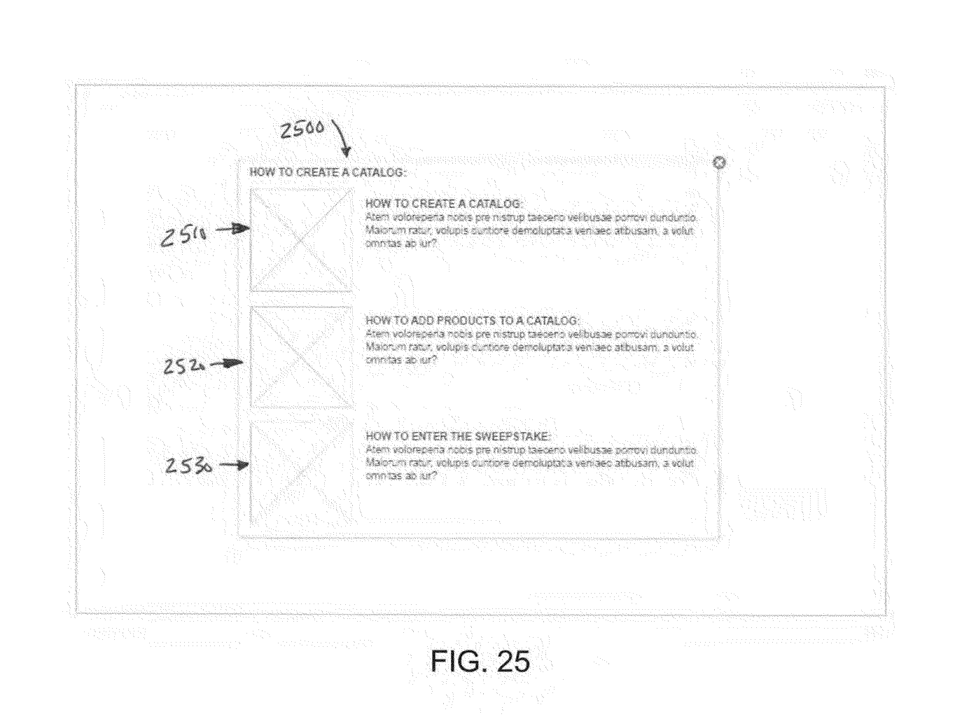

FIG. 25 is an illustration of an exemplary screen image that includes a box 2500 containing information to aid the user in performing a task required to qualify for entry in a sweepstake, in accordance with a representative embodiment of the present invention. As shown in the example of the illustration of FIG. 25, three topics may be selected by the user to learn how to create a catalog 2510, how to add products to a catalog 2520, and how to enter the sweepstake of interest 2530. Although the illustration of FIG. 25 shows only three topics and accompanying images 2512, 2522, 2532, this does not necessarily represent a specific limitation of the present invention, unless explicitly recited by the clams, as the box 2500 may include a greater or lesser number of topics.

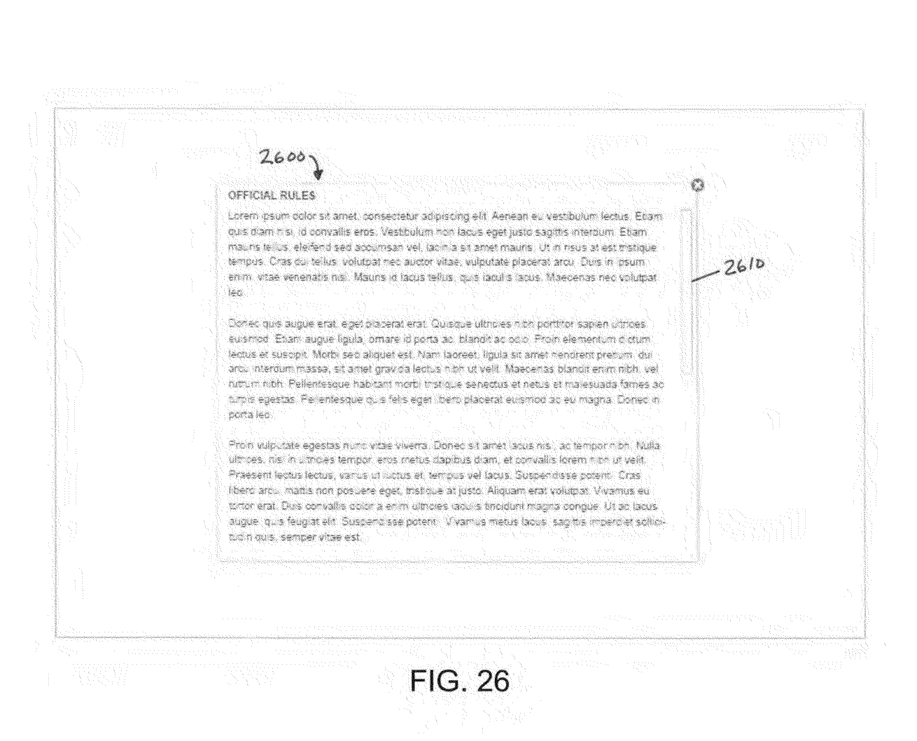

FIG. 26 shows an exemplary screen image that includes a box 2600 containing the “official rules” governing the sweepstake(s), which may be displayed upon selection/clicking upon one or more graphics such as the “Official Rules” links described above with respect to, for example, FIG. 11 and FIG. 20, in accordance with a representative embodiment of the present invention. As shown, the text presented to the user may be accompanied by a scroll bar 2610, to allow the user to scroll the text when the amount of text is unable to be displayed in its entirety within a text area of the displayed box.

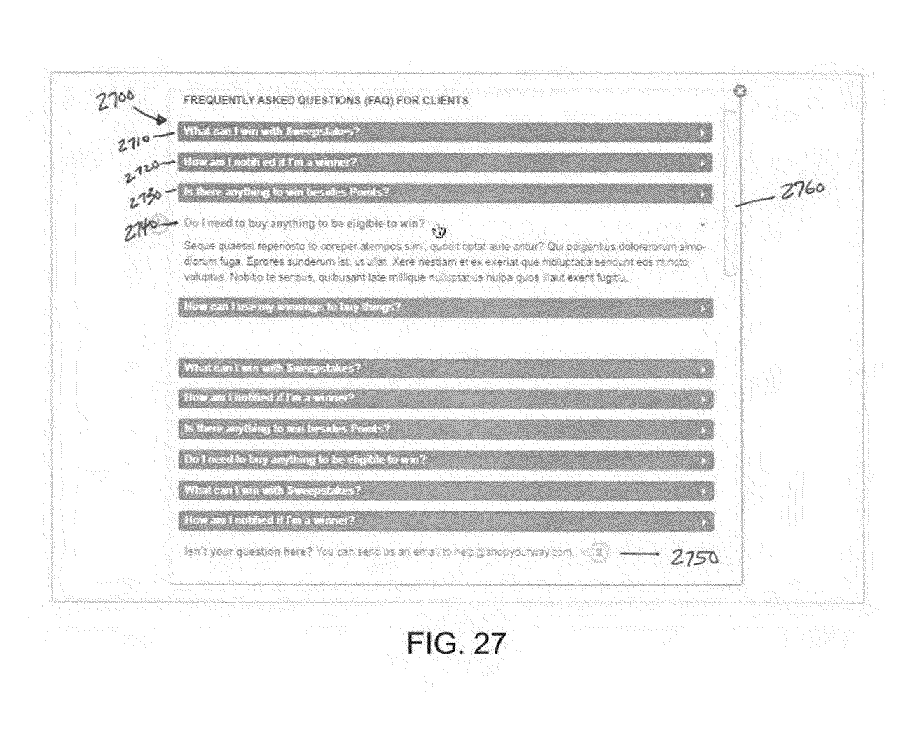

FIG. 27 shows an exemplary screen image that includes a text box 2700 displaying frequently asked questions (FAQs), which may be displayed upon selection/clicking upon one or more graphics such as the “FAQ” links 325, 1130 described above with respect to, for example, FIG. 3 and FIG. 11, in accordance with a representative embodiment of the present invention. The displayed text for each question may first be shown in a collapsed state, as in questions in the first three questions 2710, 2720, 2730 of FIG. 27, in which the text of each question is selectable/clickable. Selecting/clicking upon a line of collapsed text may cause the text to show the full details of the question, as with the fourth questions 2740. The details for multiple questions may be expanded at the same time. In addition, a link 2750 to an email address through which to ask questions not listed may be provided. That link may always be visible without regard to the state of any of the questions (i.e., collapsed or full text) shown. As shown in FIG. 27, the text presented to the user may be accompanied by a scroll bar 2760, to allow the user to scroll the text when the amount of text is unable to be displayed in its entirety within a text area of the displayed box.

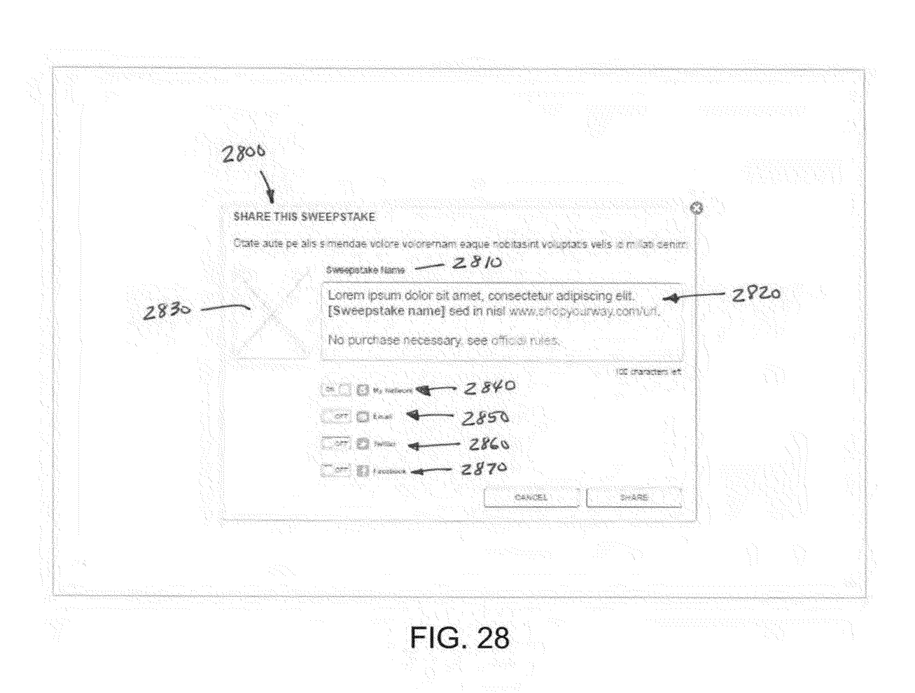

FIG. 28 is an illustration of an exemplary screen image that includes a dialog box 2800 to enable a user to share with others, via email and social media, information about participation of the user in a contest or sweepstake, in accordance with a representative embodiment of the present invention. The screen image of FIG. 28 includes the name of the sweepstake 2810, the text of a brief description of the sweepstake 2820, and a clipped or thumbnail image 2830 related to the sweepstake. In addition, the box of FIG. 28 includes a “My Network” control 2840 to permit the user to indicate whether the sharing is to take place with members of the personal network, an “email” control 2850 to permit the user to indicate whether the sharing is to use email, a “twitter” control 2860 to permit the user to indicate whether the sharing is to take place via the twitter® real-time information network, and a “Facebook” control 2870 to indicate whether sharing is to be with a user page on the Facebook® social network. It should be noted that the use of the specific communication mechanisms and networks identified above in the sharing of information related to user participation in contests and sweepstakes as described herein is not necessarily a specific limitation of a representative embodiment of the present invention, unless explicitly recited by the accompanying claims, and that other means of communication may be employed without departing from the spirit and scope of the present invention.

In a representative embodiment of the present invention, the dialog box 2800 of FIG. 28 may request an email address of the user, when the user is not logged in. The dialog box 2800 may include a means of text entry, such as a text box, to describe the sweepstake, and information identifying the intended recipients of the shared information may be entered, up to a certain number of recipients (e.g., five). The information identifying the recipients may be separated by commas. The text 2820 describing the sweepstake may be preloaded with a default message, and the user may edit the text of the message to be shared. A means such as, for example, Captcha®, may be employed to prohibit automated generation of the messages to be shared. In the example of FIG. 28, only the personal social network provided by the business operator or sponsor of the system 150 is enabled for sharing (i.e., the control 2840 for sharing with “My Network” is set to “ON”).

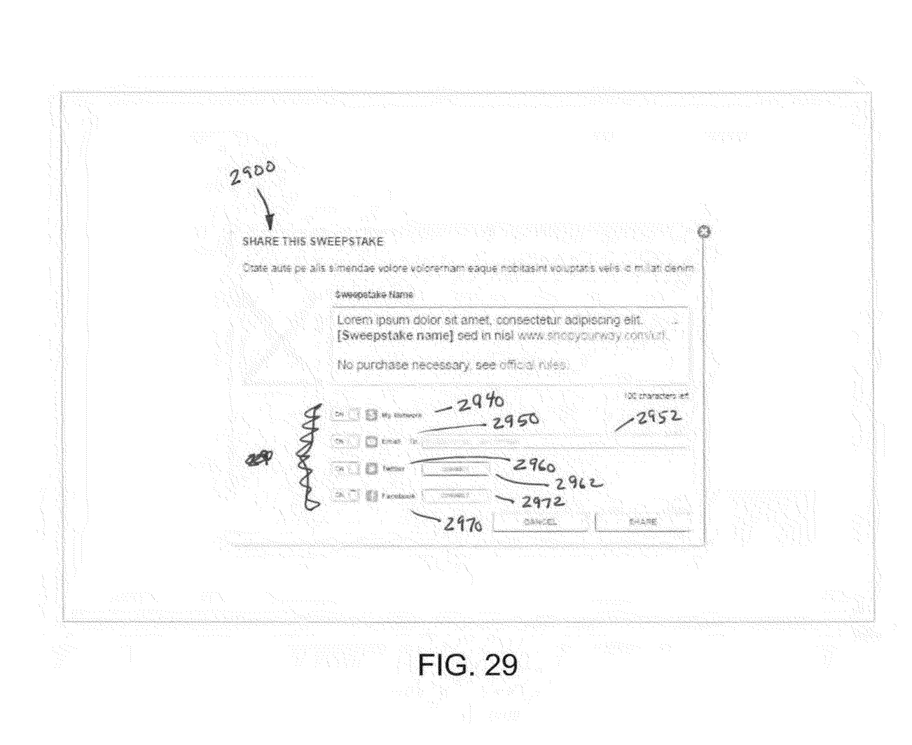

FIG. 29 illustrates an exemplary screen image having a dialog box 2900 that may correspond to the dialog box 2800 of FIG. 27, in which the user has enabled sharing of information about participation of the user in a contest or sweepstake via all of the email and social media communication options 2840, 2850, 2860, 2870, in accordance with a representative embodiment of the present invention. As can be seen in FIG. 29, the users has set the controls 2940, 2950, 2960, 2970 for each of the sharing choices to “ON,” which causes the a text box 2952 for the identification of email recipient(s) to appear, and controls 2962, 2972 to enable connections via the twitter® and Facebook® electronic communication networks, respectively, to be made available.

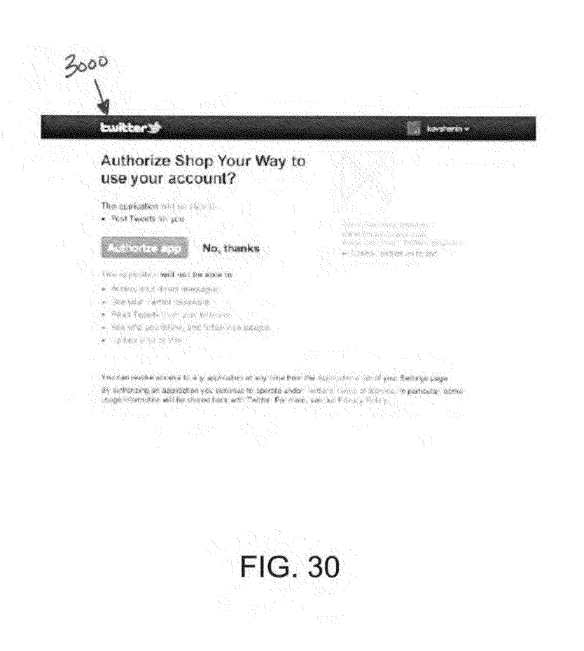

FIG. 30 shows an exemplary screen image for an authorization dialog box 3000 to permit the use of the twitter® real-time electronic communication system by a system such as, for example, the system 150 of FIG. 1, in accordance with a representative embodiment of the present invention.

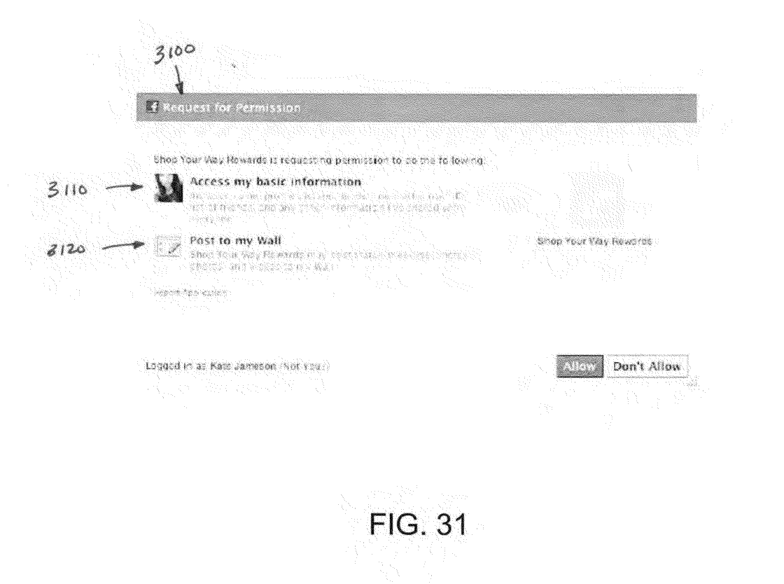

FIG. 31 shows an exemplary screen image for an authorization dialog box 3100 to permit the use of the Facebook® social communication network by a system such as, for example, the system 150 of FIG. 1, in accordance with a representative embodiment of the present invention. As shown in FIG. 31, the Facebook® authorization dialog box 3100 may include a control 3110 to authorize a system in accordance with the present invention, such as the system 150 of FIG. 1, access basic information of a Facebook® user, and may include a control 3120 to authorize a system such as, for example, the system 150 to post messages to the “Wall” or timeline of a Facebook® account.

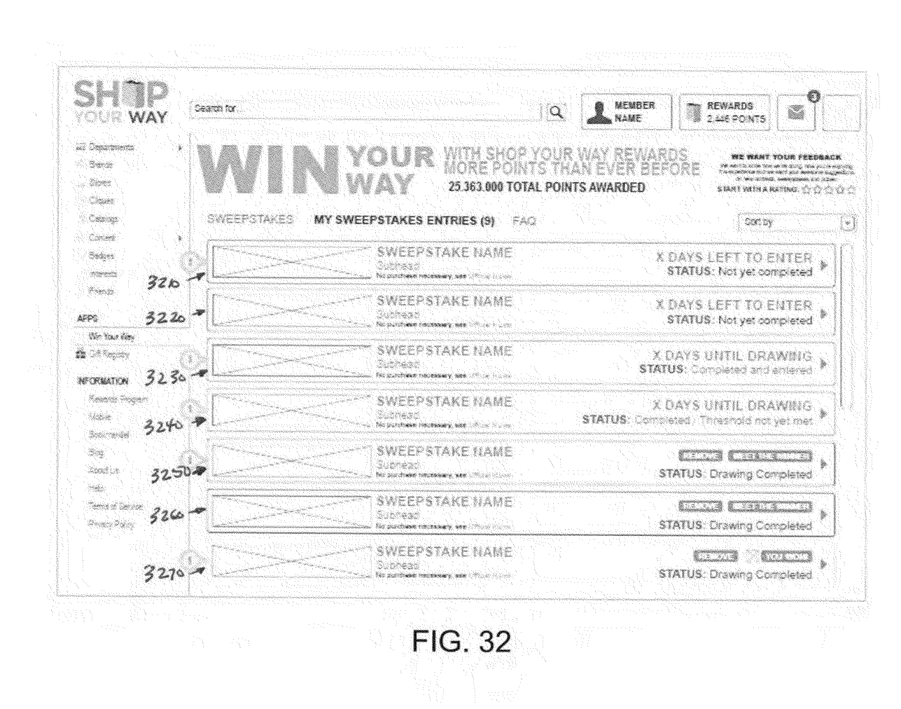

FIG. 32 shows an exemplary screen image showing a listing of sweepstakes for a user, in accordance with a representative embodiment of the present invention. The illustration of FIG. 32 shows two rows 3210, 3220 of the listing for identifying two sweepstakes for which the user is attempting but has not yet qualified for entry, and one row 3230 identifying a sweepstake in which the user has qualified and is entered but which has not yet held a drawing. The illustration of FIG. 32 also shows a row 3240 in which the user has qualified and is entered, but in which a threshold required to hold a drawing has not yet been met (e.g., number of people that have qualified is too low). In addition, the screen image of FIG. 32 also illustrates two rows 3250, 3260 for sweepstakes that have completed and for which a winner other than the user has been drawn. A row 3270 of the listing is also shown for a sweepstake in which the user was entered in which the user won.

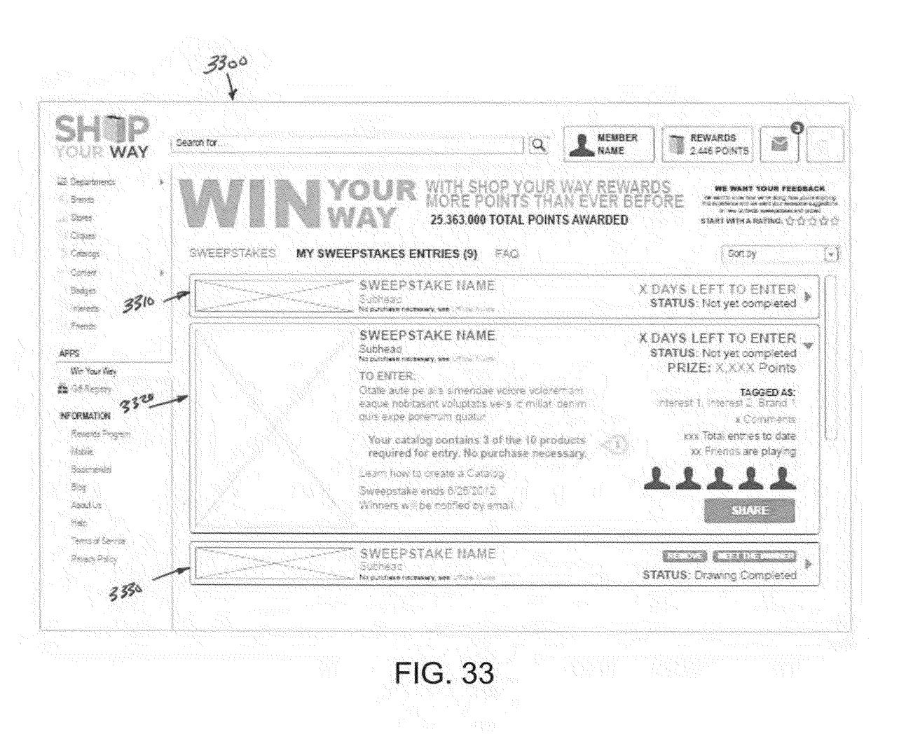

FIG. 33 is an illustration of an exemplary screen image 3300 showing another listing of sweepstakes for a user, in accordance with a representative embodiment of the present invention. The illustration of FIG. 33 shows rows of information for three sweepstakes, including a first row 3310 that identifies a sweepstake for which the user is attempting but has not yet qualified for entry, a second row 3320 that displays detailed information for a sweepstake in which the user has not yet completed the required task(s) and therefore has not qualified for entry, and a third row 3330 for a sweepstake in which the user qualified and was entered, but in which the user was not a winner.

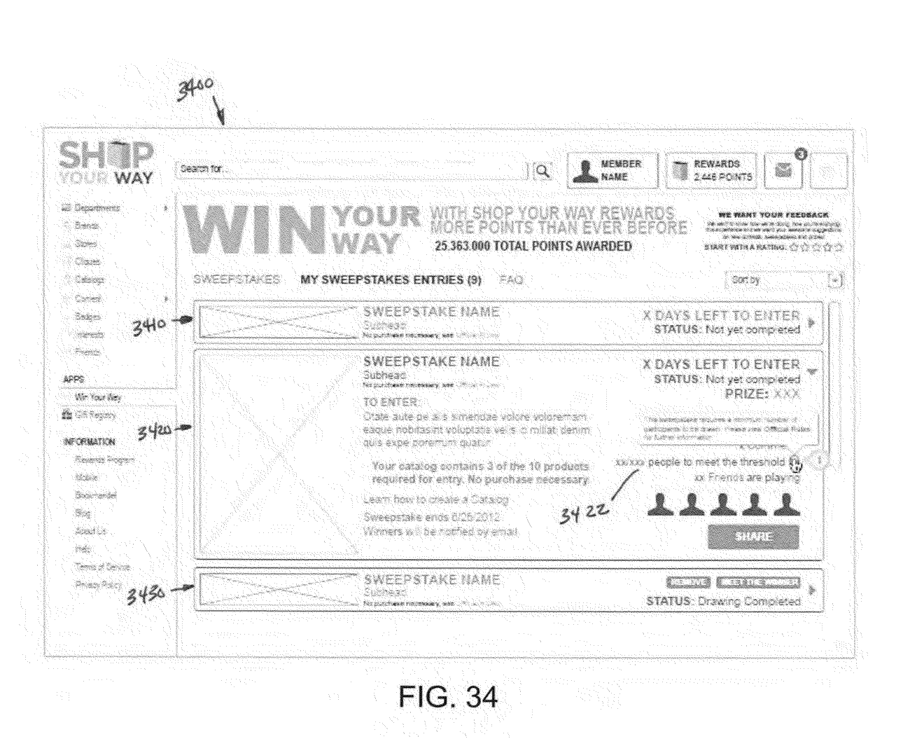

FIG. 34 is an illustration of an exemplary screen image 3400 showing another listing of sweepstakes for a user, in accordance with a representative embodiment of the present invention. As shown in FIG. 34, three rows of information for three sweepstakes are shown. The first row 3410 identifies a sweepstake for which the user is attempting but has not yet qualified for entry. The second row 3420 displays detailed information for a sweepstake in which the user has not yet completed the required task(s) and therefore has not qualified for entry. In addition, there is included an threshold indication 3422 that the sweepstake has a requirement that a certain number of the total number of participants must meet the qualification for entry before a drawing will be held and a winner announced. The listing of sweepstakes in the example of FIG. 34 also includes a third row 3430 identifying a sweepstake in which the user qualified and was entered, but in which the user was not a winner.

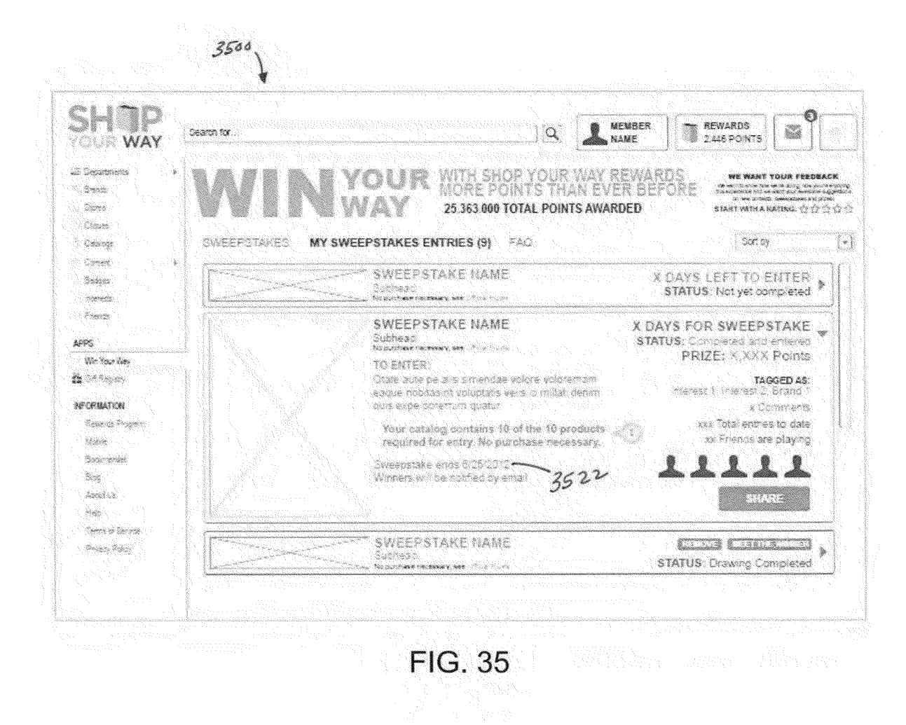

FIG. 35 is an illustration of an exemplary screen image 3500 showing another listing of sweepstakes for a user, in accordance with a representative embodiment of the present invention. As in FIG. 33, the illustration of FIG. 35 depicts three rows of information for three sweepstakes. While the first row 3510 and the third row 3530 are the same as the corresponding rows of the listing of FIG. 34, the information for the sweepstake of the second row 3520 of the listing shows detailed information for a sweepstake in which the user has completed the required task(s) and therefore has qualified for entry. The row for this sweepstake also shows an ending date 3522, indicating when the sweepstake closes. Other user interface elements of the listing of sweepstakes of FIG. 35 have been described above with respect to one or more of FIGS. 10-34, and will not be described again here.

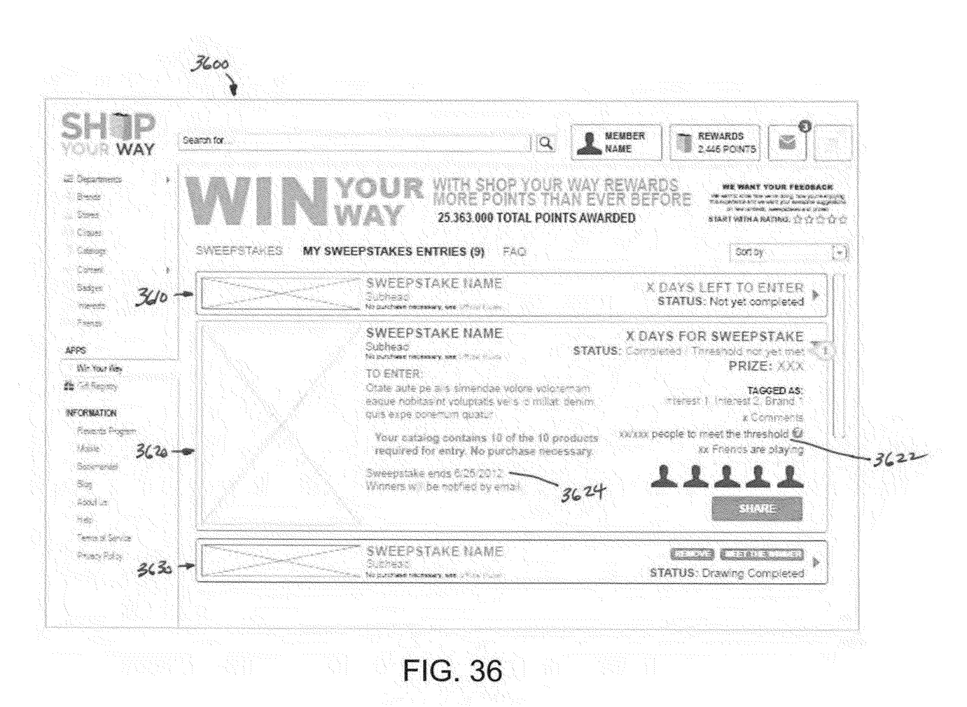

FIG. 36 is an illustration of an exemplary screen image 3600 showing yet another listing of sweepstakes for a user that is similar in ways to the illustration of FIG. 33, in accordance with a representative embodiment of the present invention. As in FIG. 33, the illustration of FIG. 36 depicts three rows of information for three sweepstakes. While the first row 3610 and the third row 3630 are the same as the corresponding rows of the listing of FIG. 34, the information for the sweepstake of the second row 3620 of the listing shows detailed information for a sweepstake in which the user has completed the required task(s) and therefore has qualified for entry. The detailed information for the sweepstake of the second row 3620, however, also includes a threshold indication 3622 that the sweepstake has a requirement that a certain number of the total number of participants must meet the qualification for entry before a drawing will be held and a winner announced, and that the number required has not been met. Like FIG. 34, the second row 3620 of information for this sweepstake also shows an ending date 3624, identifying the closing date of the sweepstake. Other user interface elements of the listing of sweepstakes of FIG. 36 have been described above with respect to one or more of FIGS. 10-34, and will not be described again here.

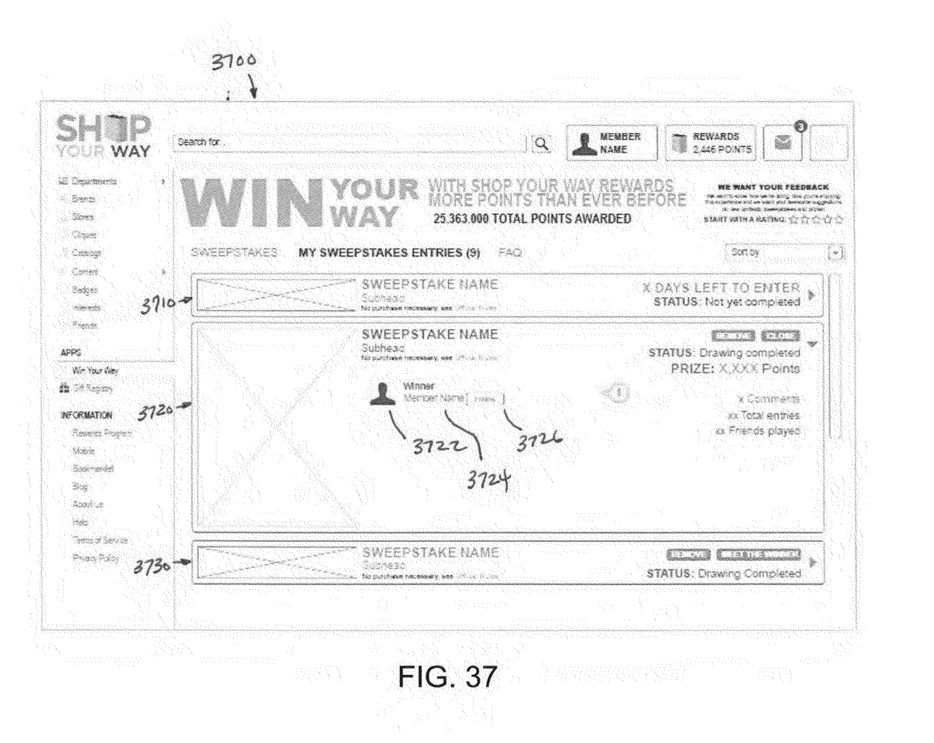

FIG. 37 is an illustration of an exemplary screen image 3700 showing another listing of sweepstakes for a user, in accordance with a representative embodiment of the present invention. Again as in FIG. 33, the illustration of FIG. 37 illustrates three rows of information for three sweepstakes. The first row 3710 and the third row 3730 of the listing of FIG. 37 contain the same information as the corresponding two rows of the listing of FIG. 33. The information for the sweepstake of the second row 3720 of the listing, however, shows detailed information for a sweepstake that has closed and for which another user was designated as the winner. The row 3720 for this sweepstake also shows an image 3722 representing the winner, the winning member's name 3724, and a “Follow” control 3726 to enable the user to indicate to the system (e.g., the system 150) that the user wishes to automatically receive social media content (e.g., messages, postings, and the like), as content is produced by or about the winner.

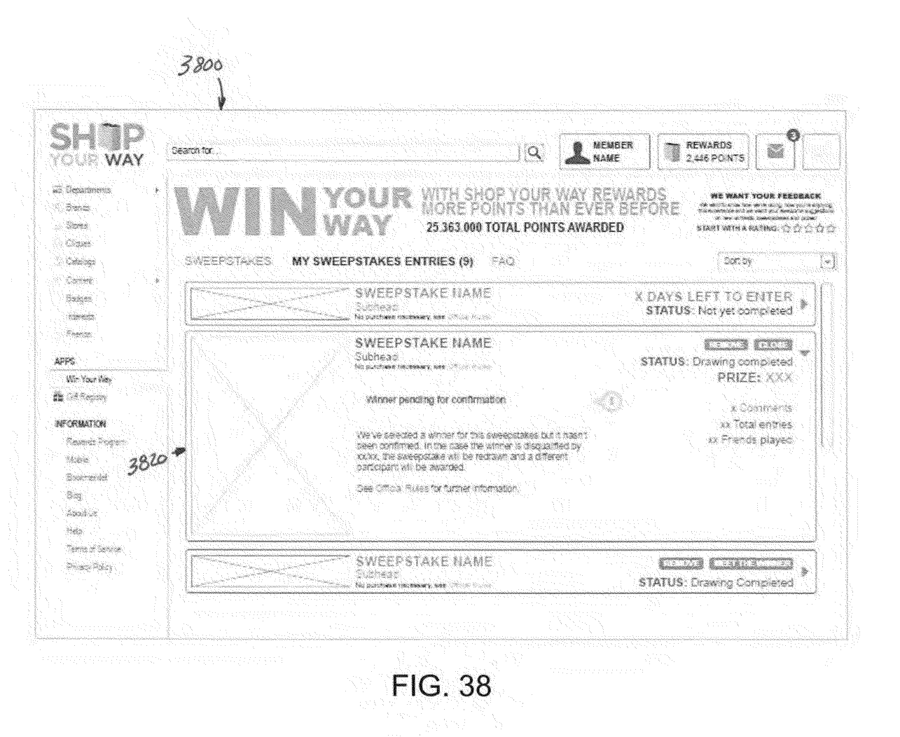

FIG. 38 is an illustration of an exemplary screen image 3800 showing another listing of sweepstakes for a user, in accordance with a representative embodiment of the present invention. FIG. 38 is similar in many ways to the illustration of FIG. 37 with the exception of the second row 3820 of the listing, which provides details for a sweepstake that has closed, and for which a winner has been identified. In the case of this sweepstake, however, the announcement of the winner is being withheld until, for example, the winner has provided required agreements or documents for the administration of the sweepstake, or adherence to government requirements such as arrangement for assessment or payment of any taxes that may be due. Should the winner fail to provide the required materials, an alternate winner may be automatically selected from those that qualified for entry in the sweepstake of the second row.

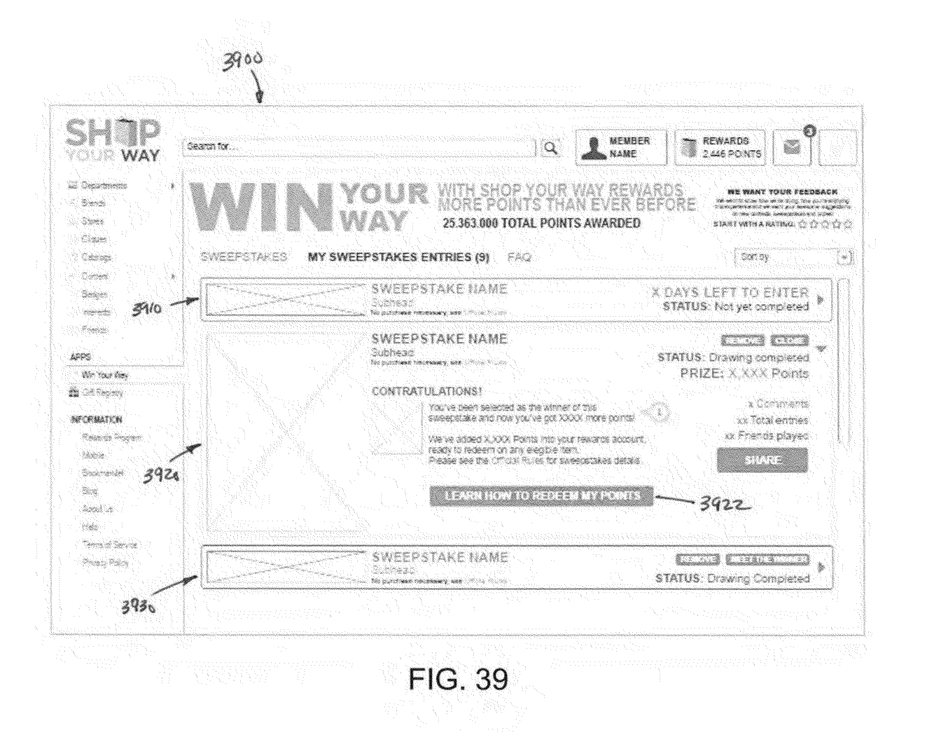

FIG. 39 is an illustration of an exemplary screen image 3900 showing another listing of sweepstakes for a user, in accordance with a representative embodiment of the present invention. In the illustration of FIG. 39, the first and third rows 3910, 3930 of the sweepstake listing are the same as those of FIG. 34. The second row 3920 of the listing of FIG. 39, however, presents details for a sweepstake that has closed, and for which the user is the winner. The information of the second row 3920 congratulates the winner, indicates the prize that has been awarded, and provides a button 3922 which, when selected/clicked provides guidance to the user on how to redeem the prize, which in the illustration of FIG. 39 is a number of reward points for the loyalty program of the business operator or sponsor of the system 150.

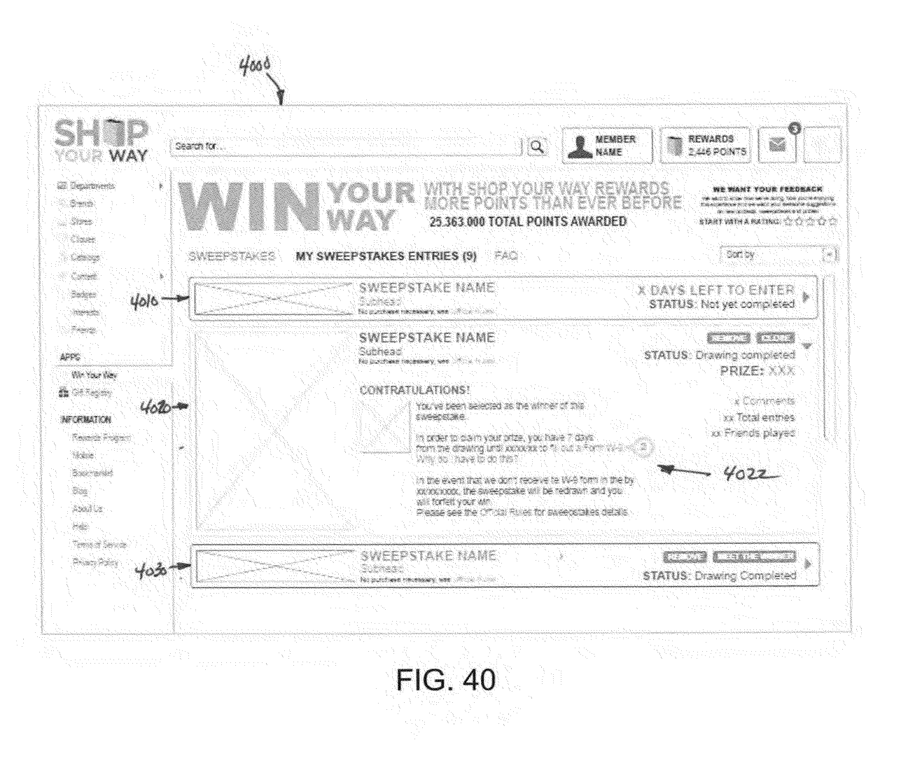

FIG. 40 is an illustration of an exemplary screen image 4000 showing another listing of sweepstakes for a user, in accordance with a representative embodiment of the present invention. In the illustration of FIG. 40, the first and third rows 4010, 4020 of the sweepstake listing are the same as those of FIG. 39. The second row 4020 of the listing of FIG. 40, however, provides a description of conditions 4022 that must be met before the winner is able to receive the prize award.

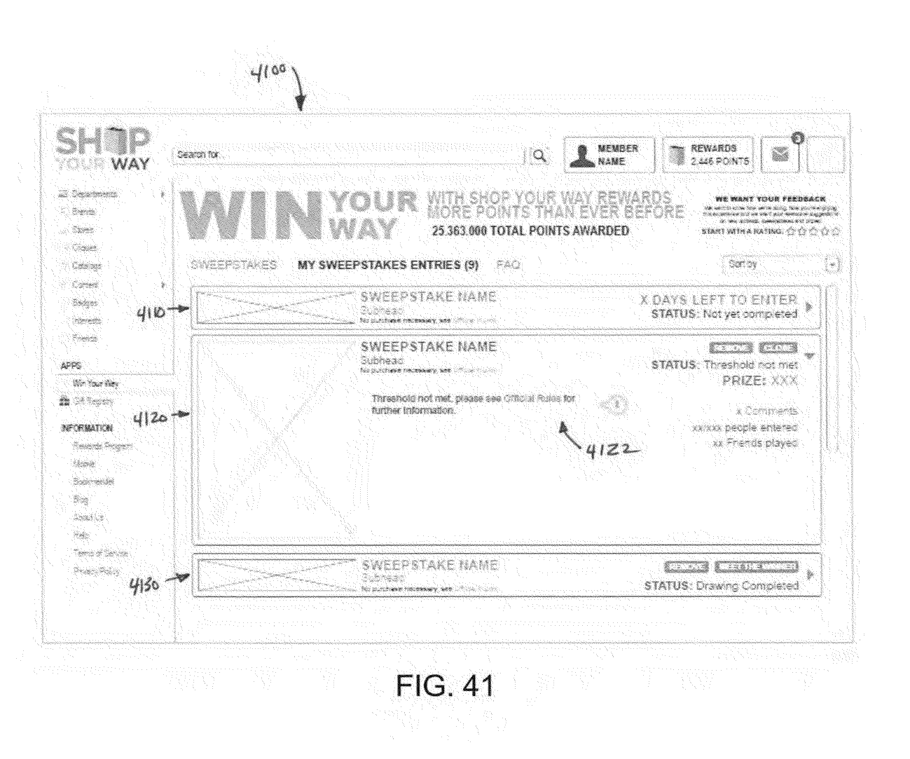

FIG. 41 is an illustration of an exemplary screen image 4100 showing another listing of sweepstakes for a user, in accordance with a representative embodiment of the present invention. In the illustration of FIG. 41, the first and third rows 4110, 4130 of the sweepstake listing are the same as those of FIG. 34. However, in the case of FIG. 41, the second row 4120 of the listing of sweepstakes is an announcement that the threshold of participants that qualified for entry in the sweepstakes has not been met by the expiration or closing date of the sweepstake.

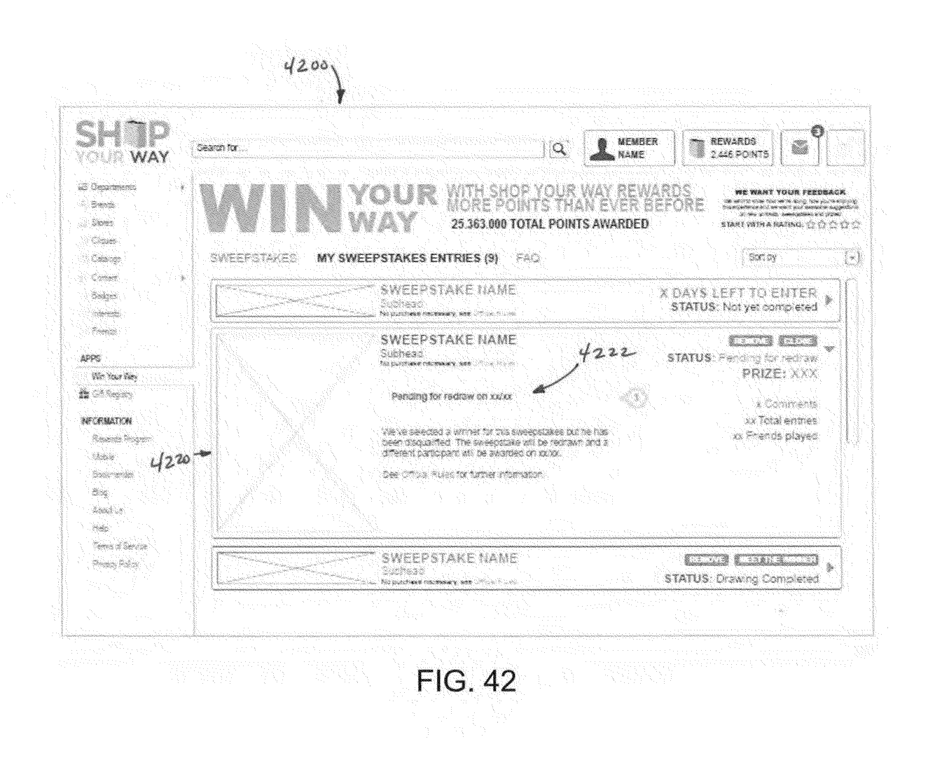

FIG. 42 is an illustration of an exemplary screen image 4200 showing another listing of sweepstakes for a user, in accordance with a representative embodiment of the present invention. FIG. 42 is similar in many ways to the illustration of FIG. 38, and may be displayed when the winner of the sweepstake of row two 4220 fails to provide the materials discussed above with respect to FIG. 38. Row two 4220 of the screen image of FIG. 42 notifies the entrant in the sweepstakes that another winner will be selected and the date when that will occur. The status 4222 of the sweepstake information of row two 4220 is shown in FIG. 42 as “Pending for redraw.” In a representative embodiment of the present invention, the non-winning entrants may be notified via their selected communication means of the re-drawing of the sweepstake.

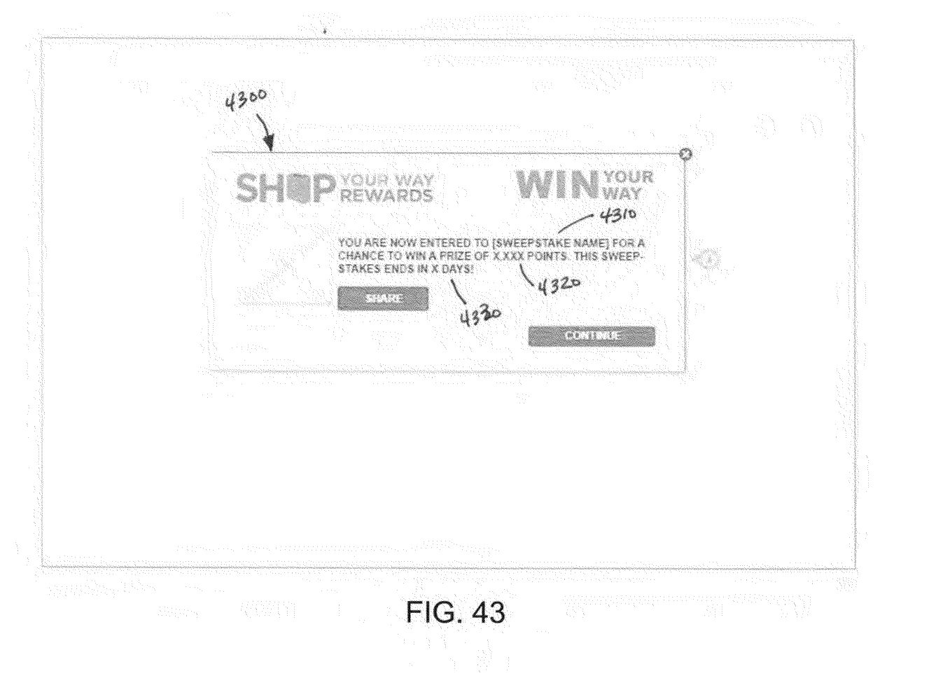

FIG. 43 is an illustration of an exemplary screen image showing a dialog box 4300 that may be displayed when a user has qualified for and been entered in a sweepstake, in accordance with a representative embodiment of the present invention. The dialog box 4300 may be modal (i.e., it may require the user to take an action to close it, before other actions with respect to the loyalty program application may be performed). The dialog box 4300 may be displayed to the user after all of the tasks required to qualify for entry have been completed successfully, and the entry of the user in the identified sweepstake has been recorded. The dialog box indicates the name of the sweepstake 4310, the size of the prize 4320, and the amount of time 4330 until qualification for the sweepstakes end and the prize may be awarded.

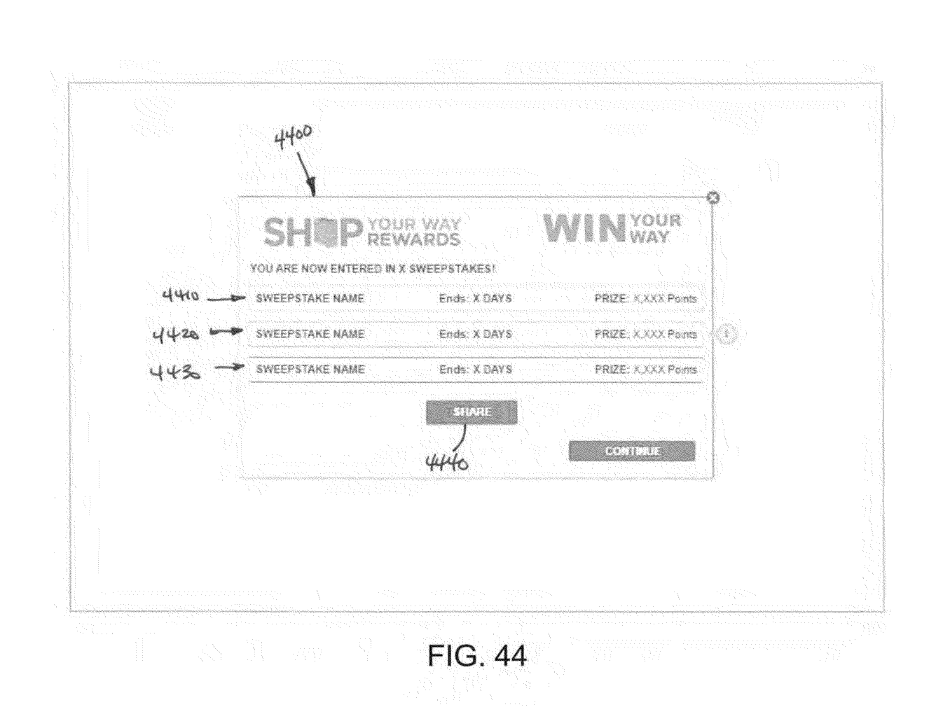

FIG. 44 shows an illustration of an exemplary screen image of a dialog box 4400 that may be displayed when a user has qualified for and been entered in multiple sweepstakes, in accordance with a representative embodiment of the present invention. The dialog box 4400 may be modal and may require the user to take an action to close it, before other actions with respect to the loyalty program application may be performed. The dialog box 4400 may be displayed to the user after all of the tasks required to qualify for entry in each of the listed sweepstakes have been completed successfully, and the entry of the user in each of the identified sweepstakes 4410, 4420, 4430 has been recorded. The dialog box 4400 indicates the name of each sweepstake, the size of the prize for each sweepstake, and the amount of time until qualification for each of the sweepstake ends and the prize for the sweepstake may be awarded. In addition, the dialog box 4400 is shown with a “Share” button 4440 that the user may select to share information about their participation in the identified sweepstakes 4410, 4420, 4430 with others in their social network via any of the means described herein.

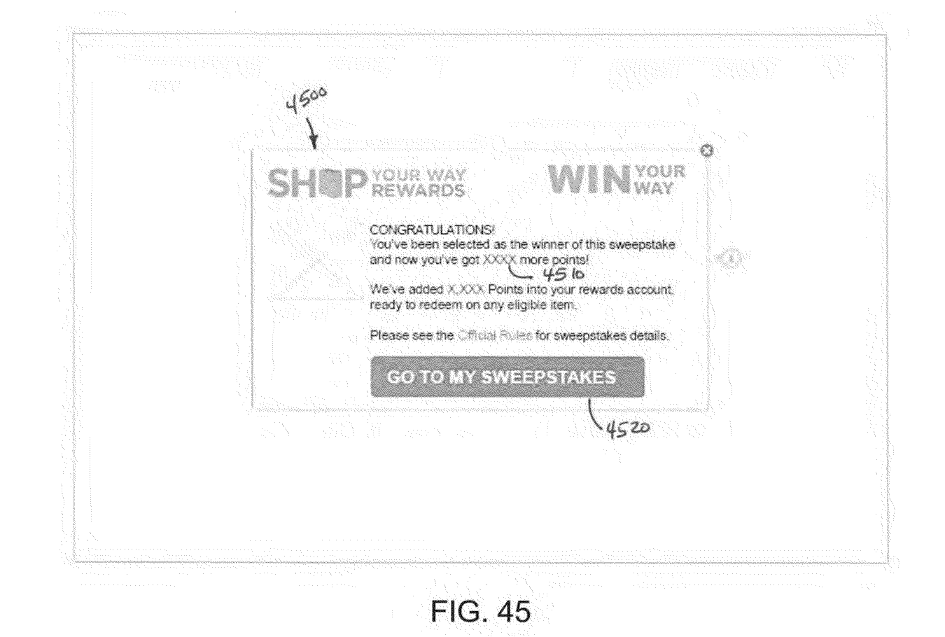

FIG. 45 shows an illustration of an exemplary screen image of a dialog box 4500 that may be displayed when a user has qualified for, been entered in, and won a sweepstakes, in accordance with a representative embodiment of the present invention. The dialog box 4500 of FIG. 45 may be modal and may require the user to take an action to close it, before other actions with respect to the loyalty program application may be performed. The dialog box 4500 indicates the size of the prize 4510 for the sweepstake, and provides a link 4520 enabling the user to transition to a listing showing the sweepstakes in which the user is engaged.

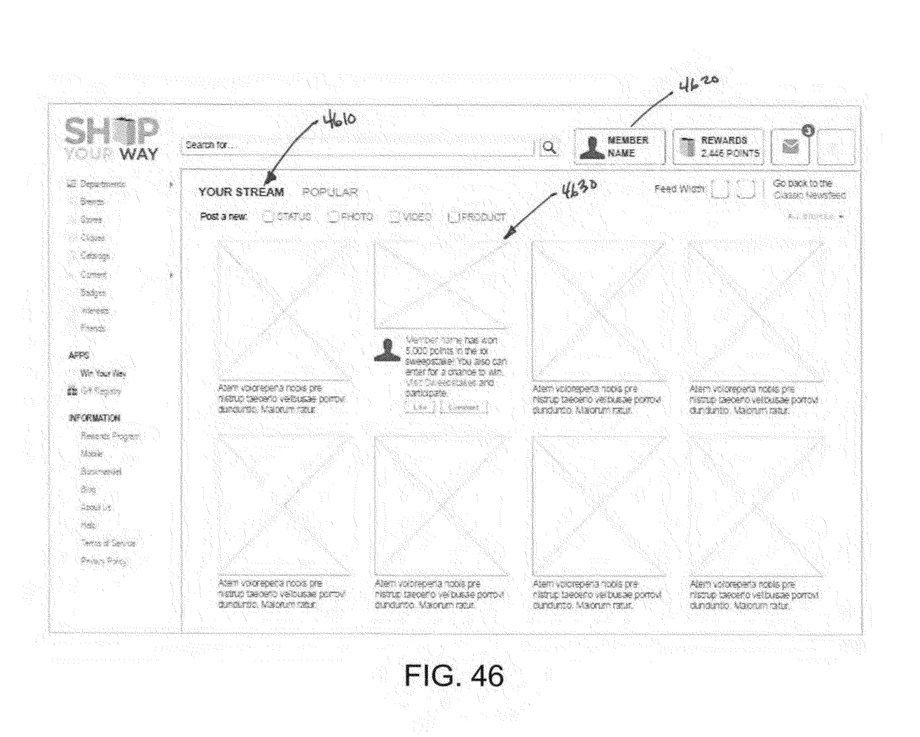

FIG. 46 is an illustration of an exemplary screen image 4600 showing a newsfeed stream 4610 of a member of the loyalty program of a business operator or sponsor of a system such as the system 150 of FIG. 1, in accordance with a representative embodiment of the present invention. An example of such a newsfeed is described in U.S. Provisional Patent Application No. 61/641,329 entitled “Object Driven Newsfeed,” (Attorney Docket No. 25073US01), filed May 2, 2012, and in U.S. Non-provisional Patent Application No. 13/886,065, filed May 2, 2013, the complete subject matter of each of which is hereby incorporated herein by reference, in its respective entirety.

In the illustration of FIG. 46, user selection of the “Your Stream” tab 4610 may cause display of a grid of posted items ordered in the grid according to their time of submission. In a representative embodiment of the present invention, a system such as, for example, the system 150 may, for example, automatically post information about a user into the newsfeeds of members of the loyalty program and/or the newsfeed of the members of the personal social network of the user. As shown in FIG. 46, a news posting for a member “Member Name” 4630 that is shown in the grid of postings has been added to the newsfeed of the user whose name “Member Name” 4620 is shown at the top of the screen image shown in FIG. 46. The sending/posting of such information to a newsfeed of a member of a social network such as, for example, the “My Network” supported by the e-commerce system 150 of FIG. 1 discussed above with respect to FIG. 28 and FIG. 29, or the user page of the Facebook® social networking system, or the sending of a real-time electronic message such as those communicated via, for example, the twitter® real-time electronic network, or via email, may be automatic under control of the e-commerce system 150. Distribution of such news items may be sent/posted, for example, when new contests and sweepstakes are announced, when the participation of users begins, when participants complete tasks required for qualification for contest or sweepstakes entry, when users have qualified for entry in a contest or sweepstakes, when certain thresholds of participation are met, and when prizes are awarded. In addition, the sending/posting of information to email, real-time electronic networks, and social networking systems may be done at other times as well, as when various measures related to contests and sweepstakes change or exceed certain levels during the activity.

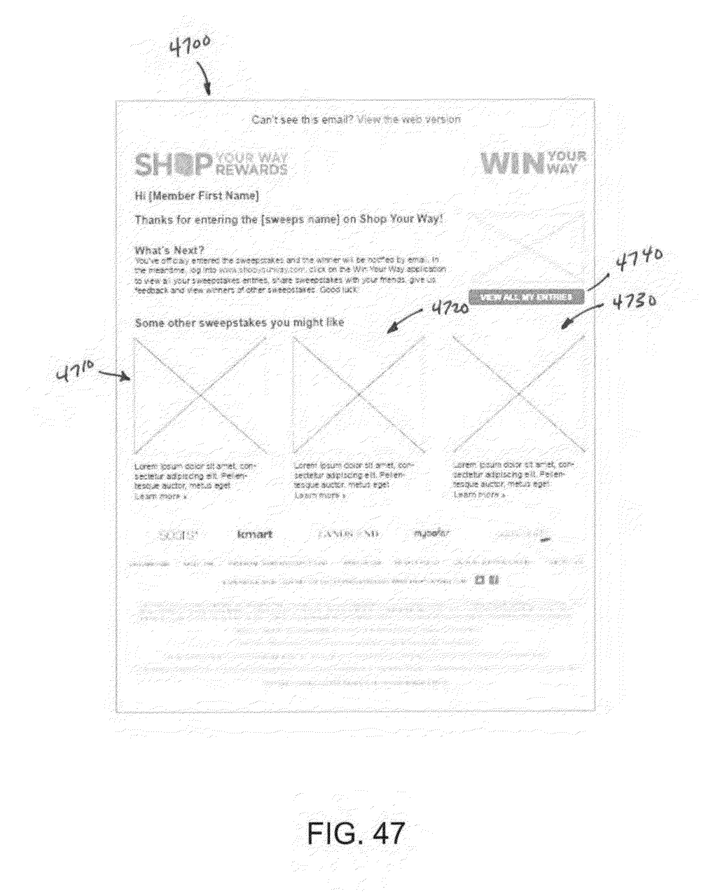

FIG. 47 is an illustration of an exemplary email 4700 that may be sent to members of a loyalty program of a business operator or sponsor of a system such as the e-commerce system 150 to promote or incite interest in participating in activities such as contests and sweepstakes, in accordance with a representative embodiment of the present invention. The user may be offered a number of contests or sweepstakes 4710, 4720, 4730 that may be of interest based on the personal interest and preferred brands identified in their profile, and may be provided with a link 4740 to permit them to view the sweepstakes and contests in which they are presently entered.

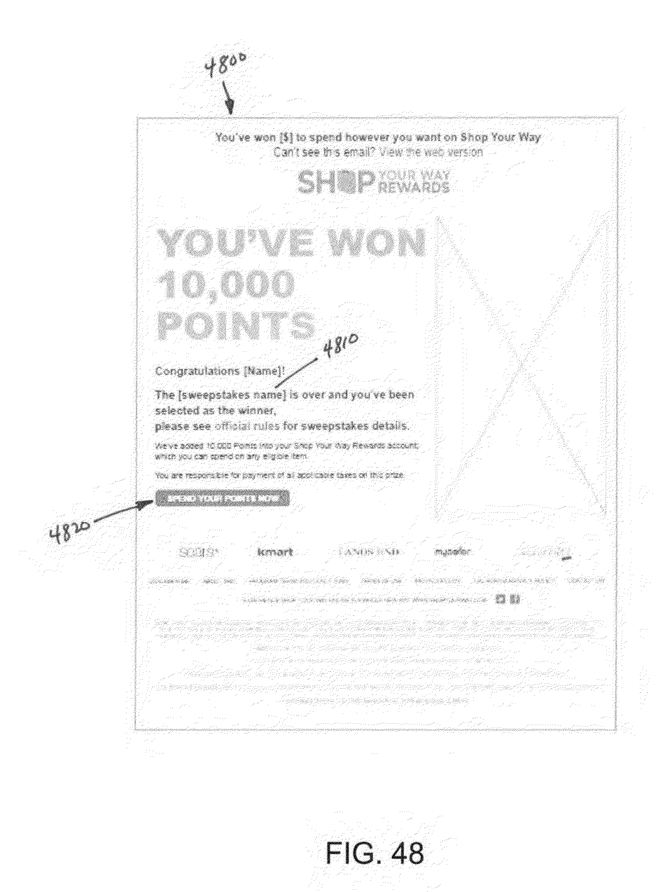

FIG. 48 is an illustration of an exemplary email 4800 that may be sent to a member of a loyalty program of a business operator or sponsor of a system such as the e-commerce system 150 to inform them of their win in an activity such as a contest or sweepstake, in accordance with a representative embodiment of the present invention. The user may be informed of the name of the sweepstakes 4810 that they have won, and may be provided with a link 4820 to allow them to immediately take advantage in shopping using the prize winnings of the contest or sweepstakes just won.

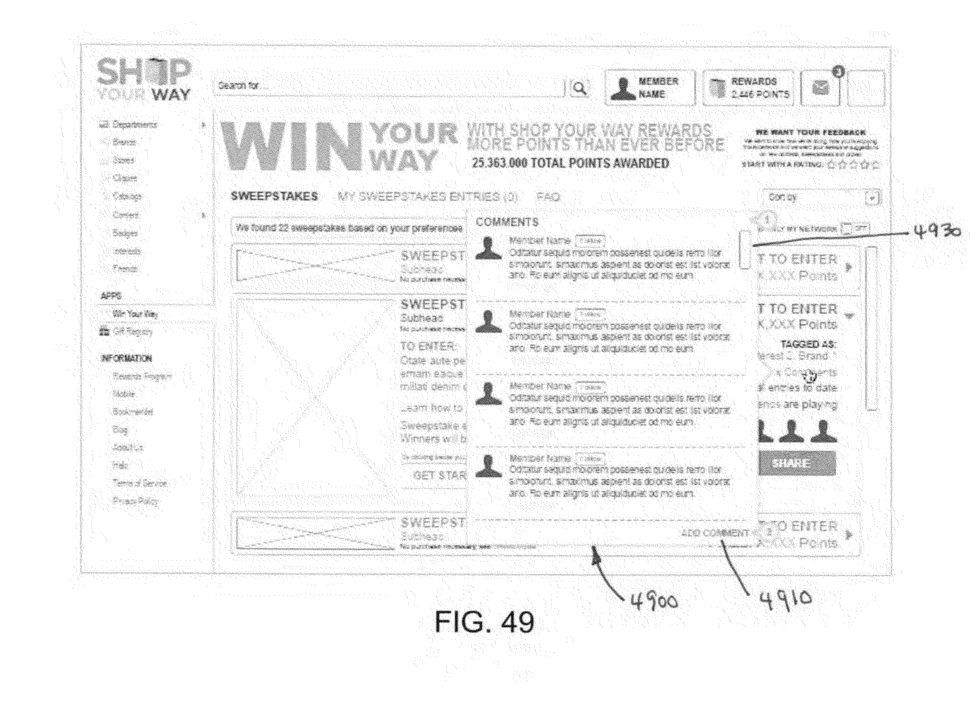

FIG. 49 is an illustration of an exemplary screen image of a pop-up box 4900 that appears when a user chooses the “Comments” link 2022 that appears on screen images such as that illustrated in, for example, FIG. 20, in accordance with a representative embodiment of the present invention. The pop-up box 4900 displays a list of comments made by various members of the loyalty program of the business operator or sponsor, and includes a link 4910 that the user may select/click to add a comment of their own. If more than a certain number of comments are available for display, a scroll bar 4930 may be provided to allow the user to scroll through the entire list of comments.

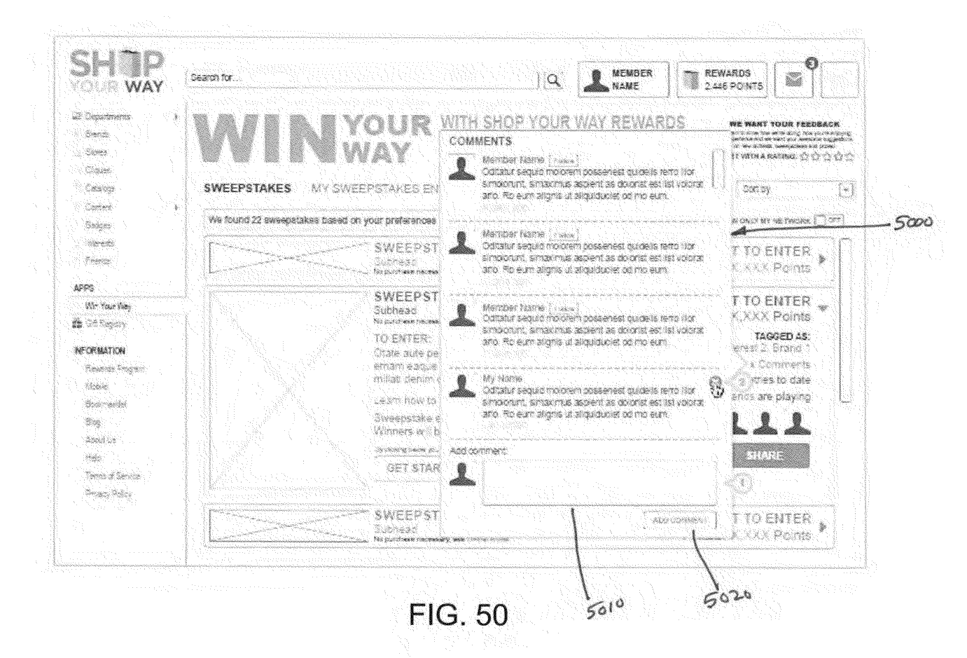

FIG. 50 is an illustration of an exemplary screen image of a pop-up box 5000 such as that shown in FIG. 49, in which the user has chosen to add a comment, in accordance with a representative embodiment of the present invention. As shown in FIG. 50, a pop-up box 5000 like that of FIG. 49 has been expanded to display a text box 5010 for entry of the new comment. The expanded portion includes a button 5020 to permit the user to add their comment to the list when done.

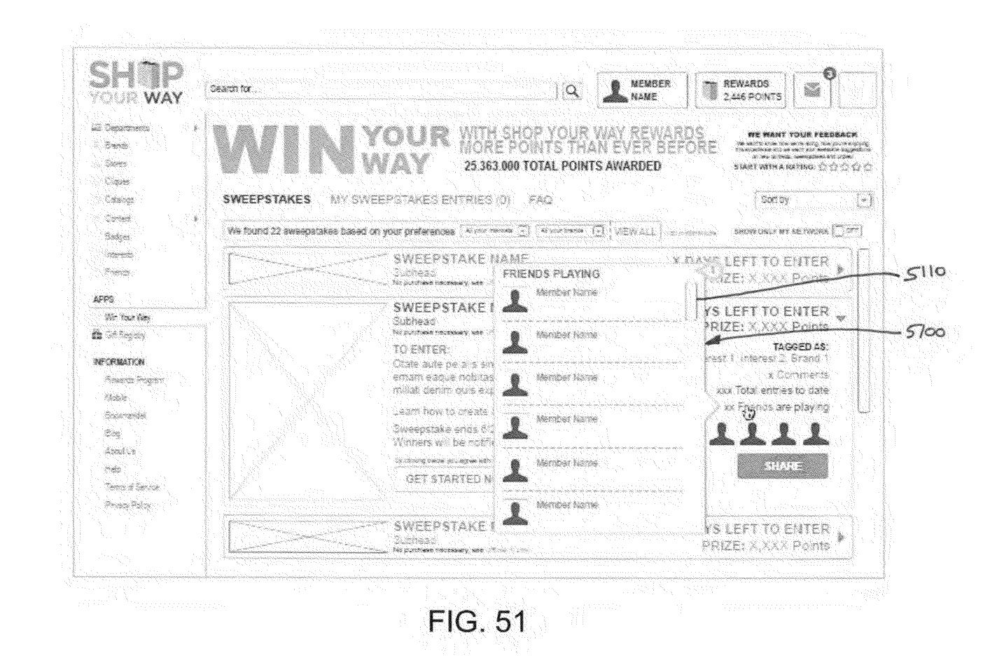

FIG. 51 is an illustration of an exemplary screen image of a pop-up box 5100 that appears when a user chooses the “Friends” link that appears on screen images such as, for example, the “Friends” link 2024 illustrated in FIG. 20, in accordance with a representative embodiment of the present invention. The pop-up box 5100 of FIG. 51 displays a list identifying the members of the loyalty program of the business operator or sponsor that belong to the personal social network of the user. If information identifying more than a certain number of “Friends” is available for display, a scroll bar 5110 may be provided to allow the user to view the entire list of their “Friends.”

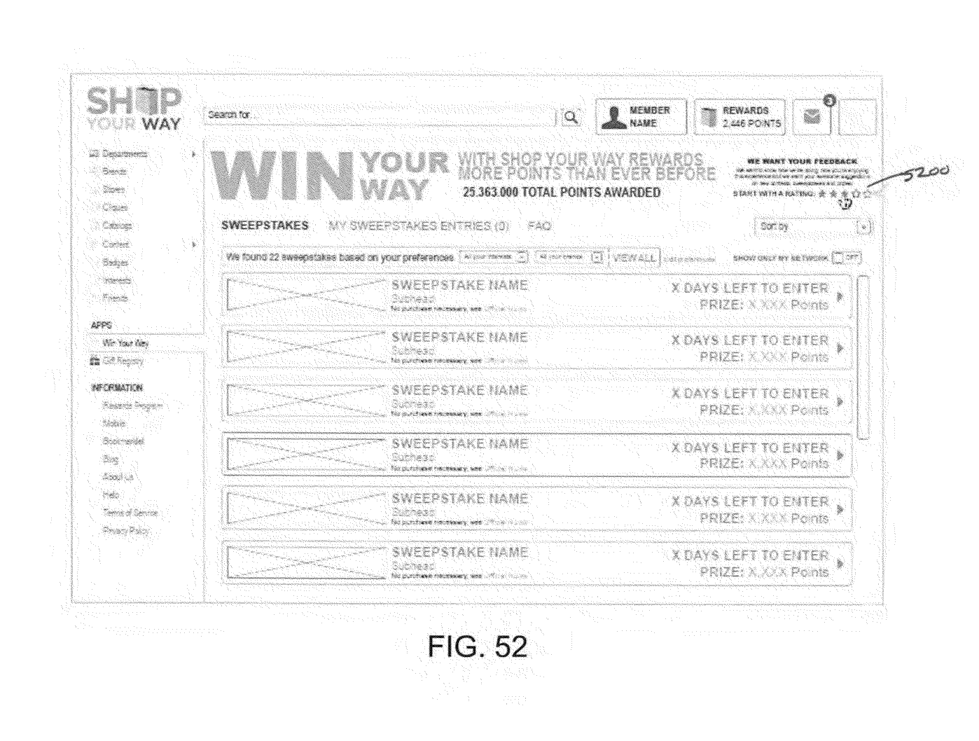

FIG. 52 is an illustration of an exemplary screen image showing a ratings tool 5200 to permit the user to indicate their satisfaction with the contests and sweepstakes application, in accordance with a representative embodiment of the present invention. The exemplary ratings tool 5200 of FIG. 52 displays a row of stars that when clicked provides to the business operator or sponsor of a system such as the e-commerce system 150 feedback in the form of a rating of, in the example of FIG. 52, one to five stars. In this manner, the user may express their satisfaction with their user experience in using the various features of the contest and sweepstakes application of the e-commerce system 150.

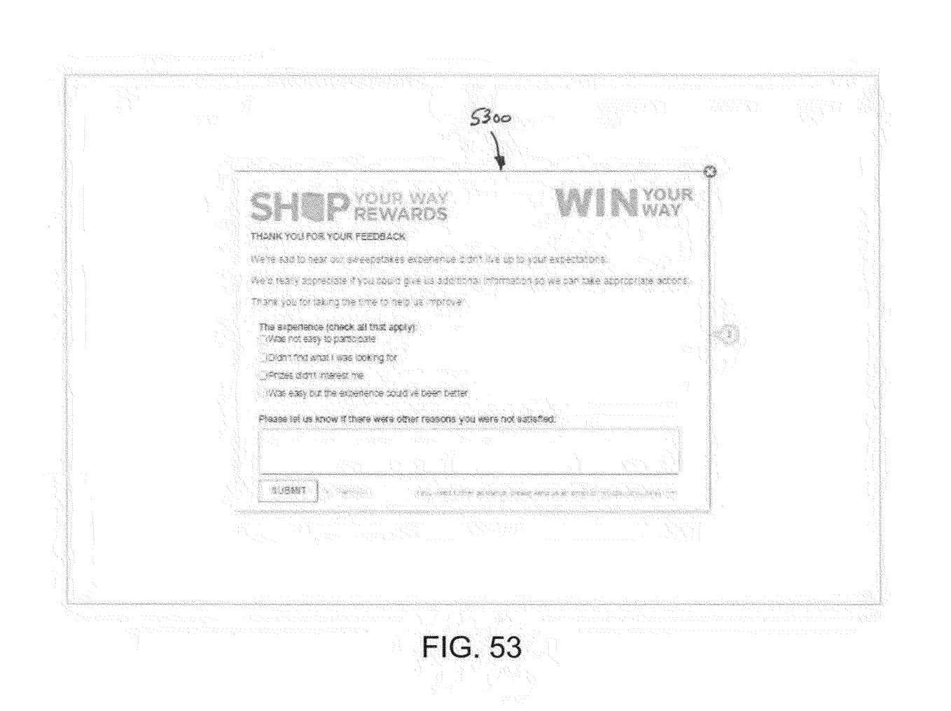

FIG. 53 is an illustration of an exemplary screen image showing a pop-up box 5300 that permits the user to indicate by selection or text entry, details of their experience using the contest and sweepstakes application, in accordance with a representative embodiment of the present invention.

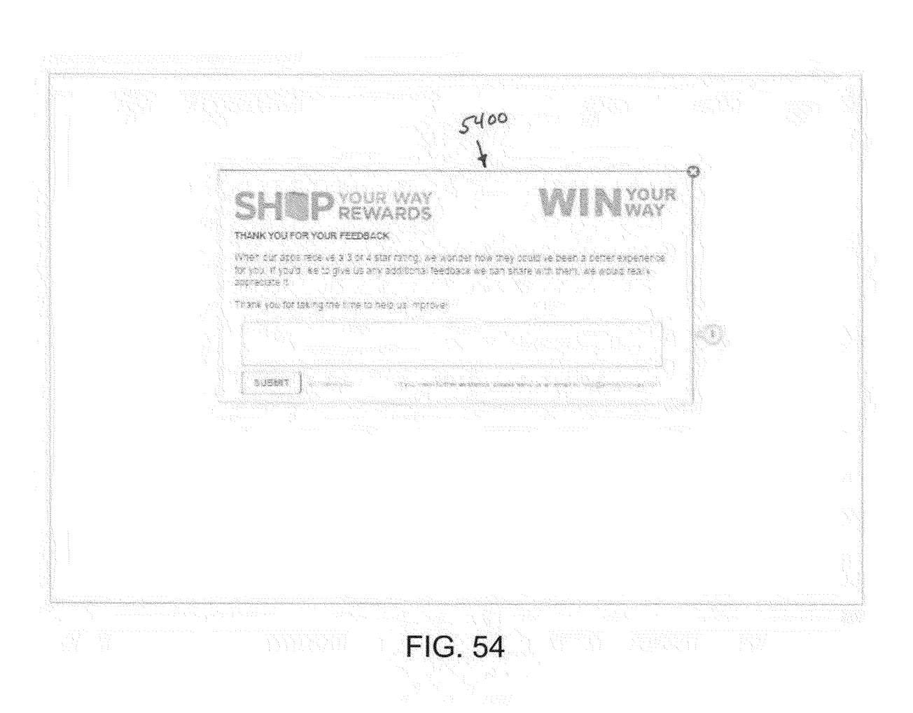

FIG. 54 is an illustration of an exemplary screen image showing a follow-on pop-up box 5400 that permits the user to indicate by text entry, details of their experience using the contest and sweepstakes application when a particular number of stars have been selected by the user via a ratings tool such as the ratings tool 5200 of FIG. 52, in accordance with a representative embodiment of the present invention.

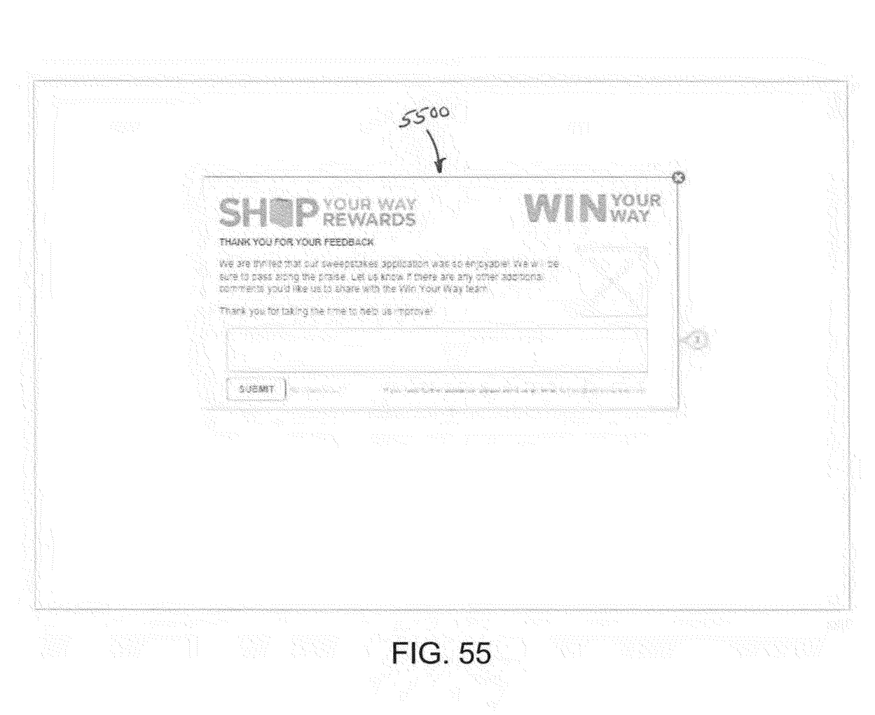

FIG. 55 is an illustration of an exemplary screen image showing a follow-on pop-up box 5500 that permits the user to indicate by text entry, details of their experience using the contest and sweepstakes application when a particular number of stars have been selected by the user ratings tool such as the ratings tool 5200 of FIG. 52, in accordance with a representative embodiment of the present invention.

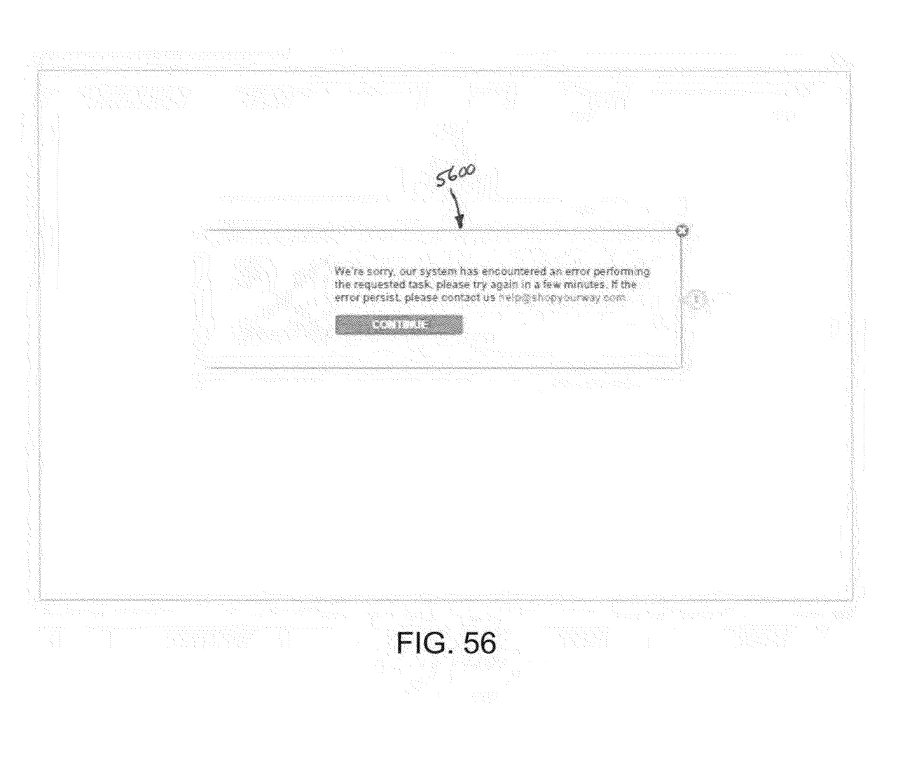

FIG. 56 is an illustration of an exemplary screen image showing a pop-up box 5600 that may be used to notify the user of a system failure, in accordance with a representative embodiment of the present invention.

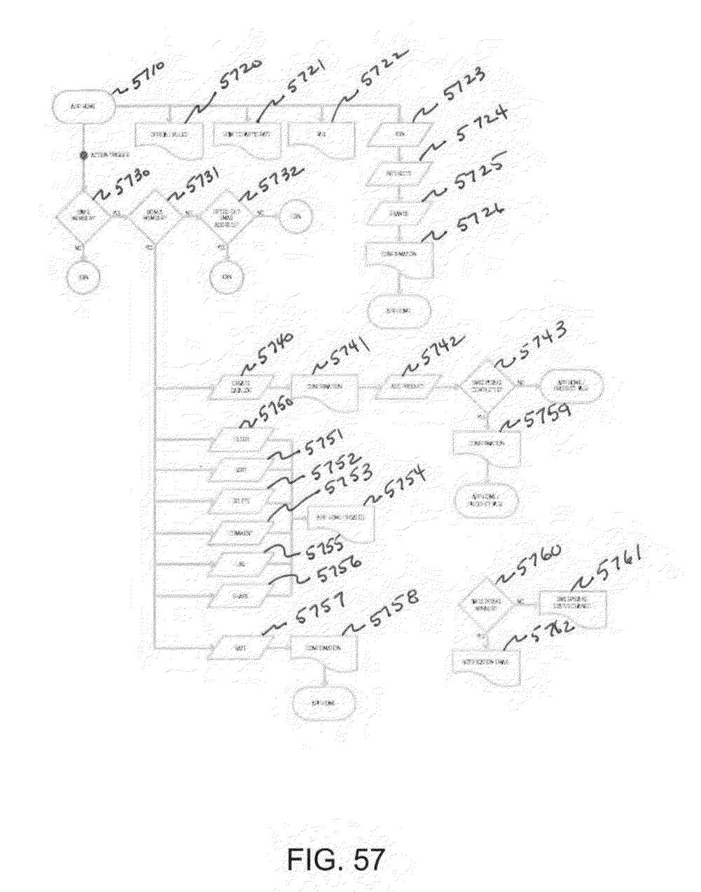

FIG. 57 is a flowchart illustrating an exemplary process for a sweepstake having a task for qualification that involves the creation of a catalog of products on a system such as the e-commerce system 150 of FIG. 1, in accordance with a representative embodiment of the present invention. The process of FIG. 57 may be used as a web site application supporting user access to a system in accordance with a representative embodiment of the present invention. The example task of creating a catalog to qualify for entry in a sweepstake has been described above with respect to FIG. 20 to FIG. 25. As illustrated in FIG. 57, the example process begins at block 5710, where the user is shown a “home page” for a contest or sweepstakes web site. The user may choose to, at block 5720, access the “official rules” for the contests or sweepstakes accessible via the web site. When finished reading the “official rules”, the user may then return to the “home page”.

Alternatively, the user may, at block 5721, may choose to access instructions on how to participate in contests or sweepstakes accessible via the web site. When finished reading the instructions, the user ma then return to the “home page”. The user may also, at block 5722, access a collection of “frequently asked questions” (“FAQs”) related to the contests and sweepstakes of the web site. When finished reviewing the “FAQs”, the user may then return to the “home page”.

In addition, the user may, at block 5723, choose to join the loyalty program of the operator or sponsor of the web site. As part of joining, the user may, at block 5724, provide information about their interests and, at block 5725, provide information about their preferred product brands. The user may then, at block 5726, be asked to confirm their submitted information or their request to join as a member of the loyalty program, and upon confirmation, are then added to the loyalty program. The user may then be returned to the “home page” displayed at block 5710.

The user may, at block 5710, perform an action to take part in a contest or sweepstakes. The system may then, at block 5730, determine whether the user is a member of the loyalty program of the operator or sponsor of the web site. If it is determined that the user is not a member, the process proceed at block 5723, described above. If it is determined that the user is a member, the process determines, at block 5731, whether the member is also a “Bonus Member”. If it is determined that the member is not a “Bonus Member”, a check is made to determine whether the user wishes to “opt-out” the submission/use of their email address, and they are then passed to the portion of the process for joining the contests and sweepstakes beginning at block 5723.

If it is determined, at block 5731, that the user is a “Bonus Member”, the system of the present exemplary process provides the user with a number of actions that may be taken. At block 5740, the user may, for example, choose to create a “catalog” of products that they like, have, or want, in partial or full fulfillment of the requirements for entry in a sweepstakes. Creation of the “catalog” may be confirmed, at block 5741, and the user may add a product of their choice, at block 5742. The process may then, at block 5743, determine whether the requirements for entry in the sweepstakes have been completed. If the requirements have not yet been completed, the process may then return to the “home page”, to permit the user to choose another product for their catalog. If the requirement for the sweepstakes has been completed, the process may then, at block 5759, display a confirmation to the user.

At block 5750, the user may set one or more filters, to control selection of the contests and sweepstakes that are identified to the user on the “home page”. The user may, at block 5751, select how the displayed list of contests and sweepstakes is sorted. At block 5752, the user may delete any of the contests and sweepstakes in the displayed listing of contests and sweepstakes selected for them. At block 5753, the user may enter a comment about a contest or sweepstakes. At block 5755, the user may “Like” a contest or sweepstakes, while at block 5756, the user may share information about a contest or sweepstakes with a member of their social network. After setting one or more filters, selecting a sorting option, deleting a contest or sweepstakes, commenting on a contest or sweepstakes, “Like'ing” a listed contest or sweepstakes, or sharing information, the “home page” may, at block 5754, be suitably updated and displayed to the user. In addition the user may, at block 5757, rate a contest or sweepstakes, and may confirm their selected rating, at block 5758.

In addition to the activities involving the web site, the process of operating a contest or sweepstakes may, at block 5760, determine a winner of a contest or sweepstakes, ad may, at block 5762, send notification to the winner, or, when the sweepstakes period is ended, at block 5761, change the status of the contest or sweepstakes to indicate that the contest or sweepstakes has ended.

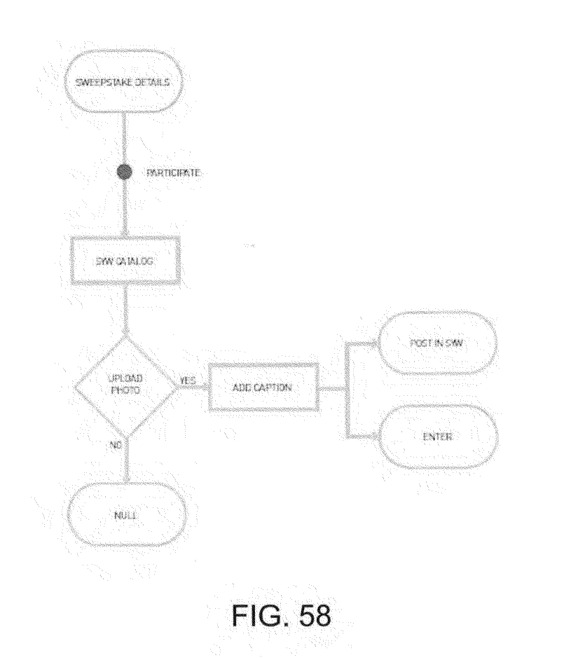

FIG. 58 is a flowchart illustrating an exemplary process for a sweepstake qualifying task that involves the uploading of a photograph to a system such as the e-commerce system 150 of FIG. 1, in accordance with a representative embodiment of the present invention.

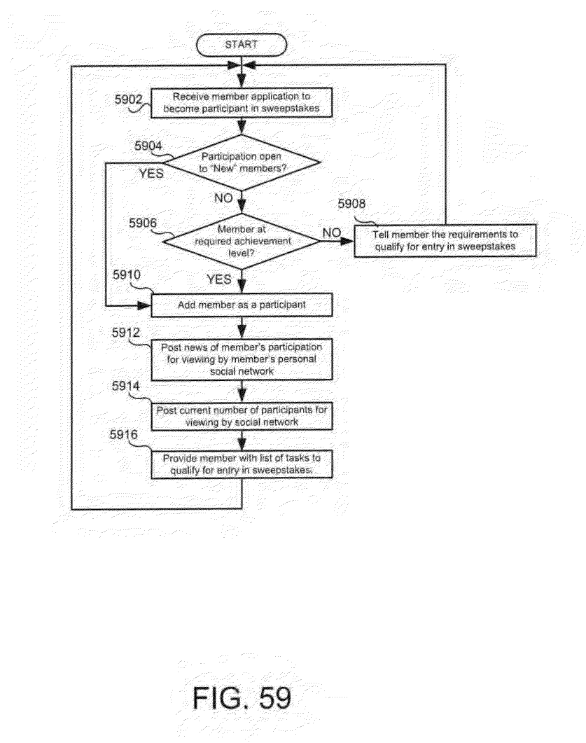

FIG. 59 is a flowchart illustrating an exemplary process of accepting an application by a member of a loyalty program to become a participant in a contest or sweepstakes, in accordance with a representative embodiment of the present invention. The process of FIG. 59 begins at block 5902, at which a member application to become a participant in a contest or sweepstakes is received. Next, at block 5904, a check is made to determine if the sweepstakes is open to “New” members. If, at block 5904, it is determined that participation in the contest or sweepstakes of interest is open to “New” members, the process of FIG. 59 passes to block 5910, described below. However, if participation is not open to “New” members, the process moves to block 5906, where a check is made to determine whether the member is at the achievement level required for participation in the contest or sweepstakes for which the applicant applied. If the member has not achieved the required level, the process of FIG. 59 informs the applicant of the requirements to qualify for entry in the contest or sweepstakes for which the applicant applied, and returns to block 5902. However, if the member has achieved the level required for participation, the process transitions to block 5910, described below.

At block 5910, the process adds the member as a participant in the contest or sweepstakes of interest. Next, at block 5912, the process may post news of the member's participation for viewing by members of the social network of the new member participant. The process then, at block 5914, may post information sharing the current number of participant in the contest or sweepstakes to members of the social network of the new participant. The process, at block 5916, then provides to the participant a list of tasks to be completed, in order to qualify for entry in the desired contest or sweepstakes. The process of FIG. 59 then returns to block 5902.

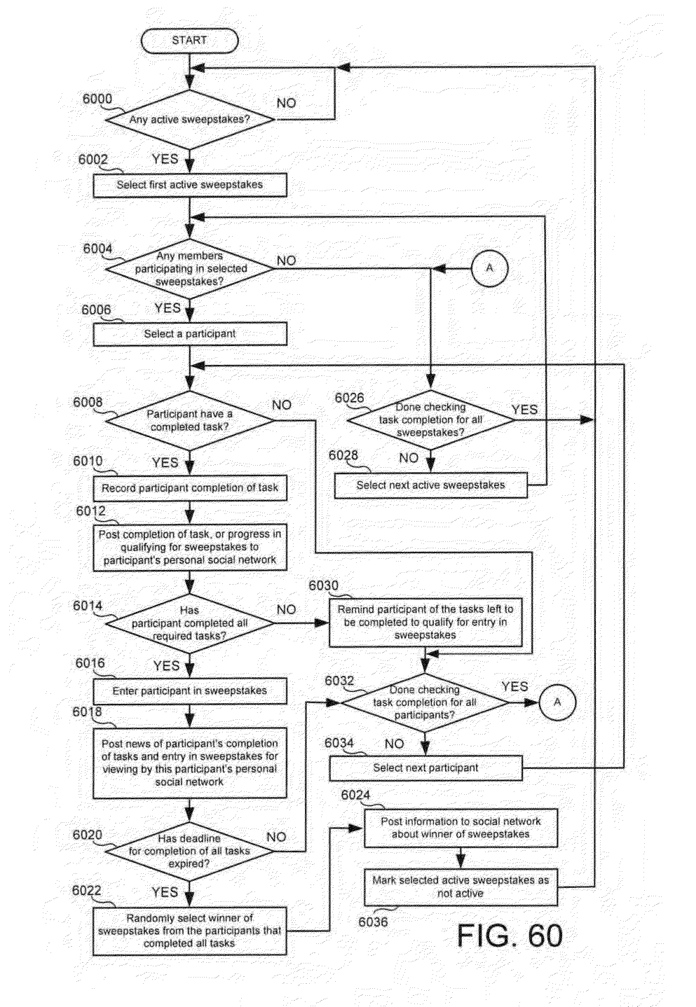

FIG. 60 is a flowchart illustrating an exemplary process for operating a system that track the completion of tasks by participants in qualifying for a contest or sweepstake in a social e-commerce network, in accordance with a representative embodiment of the present invention. The process of FIG. 60 begins at block 6000, where as check is made to determine whether any active sweepstakes exist. If there are no active sweepstakes, the process simply loops at block 6000. If, however, there is at least one active sweepstakes, the process, at block 6002, selects an active sweepstake and, at block 6004, determines whether any members of the loyalty program of the operator or sponsor of the system are participating in the selected active sweepstakes. If it is determined that the selected active sweepstake has at least one participant then, at block 6006, the process selects a participant of the selected active sweepstakes. Next, at block 6008, the system checks whether the selected participant has a completed task. If the selected participant has not completed a task, the process of FIG. 60 moves to block 6032, described below. If, at block 6008, it is determined that the selected participant has completed a task, the process then, at block 6010, records the completion of the task by the selected participant and, at block 6012, may post to the social network of the selected participant, information about completion of the task, and/or current progress in qualifying for sweepstake entry by the select participant.

Next, at block 6014, the process of FIG. 60 may check whether the selected participant has completed all of the tasks required for the selected active sweepstakes. If the selected participant has not completed all tasks required by the selected active sweepstake, the process of FIG. 60 may then remind the selected participant of the tasks still left to be completed to qualify for the selected active sweepstakes. The system performing the process may then continue on to block 6032, described below. If, however, the selected participant has completed all tasks required to qualify for the selected active sweepstake, the process moves to block 6016, at which the selected participant is entered in the selected active sweepstakes, and may, at block 6018, post news of the completion, by the selected participant, of all tasks for the selected active sweepstake for viewing by the social network of the selected participant.

Next, at block 6020, a determination is made whether the deadline for completion of all tasks for the selected active sweepstakes has expired. If, at block 6020, it is found that the deadline for task completion has not expired, then the process of FIG. 60 moves to block 6032, described below. If, however, the deadline for completion of all tasks for the selected active sweepstakes has passed, then, at block 6022, the system of the present invention may randomly select a winner of the selected active sweepstakes from the set of all participants that have qualified for entry in that selected active sweepstakes (i.e., completed all required tasks), and may then, at block 6024, post information about the winner of the sweepstakes to the social network of the winner, as well as to other members of the loyalty program of the operator or sponsor of the system. The process of FIG. 60 then, at block 6036, marks the selected active sweepstake as no longer active, and returns the system to block 6000.

Turning now to discuss block 6032, where a determination is made whether the completion of tasks for all participants in the selected active sweepstake has been done. If a check of task completion for all participants in the selected active sweepstake has been completed, then process of FIG. 60 then moves to block 6004, discussed above. If task completion by all participants in the selected active sweepstake has not been checked, the process of FIG. 60 then moves to block 6034, where the next participant in the selected active sweepstake is selected. The process then continues at block 6008, discussed above.

It should be noted that in accordance with a representative embodiment of the present invention, information about the status of a user may automatically be shared with members of the personal social network of the user, via social networking functionality of a system such as the e-commerce system 150 of FIG. 1, or using email, real-time electronic communications networks, and social networking systems external to the e-commerce system 150.

In addition, it should be noted that, in accordance with a representative embodiment of the present invention, the requirements of those wishing to qualify for entry in contests and sweepstake may include the completion of tasks that by their nature involve interaction and/or communication with members of a social network, such as that supported by the system 150 of FIG. 1, including the personal social networks of the users wishing to qualify. In this way, a representative embodiment of the present invention may be incited to more fully engage with the e-commerce system 150, the members of the loyalty program of the business operator or sponsor of the associated with the e-commerce system 150, and friends and family of the users, which results in an increased level of activity and commerce for the business operator or sponsor of the system 150.

A representative embodiment of the present invention may be seen in an e-commerce platform that provides social networking support to aid in the sale of products and services by a vendor, by engaging customers in activities or tasks that promote the sale of the products and services of the vendor, or a business partner of the vendor.

In a representative embodiment of the present invention, an operator of a business that involves the sale of products and/or services may send advertising materials to customers, where the materials promote participation by the customer in one or more contests or sweepstakes. The term contest may be used herein to refer to an activity or event that involves the awarding of a reward or prize based on the outcome of judging of submissions of a group of participants, while the term sweepstakes may be used herein to represent an activity or event that involves the awarding of a reward or prize based on the outcome of random selection of one or more winners from a group of participants. In a representative embodiment of the present invention, an e-commerce platform employed by the business operator or sponsor may provide functionality that supports the purchasing activities of customers, and may also provide functionality supporting activities such as, for example, contests and sweepstakes involving customers and their personal social networks to increase engagement of the customers with the e-commerce platform of the business operator or sponsor.

In a representative embodiment of the present invention, a reward may be provided to a user. Presenting a reward to users is something very common in e-commerce apps, based on loyalty or specific actions. Research has shown that if the customer believes he/she won something, the sentiment towards the award is much more positive.

In some representative embodiments of the present invention, an individual may, for example, be automatically entered into a contest or sweepstakes when they are within a certain physical distance of the communication systems of, or enter, a “brick and mortar” location of the operator, sponsor, or partner of the operator or sponsor of the system of the present invention. For example, locations of the business enterprise of the operator or sponsor, or of a partner of the operator or sponsor of a representative embodiment of the present invention may be equipped with devices or systems to detect wireless signals of electronic user devices such as, by way of example and not limitation, cell phones, smart phones, tablet computers, portable computers, media players, or other electronic devices. The electronic device of the user may emit signals detectable by the communication devices and systems at the business location that are specific to the purpose of detecting the presence of customers or member of a loyalty program of the operators or sponsors of a representative embodiment of the present invention, or their business partners, in response to receipt of a specific signal by the electronic device of the user such as, for example, a geolocation signal (e.g., global positioning system (GPS) or a beacon or other transmission of the communication device and systems at the business location. Such signals may include, by way of example and not limitation, signal formats and frequencies used by Wi-Fi (e.g., IEEE 802.11 b/g/n/ac), BLUETOOTH®, Zigbee®, near field communication (NFC), cellular, and/or other suitable wireless air interface technologies known now or in the future. Wireless interaction with such electronic user devices may permit the communication devices or systems at a business location to identify the individual(s) carrying the electronic user devices, and permit a representative embodiment of the present invention to reward the individual with automatic entry in a contest or sweepstakes, simply for visiting the physical location of the business enterprise. In some representative embodiments of the present invention, an individual may receive an entry in a contest or sweepstakes for each business location visited, and may be rewarded with a higher level of achievement in a contest or sweepstakes, based on the number of business location visited by the individual within a certain amount of time.

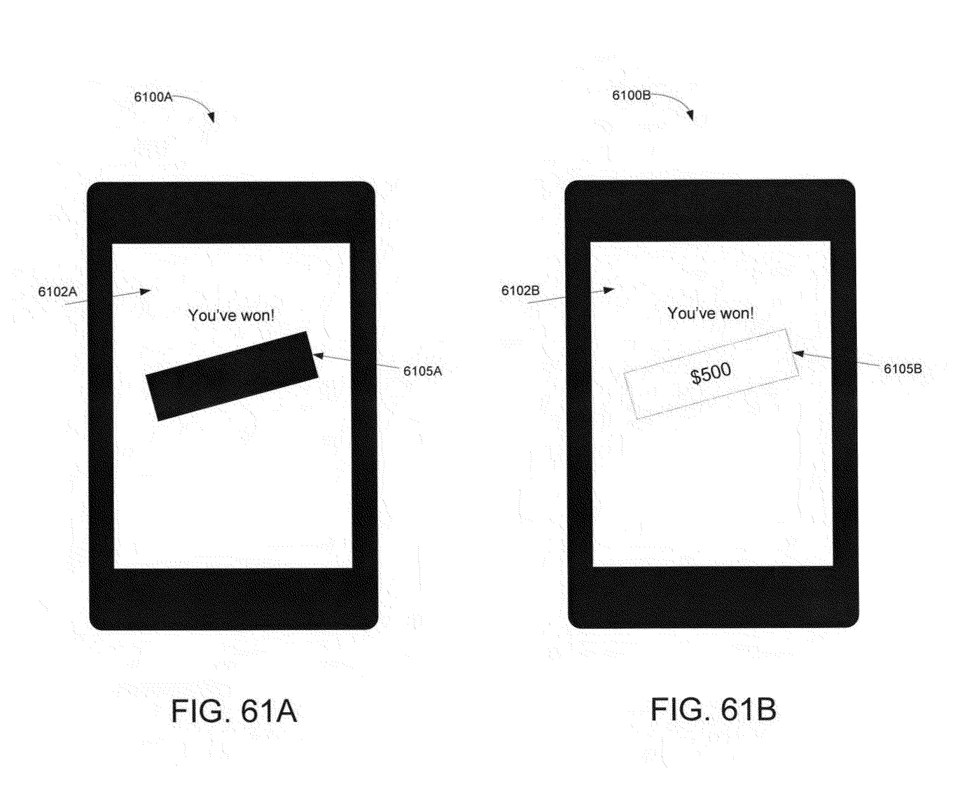

FIG. 61A is an illustration of an exemplary electronic user device 6100A having an display screen 6102A that includes a region having a graphical representation of a “scratch-off” coating 6105A that partially or fully obscures notice to the user of reward information, in accordance with a representative embodiment of the present invention. The content displayed on the electronic display screen 6102A may be displayed to a user on any of a number of electronic devices including, for example, the PCs 110, 115, the communication devices 125, 162, the cellular phone 130, and the kiosks 135, 164 illustrated in FIG. 1.

In the case of devices having a display with a touch-sensitive surface, such as the handheld electronic depicted in FIG. 61A, the reward information obscured by the graphical representation of the scratch-off coating 6105A of a representative embodiment of the present invention may be revealed, as shown in FIG. 61 B as revealed reward 6105B, when the user repeatedly moves their finger across the touch-sensitive region identified by the electronic graphical representation of the scratch-off coating 6105A.

In the case of devices not equipped with a display having a touch-sensitive surface, such as a desktop or laptop personal computer equipped with a mouse or a touch pad, the user may use the mouse or the touch pad, or in other situations other user input devices, to move the screen cursor across the region of the graphical representation of the scratch-off coating 6105A. As the use engages in the motion on the touch screen, or using a mouse or touchpad, the obscured information is gradually revealed to the user.

The use of the simple ‘scratch’ operation over the covered/obscured reward area of the display may help to enhance the overall experience for the user in situations in which a prize may be awarded, such as the situations described above with respect to FIGS. 39, 40, 45, and 48, contributing both to further engagement of the user, and to better conversion towards future sales. The act of a user physically ‘scratching’ the obscured region of the display to reveal a reward, particularly in a mobile environment, creates excitement in the user, and is a novel feature that improves customer enjoyment of the games, contests, and sweepstakes in which they may participate. As previously described above, the value and nature of a reward revealed in the above manner may be pre-determined based on personalization, availability, and possibly additional variables and parameters (e.g., user interests and preferred brands) related to that specific customer.

In some representative embodiments of the present invention, the customer may navigate to a page containing product information, customer profile information, and/or rewards to be redeemed. The rewards shown on the page may or may not all have a ‘scratch prize’ virtual layer obscuring the nature of the rewards, as described above. For those that do, once the customer “scratches” the virtual “scratch-off” coating or layer sufficiently, the reward is revealed, and the customer is then able to redeem it.

FIG. 61B is an illustration of an exemplary user device 6100B having an electronic display 6102B, that may correspond to the user device 6100A, in which the region having a graphical representation of a “scratch-off” coating 6105A of FIG. 61A has been “scratched-off” to reveal the details of a reward 6105B to the user of the device 6100B, in accordance with a representative embodiment of the present invention.

It should be noted that the social tasks that may be supported by a system in accordance with a representative embodiment of the present invention, such as the system 150 of FIG. 1, are not limited to the examples provide above. A large number of different activities may be tracked by such a system, the completion of which may be one condition to qualify a participant for entry in a contest or sweepstake including, for example, creating a poll of other individual to help the participant make a product choice (i.e., a “Help Me Choose” poll), answering one or more polls on various topics (i.e., a task “Topical Poll”), or completing a particular combination of social tasks related to a certain stage in life (i.e., a “Life Stage” task).

Additional social tasks may include, for example, requiring a participant to add information or post details about one or more products accessed on a first web site to a page of a particular second web site; expressing interest in one or more products or product brands owned by or of interest to the participant by selecting/clicking web page links that are identified as enabling the participant to indicate they “have” the products, or wish to “follow” the product brands. Example social tasks may also include completing the information for a profile for the participant, and sharing a product offer with other individuals; and uploading a photo or video to a web site.

In a representative embodiment of the present invention, participants may be given a task that requires them to download a mobile application on their cellular phone, smart phone, or other user electronic device, and/or to use an application on such an electronic device to “check-in” when they enter the “brick-and-mortar” location for a business. Such a “check-in” task may be combined with other types of tasks. Other types of tasks that may be asked of a participant include, for example, asking the participant to scan a product barcode or take a picture that shows a particular product or product brand, or the participant may be asked to share information or details or opinions about a product or product brand on a social networking system such as “facebook®” or a real-time electronic network such as “twitter®”. The participant may be asked to “Follow” a one or more businesses, one or more “tags,” or one or more of their friends.

Other examples of possible tasks in accordance with a representative embodiment of the present invention include a participant adding one or more “tags” to each of one or more products on a web site or web page; publishing one or more stories to a web page or web site; adding one or more comments to one or more web pages or web sites; and answering questions from one more friends.

To support vendors, internal businesses, business partners, and businesses external to the operator or sponsor of the e-commerce system 150 of FIG. 1, a representative embodiment of the present invention may include one or more administrative tools to enable those entities/organizations to create or to request the creation of various contests and sweepstakes. An e-commerce system such as that described herein may also provide those entities/organizations with a platform through which to market/launch their products/services/assets to the large member base supported by the e-commerce system 150 of FIG. 1, in accordance with a representative embodiment of the present invention.

It should be noted that, although the present application may describe a computer system (i.e., a “platform”) supporting the contests and sweepstakes features described herein as being supported by the e-commerce system 150 of FIG. 1, a computer system used to support the inventive concepts described herein may reside virtually anywhere, communicating using any suitable technology, and may be physically separated from the system(s) on which the web sites and social networks reside and any systems that may be used to complete the tasks described above. A computer system/platform that tracks the activities of participants may be made aware of the completion of tasks on various web sites and may communicate information identifying various forms of participants interactions with a web site. For example, web sites on which participants are active may send information to a platform tracking their activities whenever the participants selects various link, buttons, etc on cooperating web sites. Such links, buttons, and other user interface “tools” or elements may include, by way of example and not limitation, clickable/selectable links such as “Like,” “Have,” “Want,” “Follow,” “Share,” and “Comment,” various buttons, text fields, scroll bars, images, and other user interface tools or elements that may be placed on a web page and used to interact with a web site. Such activity tracking information may, for example, be sent to what may be referred to herein as an “events engine”. Such as “events engine” may track these user interactions as sent by external web sites using messages having a pre-determined and agreed upon format.

In a representative embodiment of the present invention, when a user on a web site that is separate from the computer system or platform supporting the contests and sweepstakes functionality described herein selects/clicks on, for example, a link or button on a web page to start their involvement in contest or sweepstake, the platform supporting the contest or sweepstake is informed that the user has asked to enter the contest or sweepstake by that external website. In a representative embodiment of the present invention, an entity such as, for example, the “prizing engine” described above, may be aware that the contest or sweepstakes was set up on that external web site, and may send a set of data points identifying the source of the selection/click of the user and identification details for the user that selected/clicked the link or button to start their involvement in the contest or sweepstakes. Further, an entity such as the “events engine” may begin receiving, from the external website, information identifying the interactions of the user with the external website. This occurs for all users who have initiated entry in a contest or sweepstakes on that external web site. In this manner, the platform supporting contests and sweepstakes in accordance with a representative embodiment of the present invention may determine each user's progress or entry completion of tasks and activities relating to contest and sweepstakes supported by the platform. In addition, a profile of the user may be maintained that includes records of activities of the user on web sites separate from the platform that tracks the activities. Such a profile may reside on one or both of the platform and the external web site.

In a representative embodiment of the present invention, an entity such as, for example, the “prizing engine” described herein may support separate and independent contests and sweepstakes, including contest and sweepstakes rules and winner selection, for each of multiple web sites for which tracking is performed. An entity such as an “events engine” as discussed herein, may record interactions from multiple sources (e.g., multiple external websites) and know precisely where (e.g., from which external website) each interaction originated. In addition, a representative embodiment of the present invention may support the creation and tracking of user interactions for a contest or sweepstake, in which activities/tasks take place on multiple external web sites.

A representative embodiment of the present invention may track the activities of those that are not members of the loyalty program of the operator or sponsor of the contest and sweepstake system, by maintaining “ghost identifiers (ghost IDs), that in-store purchases may be tracked. Such “ghost-IDs” may later be converted to actual IDs for non-members who eventually become members of the loyalty program. Periodically, such a system may check to see if a ghost ID, created to permit a non-loyalty program member to engage in contest and sweepstakes activity, is later associated with a new online account in the loyalty program. If a match is found, the ghost id may be replaced with the newly created loyalty program member id.

Aspects of the present invention may be seen in a method of operating a system that supports contests and sweepstakes within a social network having a plurality of individuals as members. In such an embodiment, each of the plurality of members may have a corresponding personal social network comprising selected members of the social network. Such a method may comprise communicating information to one or more members of the social network to enable each of the one or more members to qualify for entrance in one of a contest and a sweepstake by performing a defined set of tasks, wherein the defined set of tasks relates to communication, by each participant via the system, with members of the participant's personal social network. The method may also comprise accepting as participants in qualifying for the one of a contest and a sweepstake, those of the one or more members matching requirements for participation. The method may further comprise tracking user activity on the system to determine completion by each participant of each task in the defined set of tasks, and entering in the one of a contest and a sweepstake each participant that the tracking determines has completed the defined set of tasks. The method may also comprise publishing status information for the one of a contest and a sweepstake to the one or more members of the social network, via the system, and choosing one or more entrants as winners of the one of a contest and a sweepstake.

In a representative embodiment of the present invention, the defined set of tasks may comprise the participant recommending one of a product and a service to a member of the personal social network of the participant, and the participant submitting a review of one of a product and a service, for publication via the social network. The defined set of tasks may comprise the participant providing aid in choosing one of a product and a service to a member of the social network, via the system, and submitting an item created by the participant to a designated representative of the system. The defined set of tasks ma also comprise inviting one or more members of the social network to participate in the contest, and creating a catalog of one or both of products and services selected by the participant, for publication to the members of the personal social network of the participant.

In some representative embodiments of the present invention, the one of a contest and a sweepstake may be a sweepstake, and in other representative embodiments, the one or more winners may be selected based on the outcome of judging of the completion of the defined set of tasks. The method may further comprise notifying a participant in the one of a contest and a sweepstake of the number of members of the participant's personal social network that are participants in the one of a contest and a sweepstake. The method may also further comprise notifying a member of the social network when a member of the personal social network of the member is a winner of a contest or a sweepstake. Status information may comprise one or both of the number of members participating in the one of a contest and a sweepstake and the number of entrants in the one of a contest and a sweepstake.

Additional aspects of the present invention may be found in a system that performs the actions of the method set forth above.

Although devices, methods, and systems according to the present invention may have been described in connection with a preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of operating a system that supports contests and sweepstakes within a social network having a plurality of individuals as members, each of the plurality of members having a corresponding personal social network comprising selected members of the social network, the method comprising:
communicating information to one or more members of the social network to enable each of the one or more members to qualify for entrance in one of a contest and a sweepstake by performing a defined set of tasks, wherein the defined set of tasks relates to communication, by each participant via the system, with members of the participant's personal social network;
accepting as participants in qualifying for the one of a contest and a sweepstake, those of the one or more members matching requirements for participation;
tracking user activity on the system to determine completion by each participant of each task in the defined set of tasks;
entering in the one of a contest and a sweepstake each participant that the tracking determines has completed the defined set of tasks;
publishing status information for the one of a contest and a sweepstake to the one or more members of the social network, via the system; and
choosing one or more entrants as winners of the one of a contest and a sweepstake.

2. The method according to claim 1, wherein the defined set of tasks comprises the participant recommending one of a product and a service to a member of the personal social network of the participant.

3. The method according to claim 1, wherein the defined set of tasks comprises the participant submitting a review of one of a product and a service, for publication via the social network.

4. The method according to claim 1, wherein the defined set of tasks comprises the participant providing aid in choosing one of a product and a service to a member of the social network, via the system.

5. The method according to claim 1, wherein the defined set of tasks comprises submitting an item created by the participant to a designated representative of the system.

6. The method according to claim 1, wherein the defined set of tasks comprises inviting one or more members of the social network to participate in the contest.

7. The method according to claim 1, where the defined set of tasks comprises creating a catalog of one or both of products and services selected by the participant, for publication to the members of the personal social network of the participant.

8. The method according to claim 1, wherein the one of a contest and a sweepstake is a sweepstake.

9. The method according to claim 1, wherein one or more winners are selected based on the outcome of judging of the completion of the defined set of tasks.

10. The method according to claim 1, further comprising notifying a participant in the one of a contest and a sweepstake of the number of members of the participant's personal social network that are participants in the one of a contest and a sweepstake.

11. The method according to claim 1, further comprising notifying a member of the social network when a member of the personal social network of the member is a winner of a contest or a sweepstake.

12. The method according to claim 1, wherein status information comprises one or both of the number of members participating in the one of a contest and a sweepstake and the number of entrants in the one of a contest and a sweepstake.

13. A system that supports contests and sweepstakes within a social network having a plurality of individuals as members, each of the plurality of members having a corresponding personal social network comprising selected members of the social network, the system comprising:
at least one processor for communicatively coupling to user devices of the plurality of members, the at least one processor being operable to, at least:
communicate information to one or more members of the social network to enable each of the one or more members to qualify for entrance in one a contest and a sweepstake by performing a defined set of tasks, wherein the defined set of tasks relates to communication, by each participant via the system, with members of the participant's personal social network;
accept as participants in qualifying for the one of a contest and a sweepstake, those of the one or more members matching requirements for participation;
track user activity on the system to determine completion by each participant of each task in the defined set of tasks;
enter in the one of a contest and a sweepstake each participant that the tracking determines has completed the defined set of tasks;
publish status information for the one of a contest and a sweepstake to the one or more members of the social network, via the system; and
choose one or more entrants as winners of the one of a contest and a sweepstake.

14. The system according to claim 13, wherein the defined set of tasks comprises the participant recommending one of a product and a service to a member of the personal social network of the participant.

15. The system according to claim 1, wherein the defined set of tasks comprises the participant submitting a review of one of a product and a service, for publication via the social network.

16. The system according to claim 13, wherein the defined set of tasks comprises the participant providing aid in choosing one of a product and a service to a member of the social network, via the system.

17. The system according to claim 13, wherein the defined set of tasks comprises submitting an item of content created by the participant to a designated representative of the system.

18. The system according to claim 13, wherein the defined set of tasks comprises inviting one or more members of the social network to participate in the one of a contest and a sweepstake.

19. The system according to claim 13, where the defined set of tasks comprises creating a catalog of one or both of products and services selected by the participant, for publication to the members of the personal social network of the participant.

20. The system according to claim 13, wherein one or more winners are selected based on the outcome of judging of content submitted by the participant.

21. The system according to claim 13, further comprising notifying a participant of the number of members of the participant's personal social network that are participants in the one of a contest and a sweepstake.

22. The system according to claim 13, further comprising notifying a member of the social network when a member of the personal social network of the member is a winner of the one of a contest and a sweepstake.

23. The system according to claim 13, wherein status information comprises one or both of the number of members participating in the one of a contest and a sweepstake and the number of entrants in the one of a contest and a sweepstake.
